(19) United States
(12) Patent Application Publication
(10) Pub. No.: US 2007/0046211 A1
(43) Pub. Date: Mar. 1, 2007

(54) Plasma display panel

(75) Inventors: Takashi Yamada, Yamanashi (JP); Toshiyuki Akiyama, Yamanashi (JP); Koji Shinohe, Kanagawa (JP); Yasuyuki Noguchi, Osaka (JP)

Correspondence Address: ARENT FOX PLLC, 1050 CONNECTICUT AVENUE, N.W., SUITE 400, WASHINGTON, DC, 20036, US

(73) Assignees: ADVANCED PDP DEVELOPMENT CENTER CORPORATION; PIONEER CORPORATION;; MATSUSHITA ELECTRIC INDUSTRIAL CO., LTD. and FUJITSU LIMITED

(21) Appl. No.: 11/507,668

(22) Filed: Aug. 22, 2006

(30) Foreign Application Priority Data
Aug. 23, 2005 (JP) 2005-241274
May 17, 2006 (JP) 2006-137969
May 17, 2006 (JP) 2006-137970
May 17, 2006 (JP) 2006-137971
May 17, 2006 (JP) 2006-137972

(51) Int. Cl. H01J 17/49

(52) U.S. Cl. 313/586

(57) ABSTRACT

Each of the row electrodes (X1, Y1) of a PDP is constituted of a pair of row electrodes X1, Y1. Each of the transparent electrodes X1a, Y1a of the respective row electrodes X1, Y1, which face each other across a discharge gap g1 and between which a sustaining discharge is initiated, has a width set at 150 μm or less in the transverse direction with respect to the longitudinal direction of the row electrodes X1, Y1. Xenon included in a discharge gas filling in a discharge space has a partial pressure set at 6.67 kPa or more. In consequence, a high luminous efficiency is achieved.

### BACKGROUND OF THE INVENTION

1. Field of the Invention

This invention relates to a structure of plasma display panels.

The present application claims priority from Japanese Applications No. 2005-241274, 2006-137969, 2006-137970, 2006-137971 and No. 2006-137972, the disclosure of which is incorporated herein by reference.

2. Description of the Related Art

A surface-discharge type AC plasma display panel (hereinafter referred to as “PDP”) typically has two opposing glass substrates placed on either side of a discharge-gas-filled discharge space. On one of the two glass substrates, a plurality of row electrode pairs each extending in the row direction are regularly arranged in the column direction and overlaid with a dielectric layer. On the other glass substrate, a plurality of column electrodes each extending in the column direction are regularly arranged in the row direction. Discharge cells each equipped with a red, blue or green phosphor layer are formed in the respective areas in the discharge space corresponding to the intersections between the row electrode pairs and the column electrodes, so as to form a matrix on the panel surface.

The discharge space defined between the pair of glass substrates is filled with a discharge gas that includes 1% to 10% xenon by volume.

The PDP selectively produces an address discharge between the column electrode and one of the paired row electrodes constituting each row electrode pair for the selection of the light-emitting cells (the discharge cells in which a wall charge accumulates on the respective portions of the dielectric layer facing them) and the non-light-emitting cells (the discharge cells in which the wall charge is erased from the respective portions of the dielectric layer facing them), thus distributing the light-emitting cells and the non-light-emitting cells over the panel surface in accordance with image data of the video signal.

Sequentially, a sustaining pulse is applied alternately to the paired row electrodes of each row electrode pair to initiate a sustaining discharge in each of the light-emitting areas. The sustaining discharge results in the generation of vacuum ultraviolet light from the xenon in the discharge gas filling the discharge space. The vacuum ultraviolet light excites the red, green and blue phosphor layers provided in the respective light-emitting cells to cause them to produce visible light, thus generating a matrix-display image on the panel surface.

In the PDP structured as described above, conventionally, the size of the row electrode is set as described below.

FIG. 1 illustrates the structure of a portion of the row electrode pair facing a discharge cell C in the conventional PDP. In FIG. 1, the row electrodes X, Y constituting each of the row electrode pairs (X, Y) are respectively made up of belt-shaped transparent electrodes Xa, Ya that extend parallel to each other in the row direction and face each other across a discharge gap g in the column direction, and belt-shaped bus electrodes Xb, Yb that extend in the row direction and are connected to the respective transparent electrodes Xa, Ya.

FIG. 1 shows also the column electrodes D.

The column-direction width W of each of the row electrodes X, Y of the conventional PDP is set at any value of from 400 μm to 1000 μm.

Such a conventional PDP is disclosed in JP-A-H8-22772, for example.

The following are reasons why the conventional PDP has the column-direction width of the row electrode set as described above.

In the PDP, the visible light is emitted by the phosphor layer, which is excited by a resonance line of a 147 nm wavelength which is the main component of the vacuum ultraviolet light generated from the xenon in the discharge gas by means of the sustaining discharge. In the process of moving within the discharge gas toward the phosphor layer, the resonance line comes into collision with the xenon atoms in the discharge gas, and is repeatedly absorbed and emitted by the xenon atoms and thus becomes attenuated.

Accordingly, in the PDP using a discharge gas with a low xenon partial pressure, such as a discharge gas containing 1% to 10% xenon by volume, the amount of resonance line reaching the phosphor layer when the sustaining discharge is produced may be reduced, thus possibly making it impossible to provide the required luminance.

Therefore, each of the row electrodes X, Yin the conventional PDP has a large width W in the column direction as described earlier (see FIG. 1) in order to initiate a sustaining discharge over a wide area in the discharge cell C for an increase in the amount of vacuum ultraviolet light (i.e. the amount of resonance line) generated by means of the sustaining discharge. As a result, the amount of resonance line reaching the phosphor layer reaches the predetermined value or more, leading to the achievement of a luminance of the predetermined value or higher.

However, the foregoing conventional PDP is incapable of providing the high luminous efficiency required to achieve a screen with high brightness.

For the enhancement of the luminous efficiency in a PDP, the typically preferred manner is to increase the thickness of the dielectric layer overlying the row electrode pairs constituted of the row electrodes across which a sustaining discharge is initiated, in order to curb the discharged current. However, an increase in the thickness of the dielectric layer results in a rise in discharge voltage which leads to a rise in the cost of a drive circuit, and in an increase in electrostatic capacitance between the row electrodes which leads to an increase in power consumption.

To address such disadvantage, the conventional PDP has a recess formed in a portion of the dielectric layer corresponding to the discharge gap between the row electrode pair. The dielectric layer has a smaller thickness in the portion corresponding to the discharge gap between the row electrode pair than that in the other portions, in order to increase the electric-field strength around the discharge gap so as to reduce the drive voltage.

Such a conventional PDP structured as described above is described in JP-A-H11-96919, for example.

However, this conventional PDP is also incapable of providing a high luminous efficiency required for a screen with

### SUMMARY OF THE INVENTION

The present invention has been made to solve the technical problems associated with conventional PDPs as described above. Accordingly, it is an object of the present invention to provide a PDP capable of achieving a high luminous efficiency.

It is another object of the present invention to prevent the electrical power consumption from increasing for providing a high luminous efficiency.

To achieve the objects, the present invention provides a PDP which includes: a pair of first and second substrates placed parallel to each other across a discharge space; a plurality of row electrode pairs that are placed on the first substrate, each extend in a row direction, are regularly arranged in a column direction, and are each constituted of row electrodes paired with and facing each other across a discharge gap; a dielectric layer that is formed on the first substrate and covers the row electrode pairs; and a plurality of column electrodes that are placed on the second substrate, each extend in the column direction and are regularly arranged in the row direction. In the PDP, unit light emission areas are respectively formed in portions of the discharge space corresponding to intersections of the column electrodes and the row electrode pairs. The discharge space is filled with a discharge gas that includes xenon. Portions of the respective row electrodes paired with each other and constituting each of the row electrode pairs, which are involved in a discharge initiated across the discharge gap, each have a width set at 150 μm or less in a transverse direction with respect to a longitudinal direction of the row electrode. The xenon included in the discharge gas has a partial pressure set at 6.67 kPa or more.

In a first embodiment of such a PDP according to the present invention, the portion of each of the paired row electrodes constituting each row electrode pair, which is involved in a discharge initiated across the discharge gap, has a width set at 150 μm or less in the transverse direction with respect to the longitudinal direction of the row electrode. Also, the discharge space defined between the front glass substrate and the back glass substrate is filled with a discharge gas with a xenon partial pressure set at 6.67 kPa or more.

In the PDP of the first embodiment, the portion, involved in a discharge initiated across the discharge gap between the paired row electrodes constituting each row electrode pair, among the component portions of each of the paired row electrodes has a width in the transverse direction with respect to the longitudinal direction of the row electrode, and this width is set at 150 μm or less, which is a small width as compared with a width ranging from 400 μm to 1000 μm in the conventional PDPs. Because of this small width, the range over which a discharge initiated between the row electrodes expands in the unit light emission area in the discharge space is narrower than that of the conventional PDPs. Thus, the area of transition of the discharge is limited to a small area in the proximity to the discharge gap corresponding to the area in which the discharge enters an initial glow discharge stage.

In this way, in the PDP of the first embodiment, vacuum ultraviolet light is generated from the xenon in the discharge gas at a significantly high efficiency as compared with that of the conventional PDPs.

With the setting of the xenon partial pressure in the discharge gas at 6.67 kPa or more, the phosphor layer is excited mainly by the molecular beam of a 172 nm wavelength in the vacuum ultraviolet light generated from the xenon in the discharge gas. The molecular beam is seldom attenuated while moving within the discharge gas in the way that the resonance line is. For this reason, even when a discharge initiated between the row electrodes is localized within the range in the vicinity of the discharge gap, the vacuum ultraviolet light properly reaches the phosphor layer. This makes it possible to directly take advantages of the property of having a significantly high efficiency in generating the vacuum ultraviolet light as compared with that in the conventional PDPs, resulting in achievement of a high luminous efficiency.

Further, in the PDP of the first embodiment, the area in the unit light emission area in which the vacuum ultraviolet light is produced is smaller than that in the conventional PDPs. Because of this, even when the unit light emission area is surrounded by the partition wall unit, the vacuum ultraviolet light is not easily affected by the partition wall unit, which involves such things as wall loss. In addition, the use of the molecular beam in the vacuum ultraviolet light for excitation of the phosphor layer reduces the effects caused by the variations in distance between the phosphor layer and the area in which the vacuum ultraviolet light is produced. This reduction eliminates a requirement of a high precision of positioning of the row electrode pair in the unit light emission area in the column direction. This makes it possible to enhance the product yield in the manufacturing process so as to contribute to a reduction in manufacturing costs.

There are some possible structures for setting, at 150 μm or less, the column-direction width of the portion of each of the paired row electrodes of each row electrode pair involved in a discharge initiated across the discharge gap. For example, in a first structure, each of the row electrodes has a column-direction width set at 150 μm or less. In a second structure, regarding the dielectric layer overlying the row electrode pairs, a portion of the dielectric layer placed on a leading-side portion of a column-direction width of 150 μm or less of the row electrode has a smaller thickness and the other portions of the dielectric layer has a greater thickness, so that a discharge is permitted to be initiated only between the leading-side portions, each having a column-direction width of 150 μm or less, of the row electrodes. In a third structure, the dielectric layer covers the row electrode pairs, and a secondary electron emission layer, which is formed of a high γ material, is placed only on a portion of the dielectric layer facing a leading-side portion of a column-direction width of 150 μm or less of each row electrode.

With the PDP of the first structure, a significant reduction in the column-direction width of each row electrode as compared with the case of the conventional PDPs results in a significant reduction in the electrostatic capacity arising between the electrodes. In consequence, the amount of reactive current is reduced, thus making a reduction in the electrical power consumption possible.

With the PDP in the second structure, because a change in the structure of a conventional row electrode pair is unnecessary, an extensive change in the manufacturing process is unnecessary. Also, the second structure can be achieved by selectively setting a position and/or a thickness of the dielectric layer. Accordingly, the degree of flexibility in design and manufacturing is increased, thereby making it possible to reduce the manufacturing costs and enhance the product yield.

With the PDP in the third structure, since the area for initiating a discharge between the row electrodes can be freely set by changing position and/or dimensions of the secondary electron emission layer, the degree of flexibility in design and manufacturing is increased. Accordingly, it is possible for the PDP to flexibly adaptable to a modification in design and the like.

In the first embodiment, if the discharge gas includes a helium partial pressure of 8.00 kPa or more, the luminous efficiency can be further improved as compared with the case where the discharge gas does not include helium.

In the first embodiment, a portion, facing each unit light emission area, of each of the row electrodes constituting each row electrode pair is shaped having a length greater than a row-direction width of the unit light emission area. Also, the width of the portion in the transverse direction with respect to the longitudinal direction of the row electrode is set at 150 μm or less. As a result, the brightness of the PDP is improved. In addition, even when a high xenon partial pressure is set in the discharge gas, a rise in drive voltage can be held down.

Further, in a second embodiment of the PDP according to the present invention, each of the portions, involved in a sustaining discharge initiated across the discharge gap, of the respective row electrodes constituting each row electrode pair has a column-direction width set at 150 μm or less. Also, the discharge space defined between the front glass substrate and the back glass substrate is filled with a discharge gas including a xenon partial pressure set at 6.67 kPa or more. In addition, wall members are formed between the dielectric layer and the portions, facing the row electrode pairs, of a partition wall unit that partitions the adjacent light emission areas in the row direction from each other. Each of the wall members has a required column-direction width greater than a column-direction width of the row electrode pair and smaller than a column-direction width of each of the unit light emission areas. The wall member blocks off, from each other, portions, on opposite sides of the wall member, of the respective unit light emission areas adjacent each other in the row direction. Clearances are formed between the dielectric layer and portions of the partition wall unit on both ends of the wall member in the column direction, and thereby provide communication between the unit light emission areas adjacent to each other in the row direction.

In the PDP of the second embodiment, a sustaining discharge initiated between the paired row electrodes constituting each row electrode pair develops as a narrow-depth-range discharge because each of the portions of the paired row electrodes involved in the sustaining discharge has a column-direction width set at 150 μm or less. Also, the discharge gas includes a high xenon partial pressure set at 6.67 kPa (50 Torr) or more. In consequence, the luminous efficiency is improved.

The wall member is placed between the dielectric layer and the portion, facing the row electrode pair, of the partition wall unit which partitions the adjacent unit light emission areas in the row direction from each other. This wall member blocks off from each other the portions, where the sustaining discharge develops as a narrow-depth-range discharge, of the adjacent unit light emission areas in the row direction. In this way, when the sustaining discharge is initiated, a false discharge is prevented from occurring between the adjacent unit light emission areas in the row direction. Further, the clearances created between the dielectric layer and the portions of the partition wall unit on both ends of the wall unit induce the priming effect in the adjacent unit light emission areas in the row direction, as well as provide the path used for removing the air from the discharge space and introducing a discharge gas into the discharge space in the process of manufacturing the PDP.

When the period of a sustaining pulse applied to initiate the sustaining discharge is reduced in order to further improve the priming effect, the luminous efficiency can be successfully improved as compared with that of the conventional PDPs by the use of a discharge gas including a high ratio of xenon and by initiation of the sustaining discharge forming a narrow-depth-range discharge.

The formation of the narrow-depth-range discharge and the use of a discharge gas including a high ratio of xenon effectively enhance the action of the priming effect which is induced by the clearances created between the dielectric layer and the vertical wall of the partition wall unit. Thus, owing to the clearances created between the dielectric layer and the vertical wall, a higher luminous efficiency than that of the conventional PDPs can be successfully achieved.

In the PDP of the second embodiment, the wall member may be formed integrally on the partition wall unit. Alternatively, the wall member may be formed on the dielectric layer overlaying the row electrode pairs.

In the case of forming the wall member on the dielectric layer overlying the row electrode pairs, it is possible to increase the precision of positioning when the wall member is formed in the manufacturing process for the PDP.

In the PDP of the second embodiment, the wall member may be formed of the same material as that of the dielectric material used for forming the partition wall unit, or alternatively formed of a low dielectric material different from the dielectric material used for forming the partition wall unit.

If the wall member is formed of the same dielectric material as that for the partition wall unit, the wall members and the partition wall unit can be formed simultaneously and integrally. If the wall member is formed of a low dielectric material different from the dielectric material for the partition wall unit, it is possible to reduce the electrostatic capacity arising between the row electrode and the column electrode between which an address discharge is initiated, leading to a decrease in power consumption when the address discharge is initiated.

In the PDP of the second embodiment, each of the wall members is placed such that a central portion of the wall member faces the portions of the row electrodes involved in the sustaining discharge, and two ends thereof respectively extend outward from the paired row electrodes in the column direction by an equal length. For example, the column-direction length of each of the two ends extending outward in the column direction from the portions of row electrodes involved in the sustaining discharge can be set at 30 μm or less.

In this way, the wall member adequately blocks off from each other the portions of the adjacent unit light emission areas in the row direction in which the sustaining discharge develops as a narrow-depth-range discharge. As a result, a false discharge is satisfactorily prevented from occurring between the adjacent unit light emission areas in the row direction when the sustaining discharge is initiated.

In the PDP of the second embodiment, there are some possible structures for setting a column-direction width, 150 μm or less, of the portion of each of the paired row electrodes of each row electrode pair involved in a discharge initiated across the discharge gap. For example, in a first structure, each of the row electrodes has a column-direction width set at 150 μm or less. In a second structure, regarding the dielectric layer overlying the row electrode pairs, a portion of the dielectric layer placed on a leading-side portion of a column-direction width of 150 μm or less of the row electrode has a smaller thickness and the other portions of the dielectric layer has a greater thickness, so that a discharge is permitted to be initiated only between the leading-side portions, each having a column-direction width of 150 μm or less, of the row electrodes. In a third structure, the dielectric layer covers the row electrode pairs, and a secondary electron emission layer, which is formed of a high γ material, is placed on a portion of the dielectric layer facing the leading-side portions of a column-direction width of 150 μm or less of the paired row electrodes which are placed close to a discharge gap and facing the discharge gap.

With the PDP of the first structure, a significant reduction in the column-direction width of each row electrode as compared with the case of the conventional PDPs results in a significant reduction in the electrostatic capacity arising between the electrodes. In consequence, the amount of reactive current is reduced, thus making a reduction in the electrical power consumption possible.

With the PDP in the second structure, because a change in the structure of a conventional row electrode pair is unnecessary, an extensive change in the manufacturing process is unnecessary. Also, the second structure can be achieved by selectively setting a position and/or a thickness of the dielectric layer. Accordingly, the degree of flexibility in design and manufacturing is increased, thereby making it possible to reduce the manufacturing costs and enhance the product yield.

With the PDP in the third structure, since the area for initiating a discharge between the row electrodes can be freely set by changing position and/or dimensions of the secondary electron emission layer, the degree of flexibility in design and manufacturing is increased. Accordingly, it is possible for the PDP to flexibly adaptable to a modification in design and the like.

In a third embodiment of the PDP according to the present invention, each of the portions, involved in a discharge initiated across the discharge gap, of the respective row electrodes constituting each row electrode pair has a column-direction width set at 150 μm or less. Also, the discharge space defined between the front glass substrate and the back glass substrate is filled with a discharge gas including a xenon partial pressure set at 6.67 kPa or more. In addition, a portion, facing the discharge gap, of the dielectric layer overlying the row electrode pairs has a thickness smaller than that of the other portions of the dielectric layer which do not face the discharge gap.

In the PDP of the third embodiment, the portion, involved in a discharge initiated across the discharge gap between the paired row electrodes constituting each row electrode pair, among the component portions of each of the paired row electrodes has a column-direction width set at 150 μm or less, which is a small width as compared with a width ranging from 400 μm to 1000 μm in the conventional PDPs. Because of this small width, the range over which a discharge initiated between the row electrodes expands in the unit light emission area in the discharge space is narrower than that of the conventional PDPs. Thus, the area of transition of the discharge is limited to a small area in the proximity to the discharge gap corresponding to the area in which the discharge enters an initial glow discharge stage.

In this way, in the PDP of the third embodiment, vacuum ultraviolet light is generated from the xenon in the discharge gas at a significantly high efficiency as compared with that of the conventional PDPs.

With the setting of the xenon partial pressure in the discharge gas at 6.67 kPa or more, the phosphor layer is excited mainly by the molecular beam of a 172 nm wavelength in the vacuum ultraviolet light generated from the xenon in the discharge gas. The molecular beam is seldom attenuated while moving within the discharge gas in the way that the resonance line is. For this reason, even when a discharge initiated between the row electrodes is localized within the range in the vicinity of the discharge gap, the vacuum ultraviolet light properly reaches the phosphor layer. This makes it possible to directly take advantages of the property of having a significantly high efficiency in generating the vacuum ultraviolet light as compared with that in the conventional PDPs, resulting in achievement of a high luminous efficiency.

Further, a rise in the drive voltage which is caused by using a discharge gas with a high xenon partial pressure is held down by reducing the thickness of the portion of the dielectric layer facing the discharge gap to less than the thickness of the other portions of the dielectric layer. Thus, the drive voltage is reduced, thereby making it possible to achieve a reduction in the drive-circuit costs and a further increase in the luminous efficiency.

In the PDP of the third embodiment, examples of methods by which the thickness of the portion of the dielectric layer facing the discharge gap is reduced to less than that of the other portions includes a method of forming a recess in a portion, facing the discharge gap, of the face of the dielectric layer facing the discharge space.

Further, in the PDP of the third embodiment, the area in the unit light emission area in which the vacuum ultraviolet light is produced is smaller than that in the conventional PDPs. Because of this, even when the unit light emission area is surrounded by the partition wall unit, the vacuum ultraviolet light is not easily affected by the partition wall unit, which involves such things as wall loss. In addition, the use of the molecular beam in the vacuum ultraviolet light for excitation of the phosphor layer reduces the effects caused by the variations in distance between the phosphor layer and the area in which the vacuum ultraviolet light is produced. This reduction eliminates a requirement of a high precision of positioning of the row electrode pair in the unit light emission area in the column direction. This makes it possible to enhance the product yield in the manufacturing process so as to contribute to a reduction in manufacturing costs.

There are some possible structures for setting a column-direction width, 150 μm or less, of the portion of each of the paired row electrodes of each row electrode pair involved in a discharge initiated across the discharge gap. For example, in a first structure, each of the row electrodes has a column-direction width set at 150 μm or less. In a second structure, regarding the dielectric layer overlying the row electrode pairs, a portion of the dielectric layer placed on a leading-side portion of a column-direction width of 150 μm or less of the row electrode has a smaller thickness and the other portions of the dielectric layer has a greater thickness, so that a discharge is permitted to be initiated only between the leading-side portions, each having a column-direction width of 150 μm or less, of the row electrodes. In a third structure, a secondary electron emission layer, which is formed of a high γ material, is placed on a portion of the dielectric layer including the thin portion with a small thickness facing the leading-side portions of a column-direction width of 150 μm or less of the paired row electrodes which are placed close to a discharge gap and facing the discharge gap.

With the PDP of the first structure, a significant reduction in the column-direction width of each row electrode as compared with the case of the conventional PDPs results in a significant reduction in the electrostatic capacity arising between the electrodes. In consequence, the amount of reactive current is reduced, thus making a reduction in the electrical power consumption possible.

With the PDP in the second structure, because a change in the structure of a conventional row electrode pair is unnecessary, an extensive change in the manufacturing process is unnecessary. Also, the second structure can be achieved by selectively setting a position and/or a thickness of the dielectric layer. Accordingly, the degree of flexibility in design and manufacturing is increased, thereby making it possible to reduce the manufacturing costs and enhance the product yield.

With the PDP in the third structure, since the area for initiating a discharge between the row electrodes can be freely set by changing position and/or dimensions of the secondary electron emission layer, the degree of flexibility in design and manufacturing is increased. Accordingly, it is possible for the PDP to flexibly adaptable to a modification in design and the like.

Further, in a fourth embodiment of the PDP according to the present invention, each of the portions, involved in a discharge initiated across the discharge gap, of the respective row electrodes constituting each row electrode pair has a column-direction width set at 150 μm or less. Also, the discharge space defined between the front glass substrate and the back glass substrate is filled with a discharge gas including a xenon partial pressure set at 6.67 kPa or more. In addition, the dielectric layer overlying the row electrode pairs is formed of a dielectric material with a relative dielectric constant of 9.3 or less.

In the PDP of the fourth embodiment, the portion, involved in a discharge initiated across the discharge gap between the paired row electrodes constituting each row electrode pair, among the component portions of each of the paired row electrodes has a column-direction width set at 150 μm or less, which is a small width as compared with a width ranging from 400 μm to 1000 μm in the conventional PDPs. Because of this small width, the range over which a discharge initiated between the row electrodes expands in the unit light emission area in the discharge space is narrower than that of the conventional PDPS. Thus, the area of transition of the discharge is limited to a small area in the proximity to the discharge gap corresponding to the area in which the discharge enters an initial glow discharge stage.

In this way, in the PDP of the fourth embodiment, vacuum ultraviolet light is generated from the xenon in the discharge gas at a significantly high efficiency as compared with that of the conventional PDPs.

With the setting of the xenon partial pressure in the discharge gas at 6.67 kPa or more, the phosphor layer is excited mainly by the molecular beam of a 172 nm wavelength in the vacuum ultraviolet light generated from the xenon in the discharge gas. The molecular beam is seldom attenuated while moving within the discharge gas in the way that the resonance line is. For this reason, even when a discharge initiated between the row electrodes is localized within the range in the vicinity of the discharge gap, the vacuum ultraviolet light properly reaches the phosphor layer. This makes it possible to directly take advantages of the property of having a significantly high efficiency in generating the vacuum ultraviolet light as compared with that in the conventional PDPs, resulting in achievement of a high luminous efficiency.

In the PDP of the fourth embodiment, the dielectric layer overlying the row electrode pairs is formed of a low dielectric material with a relative dielectric constant of 9.3 or less, desirably, 8 or less, such as zinc oxide (ZnO) glass, a mixture of ZnO glass and phosphorus oxide (P₂O₅) glass, and the like. Thereby, in a PDP in which a narrow-depth-range discharge is produced and a discharge gas with a high xenon partial pressure is used, the amount of ionization in the sustaining discharge is held down, which leads to an improvement in efficiency in generating of the vacuum ultraviolet light, which in turn increases the quantity of vacuum ultraviolet light applied to the phosphor layer, resulting in a further improvement of the luminous efficiency.

In the PDP of the fourth embodiment, the dielectric layer is desirably formed in a film-thickness of 35 μm or more in the vertical direction with respect to the substrate.

The above setting leads to a decrease in the variations in the discharged current which are caused by the variations of the film-thickness of the dielectric layer from unit light emission area to unit light emission area. This in turn causes the variations in the luminous efficiency from unit light emission area to unit light emission area, thus making it possible to manufacture a PDP capable of exhibiting a steady luminous efficiency throughout the entire surface of the panel.

Further, in the PDP of the fourth embodiment, the area in the unit light emission area in which the vacuum ultraviolet light is produced is smaller than that in the conventional PDPs. Because of this, even when the unit light emission area is surrounded by the partition wall unit, the vacuum ultraviolet light is not easily affected by the partition wall unit, which involves such things as wall loss. In addition, the use of the molecular beam in the vacuum ultraviolet light for excitation of the phosphor layer reduces the effects caused by the variations in distance between the phosphor layer and the area in which the vacuum ultraviolet light is produced. This reduction eliminates a requirement of a high precision of positioning of the row electrode pair in the unit light emission area in the column direction. This makes it possible to enhance the product yield in the manufacturing process so as to contribute to a reduction in manufacturing costs.

There are some possible structures for setting a column-direction width, 150 μm or less, of the portion of each of the paired row electrodes of each row electrode pair involved in a discharge initiated across the discharge gap. For example, in a first structure, each of the row electrodes has a column-direction width set at 150 μm or less. Ina second structure, regarding the dielectric layer overlying the row electrode pairs, a portion of the dielectric layer placed on a leading-side portion of a column-direction width of 150 μm or less of the row electrode has a smaller thickness and the other portions of the dielectric layer has a greater thickness, so that a discharge is permitted to be initiated only between the leading-side portions, each having a column-direction width of 150 μm or less, of the row electrodes. In a third structure, a secondary electron emission layer, which is formed of a high γ material, is placed on a portion of the dielectric layer facing leading-side portions of a column-direction width of 150 μm or less of the paired row electrodes which are placed close to a discharge gap and facing the discharge gap.

With the PDP of the first structure, a significant reduction in the column-direction width of each row electrode as compared with the case of the conventional PDPs results in a significant reduction in the electrostatic capacity arising between the electrodes. In consequence, the amount of reactive current is reduced, thus making a reduction in the electrical power consumption possible.

With the PDP in the second structure, because a change in the structure of a conventional row electrode pair is unnecessary, an extensive change in the manufacturing process is unnecessary. Also, the second structure can be achieved by selectively setting a position and/or a thickness of the dielectric layer. Accordingly, the degree of flexibility in design and manufacturing is increased, thereby making it possible to reduce the manufacturing costs and enhance the product yield.

With the PDP in the third structure, since the area for initiating a discharge between the row electrodes can be freely set by changing position and/or dimensions of the secondary electron emission layer, the degree of flexibility in design and manufacturing is increased. Accordingly, it is possible for the PDP to flexibly adaptable to a modification in design and the like.

These and other objects and features of the present invention will become more apparent from the following detailed description with reference to the accompanying drawings.

### BRIEF DESCRIPTION OF THE DRAWINGS

FIG. 1 is a front view illustrating the structure of a conventional PDP.

FIG. 2 is a front view illustrating a first embodiment example according to the present invention.

FIG. 3 is sectional view taken along the V1-V1 line in FIG. 2.

FIG. 4 is a graph showing the relationship between the luminous efficiency and the electrode width in the PDP.

FIG. 5 is a graph showing typical mode transition of the discharge in the PDP.

FIG. 6 is a diagram illustrating mode transition of the sustaining discharge initiated in the discharge cell in the PDP in a conventional PDP.

FIG. 7 is a front view illustrating a second embodiment example according to the present invention.

FIG. 8 is a front view illustrating a third embodiment example according to the present invention.

FIG. 9 is a sectional view taken along the V2-V2 line in FIG. 8.

FIG. 10 is a front view illustrating a modified example of the third embodiment example.

FIG. 11 is a front view illustrating another modified example of the third embodiment example.

FIG. 12 is a front view illustrating a fourth embodiment example according to the present invention.

FIG. 13 is a sectional view taken along the V3-V3 line in FIG. 12.

FIG. 14 is a table showing the relationship between xenon partial pressure and helium partial pressure in regard to the luminous efficiency in a fifth embodiment example according to the present invention.

FIG. 15 is a graph representing the table in FIG. 14.

FIG. 16 is a front view illustrating a sixth embodiment example according to the present invention.

FIG. 17 is a partially enlarged view of the sixth embodiment example.

FIG. 18 is a front view illustrating a seventh embodiment example according to the present invention.

FIG. 19 is a partially enlarged view of the seventh embodiment example.

FIG. 20 is a front view illustrating an eighth embodiment example according to the present invention.

FIG. 21 is a partially enlarged view of the eighth embodiment example.

FIG. 22 is a front view illustrating a ninth embodiment example according to the present invention.

FIG. 23 is a sectional view taken along the V4-V4 line in FIG. 22.

FIG. 24 is a perspective view illustrating a partition wall unit of the PDP in the ninth embodiment example.

FIG. 25 is a graph showing the relationship between the luminous efficiency and the sustaining pulse period in the PDP.

FIG. 26 is a graph showing a comparison of the relationship between the length of clearance and the luminous efficiency in the PDP of the ninth embodiment and that in a conventional PDP.

FIG. 27 is a perspective view illustrating a tenth embodiment example according to the present invention.

FIG. 28 is a front view illustrating an eleventh embodiment example according to the present invention.

FIG. 29 is a sectional view taken along the V5-V5 line in FIG. 28.

FIG. 30 is a front view illustrating a twelfth embodiment example according to the present invention.

FIG. 31 is a sectional view taken along the V6-V6 line in FIG. 30.

FIG. 32 is a front view illustrating a thirteenth embodiment example according to the present invention.

FIG. 33 is a sectional view taken along the V7-V7 line in FIG. 32.

FIG. 34 is a front view illustrating a fourteenth embodiment example according to the present invention.

FIG. 35 is a sectional view taken along the V8-V8 line in FIG. 34.

FIG. 36 is a front view illustrating a fifteenth embodiment example according to the present invention.

FIG. 37 is a sectional view taken along the V9-V9 line in FIG. 36.

FIG. 38 is a graph showing the relationship between the luminous efficiency and the drive voltage in a PDP in which a narrow-depth-range discharge is produced.

FIG. 39 is a graph showing the relationship between the luminous efficiency and the drive voltage in a conventional PDP.

FIG. 40 is a front view illustrating a sixteenth embodiment example according to the present invention.

FIG. 41 is a sectional view taken along the V10-V10 line in FIG. 40.

FIG. 42 is a front view illustrating a seventeenth embodiment example according to the present invention.

FIG. 43 is a sectional view taken along the V11-V11 line in FIG. 42.

FIG. 44 is a front view illustrating a modified example of the seventeenth embodiment example.

FIG. 45 is a front view illustrating another modified example of the seventeenth embodiment example.

FIG. 46 is a front view illustrating an eighteenth embodiment example according to the present invention.

FIG. 47 is a sectional view taken along the V12-V12 line in FIG. 46.

FIG. 48 is a front view illustrating a nineteenth embodiment example according to the present invention.

FIG. 49 is a sectional view taken along the V13-V13 line in FIG. 48.

FIG. 50 is a table showing the relationship between the discharged current, the luminous efficiency, and the relative dielectric constant of the dielectric in a PDP in which a narrow-depth-range discharge is produced and a discharge gas with a high xenon partial pressure is used.

FIG. 51 is a graph representing the relationship between the discharged current, the luminous efficiency, and the relative dielectric constant of the dielectric shown in FIG. 50.

FIG. 52 is a graph showing the relationship between the discharged current, the luminous efficiency, and the relative dielectric constant of the dielectric in a conventional PDP.

FIG. 53 is a graph showing the relationship between the thickness of the dielectric film and the di electric capacity in a PDP.

FIG. 54 is a graph showing the relationship between the thickness of the dielectric film and the rate of change in the dielectric capacity in a PDP.

FIG. 55 is a front view illustrating a twentieth embodiment example according to the present invention.

FIG. 56 is a sectional view taken along the V14-V14 line in FIG. 55.

FIG. 57 is a front view illustrating a twenty-first embodiment example according to the present invention.

FIG. 58 is a sectional view taken along the V15-V15 line in FIG. 57.

FIG. 59 is a front view illustrating a modified example of the twenty-first embodiment example.

FIG. 60 is a front view illustrating another modified example of the twenty-first embodiment example.

FIG. 61 is a front view illustrating a twenty-second embodiment example according to the present invention.

FIG. 62 is a sectional view taken along the V16-V16 line in FIG. 61.

### DETAILED DESCRIPTION OF THE PREFERRED EMBODIMENTS

First Embodiment Example

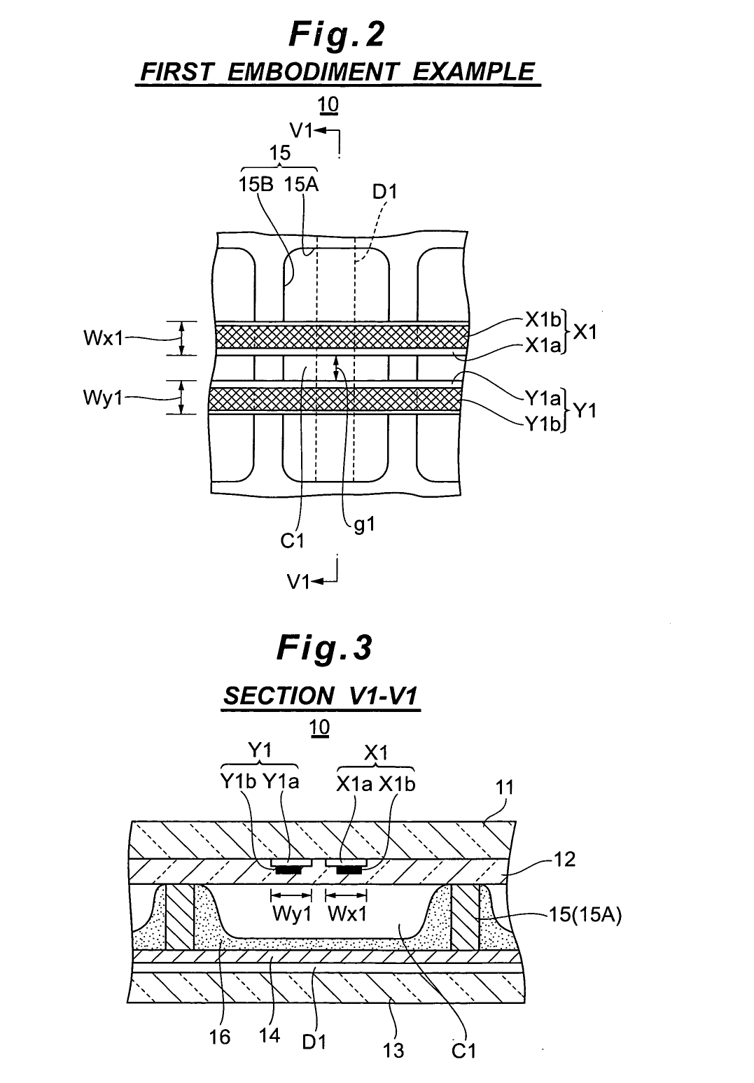

FIGS. 2, 3 illustrate a first embodiment example of the embodiment of a PDP according to the present invention. FIG. 2 is a schematic front view showing part of the PDP in the first embodiment example FIG. 3 is a sectional view taken along the V1-V1 line in FIG. 2.

In FIGS. 2 and 3, the PDP 10 has a front glass substrate 11 serving as the display surface. A plurality of row electrode pairs (X1, Y1) extending in the row direction (the right-left direction in FIG. 2) are regularly arranged at required intervals in the column direction (the up-down direction in FIG. 2) on the rear-facing face (the face facing toward the rear of the PDP) of the front glass substrate 11.

One row electrode X1 constituting part of each row electrode pair (X1, Y1) is composed of a transparent electrode X1a and a bus electrode X1b. The transparent electrode X1a extends in a belt shape in the row direction on the rear-facing face of the front glass substrate 11, and is formed of a transparent conductive film such as ITO. The bus electrode X1b extends in a belt shape in the row direction on a central portion of the rear-facing face of the transparent electrode X1a, and has a width in the column direction smaller than that of the transparent electrode X1a. The bus electrode X1b is formed of a metal film.

As is the case of the row electrode X1, the other row electrode Y1 constituting part of each row electrode pair (X1, Y1) is composed of a transparent electrode Y1a and a bus electrode Y1b. The transparent electrode Y1a extends in a belt shape in the row direction and is placed on the rear-facing face of the front glass substrate 11 parallel to the transparent electrode X1a of the row electrode X1 and at a required interval from it. The transparent electrode Y1a is formed of a transparent conductive film such as ITO. The bus electrode Y1b extends in a belt shape in the row direction on a central portion of the rear-facing face of the transparent electrode Y1a, and has a width in the column direction smaller than that of the transparent electrode Y1a. The bus electrode Y1b is formed of a metal film.

The row electrodes X1, Y1 are arranged in alternate positions in the column direction of the front glass substrate 11. In each row electrode pair (X1, Y1), the distance, set at the required width, between the opposing transparent electrodes X1a, Y1a of the respective row electrodes X1, Y1 paired with each other forms a discharge gap g1.

A dielectric layer 12 is provided on the rear-facing face of the front glass substrate 11 so as to cover the row electrode pairs (X1, Y1).

The entire dielectric layer 12 is in turn overlaid with a secondary electron emission layer (not shown) formed of a high γ material such as magnesium oxide (MgO).

A back glass substrate 13 is placed parallel to the front glass substrate 11 with a discharge space in between.

A plurality of column electrodes D1 extending in a belt shape in the column direction are regularly arranged at required intervals in the row direction on the face of the back glass substrate 13 facing the front glass substrate 11.

On this face of the back glass substrate 13, a column-electrode protective layer (dielectric layer) 14 is formed so as to cover the column electrodes D1.

A partition wall unit 15 having a shape as described below is in turn formed on the column-electrode protective layer 14.

The partition wall unit 15 is formed in an approximate grid shape made up of plurality of transverse walls 15A and a plurality of vertical walls 15B. Each of the transverse walls 15A extends in the row direction in correspondence with the mid-position between two row electrode pairs (X1, Y1) which are arranged adjacent to each other in the column direction on the front glass substrate 11. The vertical walls 15B extend in the column direction and are regularly arranged at required intervals in the row direction.

The partition wall unit 15 partitions the discharge space defined between the front glass substrate 11 and the back glass substrate 13 into approximately quadrate areas to form a plurality of discharge cells C1 arranged in matrix form over the panel surface.

The row electrode pairs (X1, Y1) are arranged so as to correspond with the central portions of the respective discharge cells C1.

Phosphor layers 16 are provided in the respective discharge cells C1. Each of the phosphor layers 16 fully overlies the five faces facing the discharge space in each discharge cell C1: the face of the column-electrode protective layer 14 and the four side faces of the transverse walls 15A and the vertical walls 15B of the partition wall unit 15. The three primary colors, red, green and blue, are applied individually to the phosphor layers 16 formed in the respective discharge cells C1, so that the three primary colors are arranged in order in the row direction.

The discharge space is filled with a discharge gas that includes xenon.

The following are the size of the row electrodes X1, Y1 and the composition of the discharge gas in the above PDP 10.

The, column-direction width of each row electrode X1, Y1, namely, a column-direction width Wx1 of the transparent electrode X1a and a column-direction width Wy1 of the transparent electrode Y1a (see FIG. 2), is set at 150 μm or less.

The xenon partial pressure in the discharge gas of the total pressure of 66.7 kPa (500 Torr) which fills the discharge space is set at 6.67 kPa (50 Torr) or more.

The PDP 10 applies a scan pulse sequentially to the row electrodes Y1 of the respective row electrode pairs (X1, Y1), and simultaneously applies a data pulse selectively to the column electrodes D1, whereupon an address discharge is initiated between the row electrode Y1 and the column electrode D1 in each of the discharge cells C1 located corresponding to the intersections of the row electrodes Y1 that receive the scan pulse and the column electrodes D1 that receive the data pulse. As a result of the address discharge, the light-emitting cells (which are the discharge cells C1 in which a wall charge accumulates on the portions of the dielectric layer 12 facing them) and the non-light-emitting cells (which are the discharge cells C1 in which the wall charge is erased from the portions of the dielectric layer 12 facing them) are distributed over the panel surface in accordance with the image data of the video signal.

Subsequently, a sustaining pulse is applied alternately to the row electrodes X1, Y1 in each row electrode pair (X1, Y1), where upon a sustaining discharge is initiated across the discharge gap g1 between the transparent electrodes X1a, Y1a in each light-emitting cell.

The sustaining discharge in each light-emitting cell results in the generation of vacuum ultraviolet light from the xenon included in the discharge gas filling the discharge space. The vacuum ultraviolet light excites the red, green and blue phosphor layers 16 provided in the light-emitting cells. The excited phosphor layers 16 produce visible light, thus generating a matrix-display image on the panel surface.

In the foregoing PDP 10, the column-direction width Wx1 of each of the row electrodes X1 and the column-direction width Wy1 of each of the row electrodes Y1 are each set at 150 μm or less, and the xenon partial pressure in the discharge gas of the total pressure of 66.7 kPa (500 Torr) is set at 6.67 kPa (50 Torr) or more. This setting enables the achievement of a high luminous efficiency when a sustaining discharge as described above is initiated for the image generation. The reasons for this are as described below.

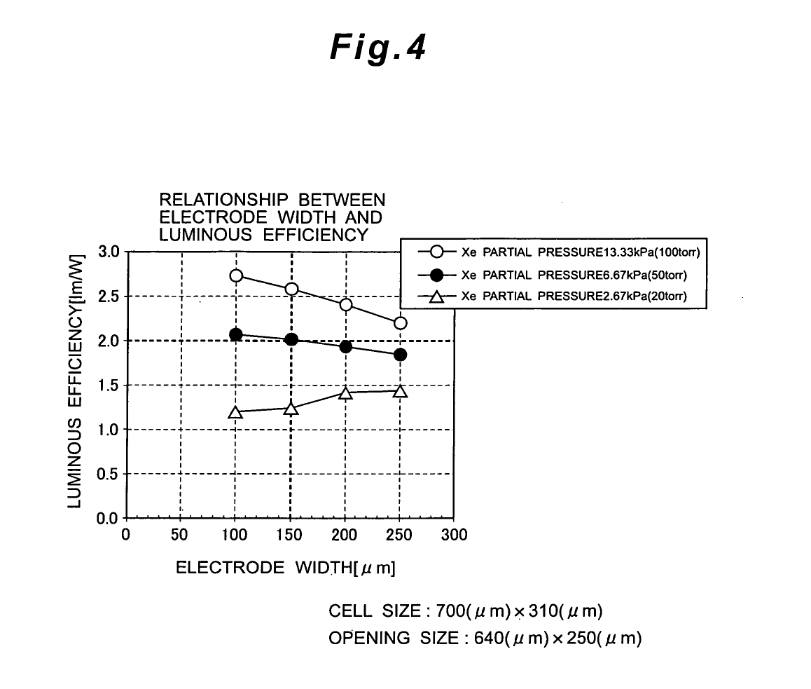

FIG. 4 shows the relationship between the luminous efficiency and the column-direction width of the row electrode (hereinafter abbreviated as “electrode width”) in the PDP.

Note that FIG. 4 shows the measurement results when the size of the discharge cell is 700 (μm)×310(μm) and the opening size is 640 (μm)×250 (μm).

In FIG. 4, the luminous efficiency decreases as the electrode width is reduced, when the xenon partial pressure is less than 6.67 kPa (50 Torr) (FIG. 4 shows the case of a xenon partial pressure of 2.67 kPa (20 Torr)).

When the xenon partial pressure is 6.67 kPa (50 Torr) or more, the luminous efficiency increases as the electrode width is reduced. The increase in the luminous efficiency becomes more and more conspicuous as the xenon partial pressure is increased (FIG. 4 shows the case of a xenon partial pressure of 13.33 kPa (100 Torr).

An effective value for the luminous efficiency required in the PDP is 2.0 (1 m/W) or more.

Accordingly, it is seen from FIG. 4 that the luminous efficiency of 2.0 (1 m/W) or more is able to be achieved in the PDP 10 when the xenon partial pressure in the discharge gas is set at 6.67 kPa (50 Torr) or more and also each of the electrode widths Wx1, Wy1 of the row electrodes X1, Y1 is set at 150 μm or less.

The following is the reason why the luminous efficiency increases with a reduction in the electrode width when the xenon partial pressure in the discharge gas is 6.67 kPa (50 Torr) or more.

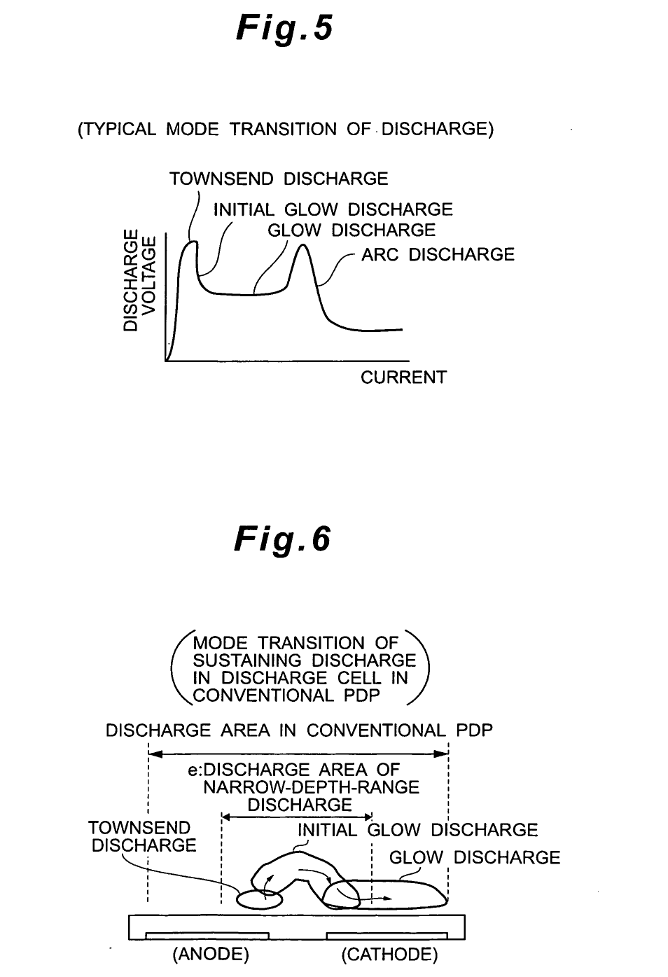

FIG. 5 is a graph showing the typical mode transition of the discharge. FIG. 6 is a diagram illustrating the mode transition of the sustaining discharge in a conventional discharge cell.

As shown in FIGS. 5, 6, the sequence of the transition of sustaining discharge, which is initiated in the discharge cell for the image generation as described earlier, is from a Townsend discharge to an initial glow discharge and then to a glow discharge.

The stages used for the generation of the vacuum ultraviolet light when an image is generated on the PDP are generally the initial glow discharge and glow discharge stages in the sustaining discharge.

In the initial glow discharge stage of the stages used for generating the vacuum ultraviolet light, the vacuum ultraviolet light is generated at a significantly high efficiency. This is because there is no energy loss in a region where a cathode fall mainly due to ions occurs around the cathode at a stage before the space charge is completely localized.

In the glow discharge stage following the initial glow discharge stage, the formation of the cathode fall region induces a very strong electric field in the discharge space, thereby producing a large amount of high energy electrons. A large amount of vacuum ultraviolet light is produced in a negative glow region corresponding to the exit of the strong electric field. However, energy loss is produced in the cathode fall region. Inconsequence, the vacuum ultraviolet light is not produced at as high an efficiency as compared with that in the initial glow discharge stage.

As shown in FIG. 6, a sustaining discharge initiated in a discharge cell of the PDP typically develops three-dimensionally from the anode toward the cathode of the row electrode pair in its mode transition.

The electrode widths Wx1, Wy1 of the row electrodes X1, Y1 of the PDP 10 are each set at 150 μm or less. The range over which the sustaining discharge expands in the discharge cell C1 of the PDP 10 is narrower than that of the conventional PDPs. Thus, the area of transition of the sustaining discharge is limited to a small area close to the discharge gap g1 (the area indicated with the letter e in FIG. 6).

In the PDP 10, a sustaining discharge that develops in a small area close to the discharge gap g1 is hereinafter referred to as “a narrow-depth-range discharge”.

The transition area of the narrow-depth -range discharge covers the area of the initial glow discharge (shown in FIG. 6) in which the vacuum ultraviolet light is highly efficiently produced as described earlier.

In consequence, in the PDP 10 having the row electrodes X1, Y1 of a 150 μm or less electrode width Wx1, Wy1, a sustaining discharge appears as a narrow-depth-range discharge. This makes it possible to generate vacuum ultraviolet light at a significantly higher efficiency than that in the conventional PDPs.

However, as in the case of the conventional PDPs, the PDP 10 uses a discharge gas with a low xenon partial pressure filling the discharge space, and the phosphor layer 16 is excited by a resonance line of a 147 nm wavelength which is the main component of the vacuum ultraviolet light generated from the xenon in the discharge gas. At this point, the sustaining discharge produced as a narrow-depth-range discharge in the PDP 10 is localized in a range close to the discharge gap g1. This localization gives rise to an increase in the attenuation of the resonance line in the vacuum ultraviolet light until it reaches the phosphor layer 16.

As a rule, when the xenon partial pressure in a discharge gas of a total pressure of 66.7 kPa (500 Torr) is in a range from 2.67 kPa to 3.33 kPa (20 Torr to 25 Torr), it is known that the main component of vacuum ultraviolet light generated from the discharge gas is a resonance line of a 147 nm wavelength. The resonance line is attenuated by approximately half when moving 100 μm within the discharge gas under the condition that the xenon partial pressure is in a range from 2.67 kPa to 3.33 kPa (20 Torr to 25 Torr).

In the PDP 10, the xenon partial pressure in the discharge gas of a total pressure of 66.7 kPa (500 Torr) is set at 6.67 kPa (50 Torr) or more. Because of this, the phosphor layer 16 is excited mainly by a molecular beam of a 172 nm wavelength in the vacuum ultraviolet light generated from the xenon in the discharge gas.

The molecular beam in the vacuum ultraviolet light is seldom attenuated in the process of moving within the discharge gas in the way that the resonance line is.

In the PDP, accordingly, although the sustaining discharge, which is a narrow-depth -range discharge, is localized in the range close to the discharge gap g1, the vacuum ultraviolet light fully reaches the phosphor layer 16. Also, the sustaining discharge appears as a narrow-depth-range discharge, which thus directly takes advantage of its property of having a significantly high efficiency in generating the vacuum ultraviolet light as compared with that in the conventional PDPs. In consequence, a high luminous efficiency is able to be achieved.

The foregoing advantageous effects can also be exerted in a PDP having a stripe-shaped partition wall unit. In the PDP 10, the partition wall unit 15 is formed in an approximate grid shape, which thus allows for the provision of the phosphor layer 16 on the four side faces of the transverse walls 15A and vertical walls 15B surrounding each discharge cell C1 so as to increase the surface area of the phosphor layer 16, resulting in the achievement of an even higher luminous efficiency.

The column-direction width of the row electrodes X1, Y1 of the PDP 10 is significantly smaller than that of the conventional PDPs, which thus massively reduces the electrostatic capacity arising between the electrodes. In consequence, the amount of reactive current is reduced, thus making it possible to reduce the electrical power consumption.

The foregoing describes the example of the row electrode pair (X1, Y1) of the PDP 10 being placed facing a central portion of each discharge cell C1 in the column direction. However, the row electrode pair (X1, Y1) may be placed in any position higher or lower (in FIG. 2) than the central portion in the column direction in each discharge cell C1.

This is for the following reasons.

In the conventional PDPs, a sustaining discharge results in a wide-range discharge expanding throughout a discharge cell as described earlier. In this case, if the row electrode pair is placed in a position higher or lower than the central position, in the column direction, of each of the discharge cells which are defined by a grid-shaped partition wall unit, the discharge gap is located closer to the upper or lower transverse wall of the partition wall unit defining each dischargecell. As a result, variations in voltage margin, brightness, luminous efficiency and the like occur from discharge cell to discharge cell, and those then adversely affect light emission. To avoid this problem, a high precision of positioning of the row electrode pair in each discharge cell is required.

However, in the PDP 10, the sustaining discharge results in a narrow-depth -range discharge with a narrow discharge area as described earlier, and the area in which vacuum ultraviolet light is produced is a so-called point light source which is smaller than that of the conventional PDPs. Thus, the vacuum ultraviolet light is not easily affected by the partition wall unit, which involves such things as wall loss. Also, the phosphor layer 16 is excited by use of a 172 nm-wavelength molecular beam, which is not much absorbed, in the vacuum ultraviolet light. This reduces the effects caused by the variations in distance between the phosphor layer 16 and the discharge area (the area in which the vacuum ultraviolet light is produced) of the sustaining discharge. In consequence, even if the position of the row electrode pair (X1, Y1) in each discharge cell C1 in the column direction is out of the central position of the discharge cell C1, the brightness and luminous efficiency seldom vary.

Accordingly, with the PDP 10, even when each of the discharge cells C1 is surrounded by the transverse walls 15A and the vertical walls 15B of the approximately grid-shaped partition wall unit 15, the position of the discharge gap (i.e. the position of the row electrode pair) need not be aligned with the column-direction central position of the discharge cell, resulting in an increase in tolerance in the precision of positioning of the row electrode pair (X1, Y1) in each discharge cell C1. This makes it possible to enhance the product yield in the manufacturing process and to contribute to a reduction in manufacturing costs.

The foregoing describes the example of a transparent electrode constituting part of the row electrode being formed in a belt shape continuously extending between adjacent discharge cells along the bus electrode. However, a transparent electrode may be formed independently in each discharge cell and connected to the bus electrode.

The foregoing describes the example of a row electrode made up of the transparent electrode and the bus electrode. However, the row electrode may be made up of a metal-made bus electrode alone and have a width of 150 μm or less in the column direction.

Second Embodiment Example

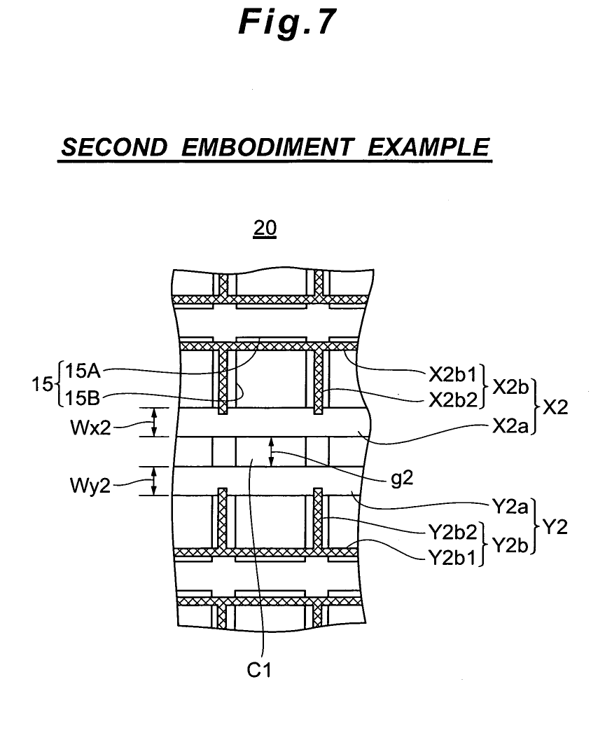

FIG. 7 is a schematic front view illustrating part of the PDP of a second embodiment example according to the present invention.

The second embodiment example uses the same reference numerals in FIG. 7 as those used in FIGS. 2, 3 to describes the same components as those of the PDP in the first embodiment example.

In the first embodiment example, the bus electrode of each of the row electrodes making up the row electrode pair of the PDP is disposed in an approximately central portion of the rear-facing face of the transparent electrode. By contrast, in the PDP 20 of the second embodiment example, row electrodes X2, Y2 constituting each of the row electrode pairs (X2, Y2) are each made up of transparent electrodes X2a, Y2a and bus electrodes X2b, Y2b. The transparent electrodes X2a, Y2a are placed in correspondence with the column-direction central portion of each discharge cell C1 defined by an approximately-grid-shaped partition wall unit 15. The bus electrodes X2b, Y2b are placed close to the respective transverse walls 15A defining the two opposing sides of the discharge cell C1, and are connected to the respective transparent electrodes X2a, Y2a.

In FIG. 7, the discharge space of the PDP 20 is partitioned into approximately quadrate areas by the partition wall unit 15 which is of an approximate grid shape made up of transverse walls 15A and vertical walls 15B to form the discharge cells C1, as in the case of the first embodiment example.

The belt-shaped transparent electrodes X2a, Y2a of the respective row electrodes X2, Y2 constituting the row electrode pair (X2, Y2) are spaced at a required interval (discharge gap g2) and extend parallel to each other in the row direction in positional correspondence with the column-direction central portion of each discharge cell C1.

The transparent electrodes X2a, Y2a each have a column-direction width (Wx2, Wy2) set at 150 μm or less.

The bus electrodes X2b, Y2b are each made up of bus-electrode bodies X2b1, Y2b1 and bus-electrode connecting portions X2b2, Y2b2. Each of the bus-electrode bodies X2b1, Y2b1 extends in a belt shape in the row direction along the inner edge of the transverse wall 15A of the partition wall unit 15. The bus-electrode connecting portions X2b2, Y2b2 each extend in the column direction between the bus-electrode bodies X2b1, Y2b1 and the transparent electrodes X2a, Y2a in parallel to the vertical wall 15B of the partition wall unit 15 for the connection between the bus-electrode bodies X2b1, Y2b1 and the transparent electrodes X2a, Y2a.

The rest of the structure in the second embodiment example is similar to that in the first embodiment example. The xenon partial pressure in the discharge gas of the total pressure of 66.7 kPa (500 Torr) filling the discharge gas is set at 6.67 kPa or more (50 Torr or more).

In the first embodiment example, the bus electrode formed of a metal film is disposed facing the central portion of the discharge cell. Therefore, the opening of the discharge cell is divided into two in the column direction by the bus electrodes that do not have light transmission properties. By contrast, in the PDP 20 of the second embodiment example, the bus-electrode bodies X2b1, Y2b1 of the bus electrodes X2b, Y2b formed of a metal film are placed close to the transverse walls 15A of the partition wall 15. In this way, the opening of the discharge cell C1 is not divided into two by the bus electrodes X2b, Y2b as is done in the first embodiment example.

The characteristics of the second embodiment example are that the intensity of the light emission increases gradually toward the discharge gap and decreases gradually toward the transverse walls. With this structure, the portion in the discharge cell with a high intensity of light emission is not obstructed by the bus electrode, resulting in the achievement of a higher luminous efficiency.

In the PDP 20, further, because the bus-electrode connecting portions X2b2, Y2b2 are placed opposite to the transverse walls 15B of the partition wall unit 15, part of the opening of the discharge cell C1 is not blocked by the formation of the bus-electrode connecting portions X2b2, Y2b2.

The foregoing describes the example of the bus-electrode bodies X2b1, Y2b1 of the bus electrodes X2b, Y2b being placed close to the transverse walls 15A of the partition wall unit 15 and facing the discharge cell C1. However, the bus-electrode bodies X2b1, Y2b1 may be placed opposite to the transverse walls 15A of the partition wall unit 15. In this case, the bus-electrode bodies X2b1, Y2b1 do not block the opening of the discharge cell C1, thus eliminating the risk of the entire area of the bus electrodes X2b, Y2b becoming obstacles to light emission from the phosphor layer.

In the PDP 20, the column-direction width (electrode width) Wx2 of the transparent electrode X2a of the row electrode X2 and the column-direction width (electrode width) Wy2 of the transparent electrode Y2a of the row electrode Y2 are each set at 150 μm or less. With this setting, as in the case of the first embodiment example, the sustaining discharge initiated between the transparent electrodes X2a and Y2a results in a narrow-depth-range discharge. In consequence, the vacuum ultraviolet light is generated at a very high efficiency as compared with the conventional PDPs. Also, by setting the xenon partial pressure in the discharge gas filling the discharge space at 6.67 kPa (50 Torr) or more, the phosphor layer 16 is excited mainly by the 172 nm-wavelength molecular beam, which is seldom attenuated, in the vacuum ultraviolet light generated from the xenon in the discharge gas, resulting in achievement of an increase in luminous efficiency as compared with the conventional PDPs.

The foregoing advantageous effects can also be exerted in a PDP having a stripe-shaped partition wall unit. In the PDP 20, the partition wall unit 15 is formed in an approximate grid shape, which thus allows for the provision of the phosphor layer on the four side faces of the transverse walls 15A and vertical walls 15B surrounding each discharge cell C1 so as to increase the surface area of the phosphor layer, resulting in a further improvement of the luminous efficiency.

The column-direction width of each of the transparent electrodes X2a, Y2a of the row electrodes X2, Y2 of the PDP 20 is significantly smaller than that of the conventional PDPS. This means that the electrostatic capacity arising between the electrodes is massively reduced. In consequence, the amount of reactive current is reduced, thus making it possible to reduce the electrical power consumption.

The row electrode pair (X2, Y2) of the PDP 20 may be placed in any position higher or lower (in FIG. 7) than the central portion in the column direction in each discharge cell C1 for the same reasons as those described in the first embodiment example. In consequence, the tolerance in the precision of positioning of the row electrode pair (X2, Y2) in each discharge cell C1 is increased. Accordingly, it is possible to contribute to a reduction in manufacturing costs because of the enhancement of the product yield in the manufacturing process.

The foregoing describes the example of a transparent electrode constituting part of the row electrode being formed in a belt shape continuously extending between adjacent discharge cells along the bus electrode. However, a transparent electrode may be formed independently in each discharge cell and connected to the bus electrode.

Third Embodiment Example

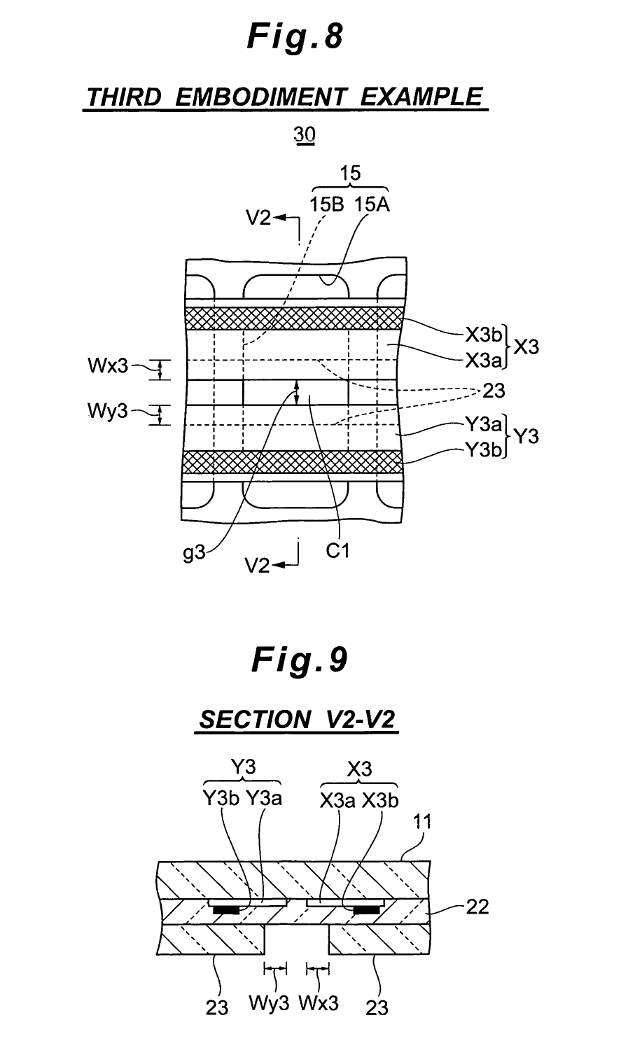

FIGS. 8, 9 illustrate a third embodiment example according to the present invention. FIG. 8 is a schematic front view showing part of the PDP of the third embodiment example. FIG. 9 is a sectional view taken along the V2-V2 line in FIG. 8.

The third embodiment example uses the same reference numerals in FIGS. 8, 9 as those used in FIGS. 2, 3 to describe the same components as those of the PDP in the first embodiment example.

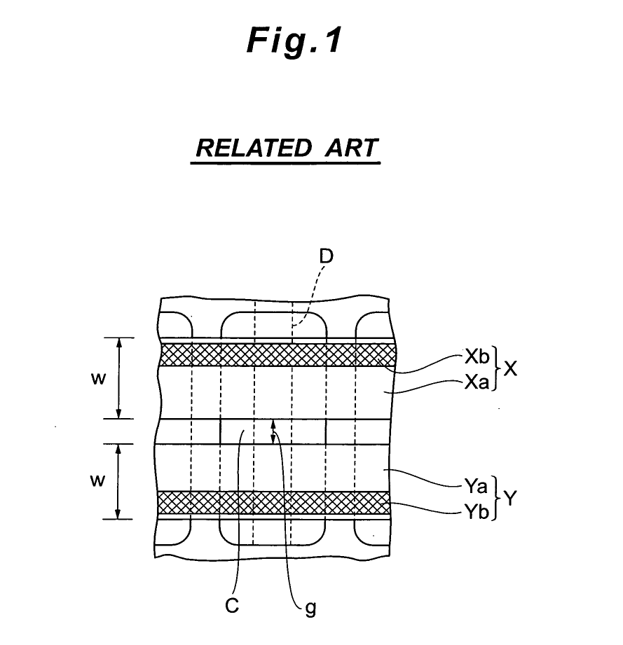

In the case of the PDP of the first embodiment example, the column-direction width of the transparent electrode of each row electrode is changed in order for the sustaining discharge to develop as a narrow-depth-range discharge. By contrast, in the PDP 30 of the third embodiment example, row electrode pairs (X3, Y3) each similar in size to those of the conventional PDPs (see FIG. 1) are arranged facing the discharge cells C1 defined by a partition wall unit 15 of an approximate grid shape. Second dielectric layers 23 are formed on the required portions of the rear-facing face, which faces the discharge space, of a first dielectric layer 22 which is provided for covering the row electrode pairs (X3, Y3), in such a manner as to reduce the column-electrode width of each of the portions of the row electrodes X3, Y3 between which a discharge is substantially initiated in each discharge cell C1. In this way, a sustaining discharge develops as a narrow-depth-range discharge.

Specifically, transparent electrodes X3a, Y3a are provided on the rear-facing face of a front glass substrate 11 of the PDP 30. The transparent electrodes X3a, Y3a are each formed in a belt shape of a similar column-direction width, e.g. 400 μm to 1000 μm, to that of the conventional PDP illustrated in FIG. 1. The transparent electrodes X3a, Y3a are spaced at a required interval (discharge gap g3) and extend parallel to each other in the row direction. Bus electrodes X3b, Y3b of a belt shape extending in the row direction are formed on the respective outer sides (away from the leading sides facing each other across the discharge gap) of the rear-facing faces of the transparent electrodes X3a, Y3a, and are connected to the respective transparent electrodes X3a, Y3a.

The row electrode pairs (X3, Y3) are overlaid with the first dielectric layer 22 formed on the rear-facing face of the front glass substrate 11.

The second dielectric layers 23 are laid, as described below, on the required portions of the rear-facing face of the first dielectric layer 22.

A secondary electron emission layer (not shown) is in turn formed so as to fully overlie the first dielectric layer 22 and second dielectric layers 23.

The second dielectric layers 23 are formed on the portions of the rear-facing face of the first dielectric layer 22 other than the belt-shaped portions which each extend in the row direction in positional correspondence with the discharge gap g3, and with the leading-side portions, having the column-direction widths Wx3, Wy3 of 150 μm or less and facing each other across the discharge gap g3, of the transparent electrodes X3a, Y3a of the row electrodes X3, Y3.

The thickness of the first dielectric layer 22 overlying the row electrode pairs (X3, Y3) is approximately equal to that of the conventional PDPs in which a discharge results in the accumulation of a wall charge. The thickness of each of the second dielectric layers 23 is greater than that of the first dielectric layer 22. The total thickness of the lamination of the first dielectric layer 22 and second dielectric layer 23 is set at a thickness which exceeds twice the thickness of the first dielectric layer 22 so as to make a wall charge seldom accumulate during a discharge.

The discharge space is filled with a discharge gas at a total pressure of 66.7 kPa (500 Torr) with a xenon partial pressure of 6.67 kPa (50 Torr) or more.

Each of the row electrodes X3, Y3 of each row electrode pair (X3, Y3) of the PDP 30 has a column-direction width approximately equal to that of the conventional PDPs. Each of the portions of the respective transparent electrodes X3a, Y3a the row electrodes X3, Y3, other than the leading-side portions of the column-direction widths Wx3, Wy3 facing each other across the discharge gap g3, is covered with the double dielectric layer made up of the laminated first and second dielectric layers 22, 23. Thus, the dielectric layer overlying these portions other than the leading-side portions of the column-direction width Wx3, Wy3 has a greater thickness than that of the dielectric layer overlying the leading-side portions. As a result, the wall charge seldom accumulates on the thicker portion of the second dielectric layer 23 deposited on the first dielectric layer 22, and accumulates on the surface of the first dielectric layer 22 overlying the leading-side portions of the column-direction widths Wx3, Wy3 of the transparent electrodes X3a, Y3a.

In this way, in the PDP 30, when a sustaining pulse is applied to the row electrode pair (X3, Y3) so as to initiate a sustaining discharge across the discharge gap g3 between the transparent electrodes X3a, Y3a, almost all of the sustaining discharge develops only on the leading-side portions of the column-direction widths Wx3, Wy3 of the transparent electrodes X3a, Y3a, resulting in the formation of a narrow-depth-range discharge as described in the first embodiment example.

With the PDP 30 designed as described above, as in the case of the first embodiment example, a sustaining discharge develops as a narrow-range discharge. This means that vacuum ultraviolet light is generated at a very high efficiency as compared with the conventional PDPs. Also, the xenon partial pressure in the discharge gas filling the discharge space is set at 6.67 kPa (50 Torr) or more. In this way, the phosphor layer is excited mainly by a 172 nm-wavelength molecular beam, which is seldom attenuated, in the vacuum ultraviolet light generated from the xenon in the discharge gas. This results in the achievement of an increase in luminous efficiency as compared with the conventional PDPs.

The row electrode pair (X3, Y3) of the PDP 30 may be placed in any position higher or lower (in FIG. 8) than the central position in the column direction in each dis charge cell C1 for the same reasons as those described in the first embodiment example. In consequence, the tolerance in the precision of positioning of the row electrode pair (X3, Y3) in each discharge cell C1 is increased. Accordingly, it is possible to contribute to a reduction in manufacturing costs because of the enhancement of the product yield in the manufacturing process.

In addition to similar advantageous effects to those in the first embodiment example, because the column-direction width of the transparent electrodes X3a, Y3a has a similar size to those in the conventional PDPs and the bus electrodes X3b, Y3b are placed at a distance from the discharge gap g3, the effect of the metal-film-formed bus electrodes X3b, Y3b on light emission from the phosphor layer is reduced, resulting in enhancement of the efficiency of the extraction of visible light.

The characteristics of the third embodiment example are that the intensity of the light emission increases gradually toward the discharge gap and decreases gradually toward the transverse walls. With this structure, the portion in the discharge cell with a high intensity of light emission is not obstructed by the bus electrode, resulting in the achievement of a higher luminous efficiency.

The design of the PDP 30 enables a simplification of the structure for reducing the effect of the bus electrode on the light emission from the phosphor layer as compared with the case of the PDP of the second embodiment example.

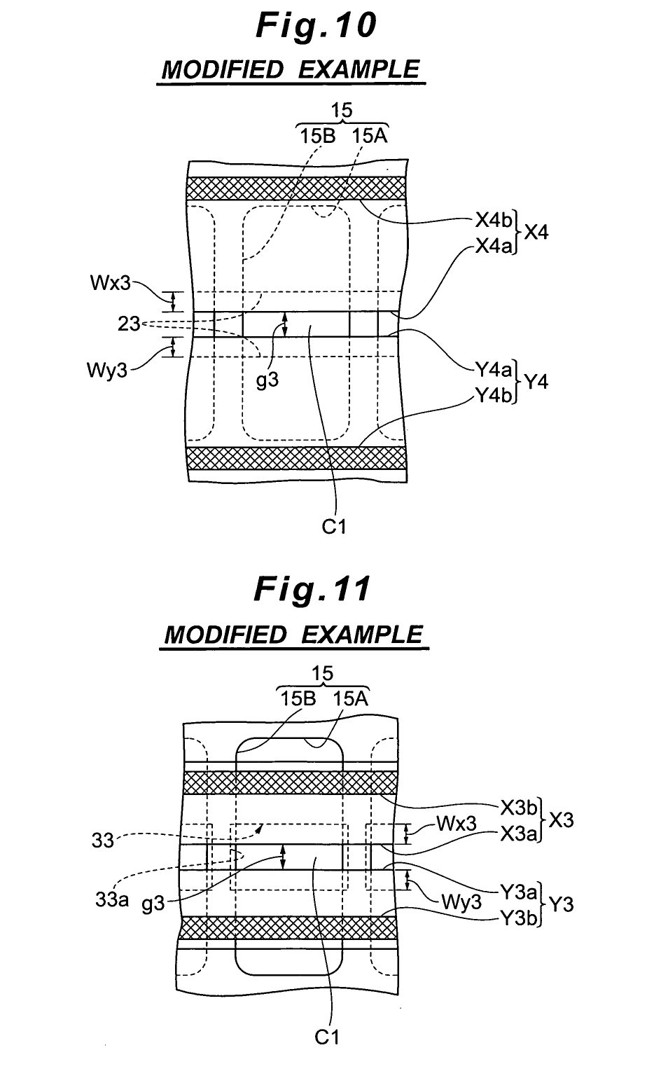

For example, FIGS. 8, 9 show the example of the bus electrodes X3b, Y3b being placed facing the opening of the discharge cell C1, but, as illustrated in FIG. 10, bus electrodes X4b, Y4b of the respective row electrodes X4, Y4 constituting a row electrode pair (X4, Y4) may be placed away from the opening of the discharge cell C1. This placement eliminates the effect of the bus electrodes X4b, Y4b on the light emission from the phosphor layer, leading to the achievement of a massive increase in the efficiency of the extraction of visible light.

Since the structure of the row electrode pair (X3, Y3) of the PDP 30 is similar to the conventional structure, an extensive change in the manufacturing process is unnecessary. Further, since the position for forming the second dielectric layer 23 can be freely determined, the degree of flexibility in design and manufacturing is increased. Accordingly, it is possible to reduce the manufacturing costs and contribute to product yield.

The foregoing describes the example of the transparent electrode, making up part of the row electrode, being formed in a belt shape continuously extending between adjacent discharge cells along the associated bus electrode. However, a transparent electrode may be formed independently in each discharge cell and connected to the associated bus electrode.

The foregoing describes the example of the second dielectric layers 23 each extending in a belt shape in the row direction. However, the second dielectric layers placed on the first dielectric layer 22 may be a second dielectric layer 33 as illustrated in FIG. 11 which may be formed in an approximate grid shape having quadrate openings 33a aligned with the openings of the respective discharge cells C1. By use of the openings 33a, the thickness of the dielectric layer overlying the portions other than the leading-side portions of the column-direction widths Wx3, Wy3 of the respective transparent electrodes X3a, Y3a and the discharge gap g3 between them may be set such that a wall charge is not accumulated thereon.

Fourth Embodiment Example

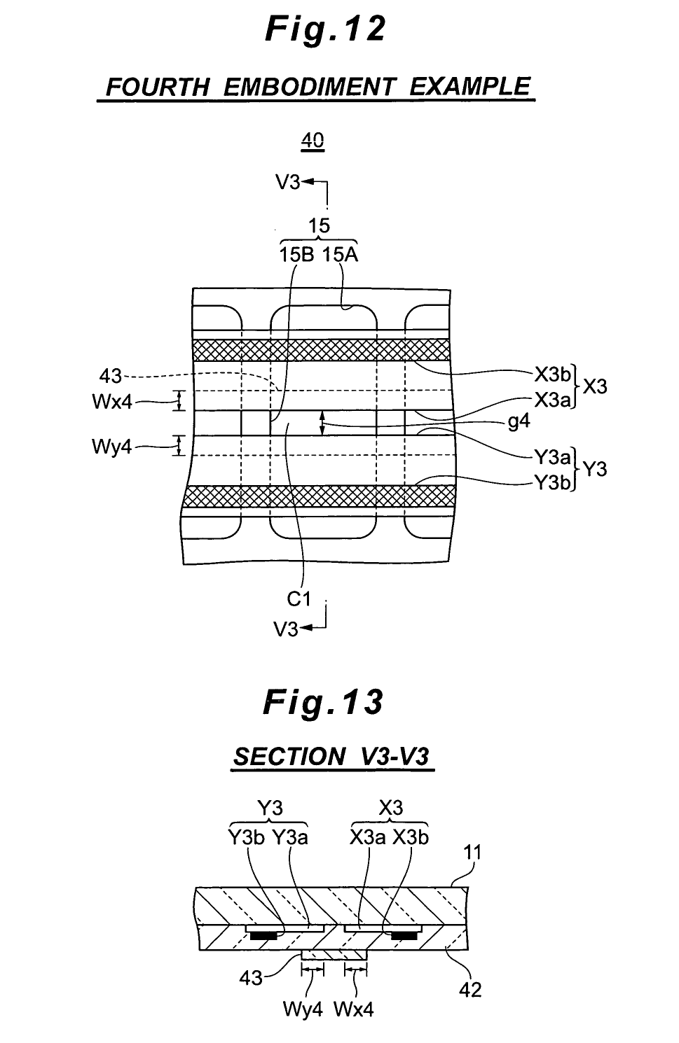

FIGS. 12, 13 illustrate a fourth embodiment example according to the present invention. FIG. 12 is a schematic front view showing part of the PDP of the fourth embodiment example. FIG. 13 is a sectional view taken along the V3-V3 line in FIG. 12.

The fourth embodiment example uses the same reference numerals in FIGS. 12, 13 as those used in FIGS. 8, 9 to describe the same components as those of the PDP in the third embodiment example.

In the PDP of the third embodiment example, a narrow-depth -range discharge is produced by using the second dielectric layer, which is positioned on the first dielectric layer overlying the row electrode pairs, to limit the discharge range of a sustaining discharge. By contrast, in the PDP 40 of the fourth embodiment example, row electrode pairs (X3, Y3) each having a similar size to that of the conventional PDPs (see FIG. 1) are arranged facing the discharge cells C1 defined by a partition wall unit 15 of an approximate grid shape. Secondary electron emission layers 43, which are formed of a high γ material such as MgO, are formed in a belt shape extending in the row direction only on the required portions of the rear-facing face, which faces the discharge space, of a dielectric layer 42 which is provided for covering the row electrode pairs (X3, Y3). A sustaining discharge initiated between the transparent electrodes X3a, Y3a develops as a narrow-depth-range discharge due to the secondary electron emission layer 43.

Specifically, the transparent electrodes X3a, Y3a are provided on the rear-facing face of the front glass substrate 11 of the PDP 40. The transparent electrodes X3a, Y3a are each formed in a belt shape of a similar column-direction width, e.g. 400 μm to 1000 μm, to that of the conventional PDP illustrated in FIG. 1. The transparent electrodes X3a, Y3a are spaced at a required interval (discharge gap g4) and extend parallel to each other in the row direction. The bus electrodes X3b, Y3b of a belt shape extending in the row direction are formed on the respective outer sides of the rear-facing aces often transparent electrodes X3a, Y3a, and are connected to the respective transparent electrodes X3a, Y3a.

The row electrode pairs (X3, Y3) are overlaid with the dielectric layer 42 formed on the rear-facing face of the front glass substrate 11.

The secondary electron emission layers 43 are in turn formed on the rear-facing face of the dielectric layer 42. Each of the secondary electron emission layers 43 is formed of a high γ material such as MgO and extends in a belt shape in the row direction in positional correspondence with the discharge -gap g4 and the leading-side portions of the column-direction width Wx4, Wy4 of the respective transparent electrodes X3a, Y3a placed across the discharge gap g4.

An example of various methods of forming the secondary electron emission layers 43 is here described: a mask having openings made in positional correspondence with the secondary electron emission layers 43 is laid between the dielectric layer 42 and a material evaporation source of a high γ material, and then a high γ material vapor is generated from the material evaporation source and deposited on the portions of the dielectric layer 42 corresponding to the mask openings so as to form layers.

The column-direction widths Wx4, Wy4 of the portions of each of the secondary electron emission layers 43 facing the respective transparent electrodes X3a, Y3a are each set at 150 μm or less.

The xenon partial pressure in the discharge gas of a total pressure of 66.7 kPa (500 Torr) filling the discharge space is set at 6.67 kPa (50 Torr) or more.

The column-direction width of each of the row electrodes X3, Y3 of the row electrode pair (X3, Y3) of the PDP 40 has approximately the same size as that of the conventional PDPs. However, the PDP 40 has the secondary electron emission layers 43 formed of a high γ material and each placed on the portion of the dielectric layer 42 corresponding to the discharge gap g4 and the leading-side portion of the column-direction width Wx4, Wy4 of the transparent electrodes X3a, Y3a across the discharge gap g4. As a result, almost all of the sustaining discharge initiated between the transparent electrodes X3a, Y3a develops within the area in which the secondary electron emission layer 43 is formed. This means that the sustaining discharge appears as a narrow-depth-range discharge as described in the first embodiment example.

As described above, the sustaining discharge develops as a narrow-depth-range discharge as in the case of the first embodiment example. Thus, in the PDP 40, the vacuum ultraviolet light is generated at a very high efficiency as compared with the conventional PDPs. Also, by setting the xenon partial pressure in the discharge gas filling the discharge space at 6.67 kPa (50 Torr) or more, the phosphor layer is excited mainly by the 172 nm-wavelength molecular beam, which is seldom attenuated, in the vacuum ultraviolet light generated from the xenon in the discharge gas, resulting in the achievement of an increase in luminous efficiency as compared with the conventional PDPS.

The row electrodes (X3, Y3) of the PDP 40 may be placed in any position higher or lower (in FIG. 12) than the central position in the column direction in each discharge cell C1 for the same reasons as those described in the first embodiment example. In consequence, the tolerance in the precision of positioning of the row electrode pair (X3, Y3) in each discharge cell C1 is increased. Accordingly, it is possible to contribute to a reduction in manufacturing costs because of the enhancement of the product yield in the manufacturing process.

In addition to similar advantageous effects to those in the first embodiment example, because the column-direction width of the transparent electrodes X3a, Y3a has a similar size to those in the conventional PDPs and the bus electrodes X3b, Y3b are placed at a distance from the discharge gap g4, the effect of the metal-film-formed bus electrodes X3b, Y3b on light emission from the phosphor layer is reduced, resulting in enhancement of the efficiency of the extraction of visible light.

The characteristics of the fourth embodiment example are that the intensity of the light emission in creases gradually toward the discharge gap and decreases gradually toward the transverse walls. With this structure, the portion in the discharge cell with a high intensity of light emission is not obstructed by the bus electrode, resulting in the achievement of a higher luminous efficiency.

The design of the PDP 40 enables simplification of the structure for reducing the effect of the bus electrode on the light emission from the phosphor layer as compared with the case of the PDP of the second embodiment example.

With the structure of the PDP 40, the area of producing a narrow-depth-range discharge can be freely set by changing the size and/or the position of the secondary electron emission layers 43. In consequence, the degree of flexibility in design and manufacturing is increased, and thus the PDP 40 is flexibly adaptable to a modification in design and the like.

The foregoing describes the example of the secondary electron emission layer 43 being formed in a belt shape in the row direction. However, a secondary electron emission layer may be formed independently in a so-called is land form in each discharge cell.

The foregoing describes the example of a transparent electrode constituting part of the row electrode being formed in a belt shape continuously extending between adjacent discharge cells along the bus electrode. However, a transparent electrode may be formed independently in each discharge cell and connected to the bus electrode.

Fifth Embodiment Example The structure of a PDP of a fifth embodiment example according to the present invention is approximately the same as that of the PDP of the first embodiment example described in FIGS. 2, 3. The PDP of the fifth embodiment example is described with reference to FIGS. 2, 3, using the same reference numerals as those in FIGS. 2, 3.

The column-direction width of each row electrode X1, Y1 of the PDP of the fifth embodiment example, namely, column-direction widths (electrode width) Wx1, Wy1 of the transparent electrodes X1a, Y1a, is set at 150 μm or less.

The discharge space of this PDP is filled with a discharge gas of a total pressure of 66.7 kPa (500 Torr) which includes a xenon partial pressure of 6.67 kPa (50 Torr) or more, and a helium partial pressure of 8.00 kPa or more, preferably, 10.00 kPa or more.

The discharge gas contains another main component, neon.

The electrode widths Wx1, Wy1 of the transparent electrodes X1a, Y1a are each set at 150 μm or less and the helium partial pressure of 8.00 kPa or more is included in the discharge gas of the total pressure of 66.7 kPa including the xenon partial pressure of 6.67 kPa or more. In consequence, the luminous efficiency is further improved as compared with the use of a discharge gas without helium.

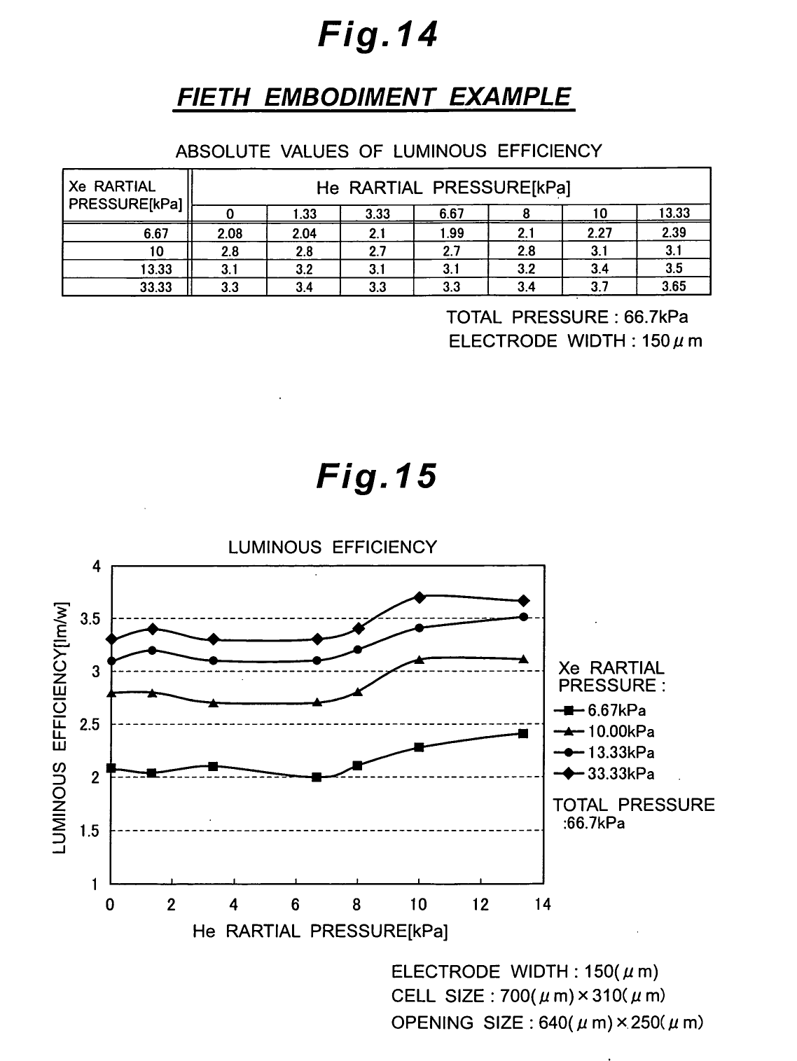

FIG. 14 is a table showing the values of luminous efficiencies (absolute values) in the PDP having the electrode width set at 150 μm and having the size of the discharge cell C1 set at 700 (μm)×310 (μm) and the opening size set at 640 (μm)×250 (μm) as in the case shown in FIG. 4, wherein, in the discharge gas of a total pressure of 66.7 kPa (500 Torr), the xenon partial pressure is set at 6.67 kPa (50 Torr), 10.00 kPa (75 Torr), 13.33 kPa (100 Torr), and 33.33 kPa (250 Torr), and the helium partial pressure is set at zero kPa, 1.33 kPa (10 Torr), 3.33 kPa (25 Torr), 6.67 kPa (50 Torr), 8.00 kPa (60 Torr), 10.00 kPa (75 Torr), 13.33 kPa (100 Torr).

FIG. 15 is a graph showing the values in the table in FIG. 14.

A relationship between the xenon partial pressure and the luminous efficiency in a PDP is as described on the basis of FIG. 4 in the first embodiment example. In order to achieve the required luminous efficiency of 2.0 (1 m/W) or more in the PDP having the foregoing electrode width, cell size and opening size, the necessary xenon partial pressure in the discharge gas of a total pressure of 66.7 kPa (500 Torr) is 6.67 kPa (50 Torr) or more.

Then, as shown in FIGS. 14, 15, the higher the helium partial pressure in the discharge gas, the greater the luminous efficiency becomes. When the xenon partial pressure is 6.67 kPa or more and the helium partial pressure is set at 8.00 kPa or more, whatever the setting of the xenon partial pressure, the improvement in luminous efficiency of the PDP results. In consequence, the luminous efficiency is 2.0 (1 m/W) or more, which is required in the PDP.

As seen from FIGS. 14, 15, the use of a discharge gas with a helium partial pressure of 10.00 kPa or more yields a distinct improvement of a 10% to 15% increase in the luminous efficiency as compared with the use of a discharge gas without helium.

A possible reason why the addition of helium to the discharge gas provides the improvement of the luminous efficiency of the PDP as compared with a discharge gas without helium is that helium further increases the ratio of the vacuum ultraviolet light generated from the xenon in the discharge gas by initiating a discharge to the molecular beam, resulting in an increase in the efficiency of irradiating the phosphor layer with the vacuum ultraviolet light.

In the PDP, as in the case of the first embodiment example, the transparent electrode constituting part of the row electrode may be formed in a belt shape continuously extending between adjacent discharge cells along the associated bus electrode, or alternatively formed independently in each discharge cell and connected to the bus electrode.

In the PDP, as in the case of the first embodiment, the row electrode may be formed of a metal-made bus electrode alone and has a column-direction width set at 150 μm or less.

The fifth embodiment example describes the case when helium is added to the discharge gas used in the PDP of the structure shown in FIGS. 2, 3 of the first embodiment. Correspondingly, when helium is added to the discharge gas used in any PDP of the structure shown in FIG. 7 of the second embodiment example, the structure shown in FIGS. 8 to 11 of the third embodiment example, and the structure shown in FIGS. 12, 13 of the fourth embodiment example, the luminous efficiency of the PDP is improved.

Sixth Embodiment Example

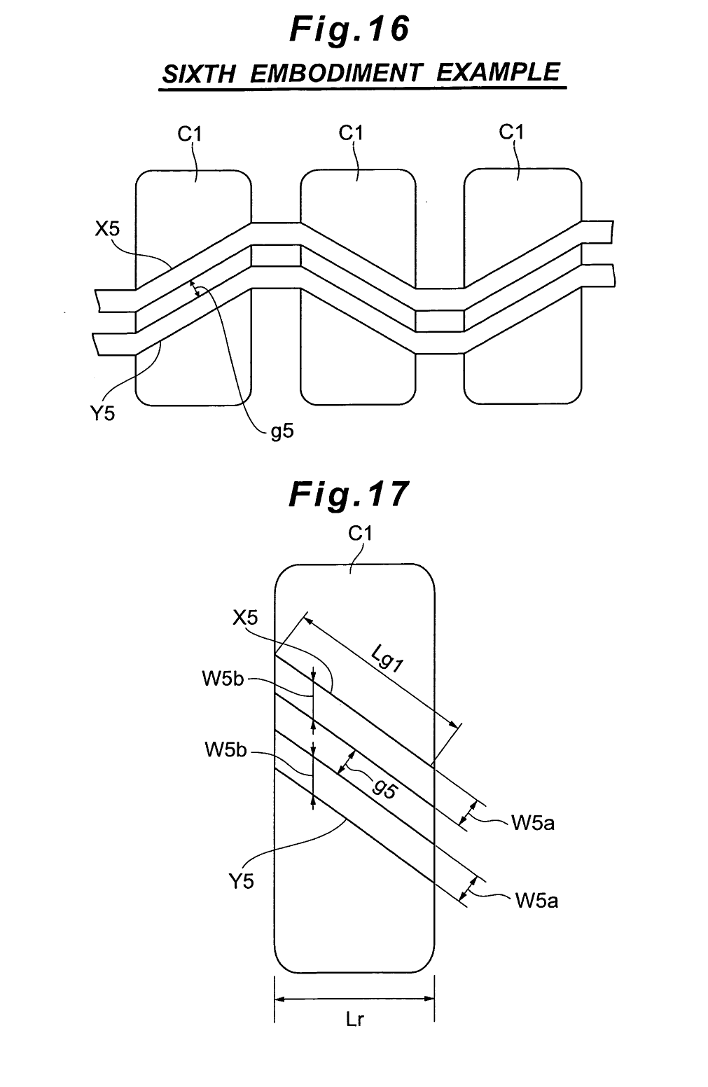

FIGS. 16, 17 illustrate a PDP of a sixth embodiment example according to the present invention. FIG. 16 is a front view showing the shape of a row electrode of the PDP in this embodiment example. FIG. 17 is an enlarged view of part of the row electrode facing a discharge cell.

In FIGS. 16, 17, row electrodes X5, Y5 constituting each of the row electrode pairs (X5, Y5) face each other across a discharge gap g5. The portions of the row electrodes X5, Y5 facing each discharge cell C1 extend in a direction inclined to the row direction at a predetermined angle (e.g. 45 degrees) while constantly keeping the discharge gap g5.

Then, the portions of the row electrodes X5, Y5 facing an adjacent discharge cell C1 extend in the reverse direction of the inclination. The row electrodes XS, Y5 extend in such a manner as to form an approximate V shape throughout two adjacent discharge The rest of the structure of the PDP in the sixth embodiment example is approximately the same as that in the first embodiment example. Each of the row, electrodes X5, Y5 may be made up of a transparent electrode and a bus electrode formed on the transparent electrode, or alternatively of a metal-made bus electrode alone, as in the case of the first embodiment example.

In each of the row electrodes X5, Y5 the width W5a in a direction at right angles to the extending direction of the row electrode is set at 150 μm or less. The discharge cell C1 is filled with a discharge gas at a total pressure of 66.7 kPa (500 Torr) including a xenon partial pressure of 6.67 kPa (50 Torr) or more.

In the PDP, although the column-direction width W5b of the portions of the row electrodes X5, Y5 facing each discharge cell C1 exceeds 150 μm, the width W5a in a direction at right angles to the extending direction of each of the row electrodes X5, Y5 is 150 μm or less. For this reason, as described on the basis of FIG. 6 in the first embodiment example, the transition area of the sustaining discharge expanding in a direction at right angles to the extending direction of the discharge gap g5 (in the direction parallel to the row electrodes X5, Y5) with the discharge gap g5 as base point is limited to the proximity of the discharge gap g5, and covers the area of development of an initial glow discharge during which vacuum ultraviolet light is generated at a very high efficiency.

In this way, because the sustaining discharge initiated between the row electrodes X5, Y5 develops as a narrow-depth-range discharge, the PDP is capable of generating vacuum ultraviolet light at a very high efficiency as compared with that in the conventional PDPs. Further, because the discharge cells C1 of the PDP are filled with a discharge gas with a xenon partial pressure of 6.67 kPa (50 Torr) or more, an increase in luminous efficiency as compared with the conventional PDPs is achieved.

If the discharge gas additionally contains helium at a partial pressure of 8.00 (60 Torr) or more, the luminous efficiency of the PDP is further improved as described in the fifth embodiment.

The portions of the row electrodes X5, Y5 of the PDP facing each discharge cell C1 are inclined with reference to the discharge cell C1, so as to have a length Lg1 longer than the row-direction width Lr of the discharge cell C1.

For example, when the angle of the inclination of the row electrodes X5, Y5 is 45 degrees, Lg1 is equal to the square root of 2Lr.

In this way, the area of development of the narrow-depth-range discharge in the discharge cell C1 expands along the extending direction of the discharge gap g5 (the direction parallel to the row electrodes X5, Y5), resulting in a reduction in the drive voltage of the PDP and the improvement of brightness.

In particular, when the high xenon partial pressure in the discharge gas is set as in the case of the PDP of the sixth embodiment example, the drive voltage typically rises. However, with the structure described in this embodiment example, even when a high xenon partial pressure in the discharge gas is set, a rise in the drive voltage can be successfully held down.

For example, when the width W5a is set at 150 μm and the Lg1-to-Lr ratio is set at 1.4:1 in FIG. 17, and the xenon partial pressure in the discharge gas of a total pressure of 66.7 kPa (500 Torr) in the discharge cell C1 is set at 6.67 kPa (50 Torr), the drive voltage is reduced by 4% and the brightness is improved 1.4 times as compared with the PDP of the first embodiment example.

Seventh Embodiment Example

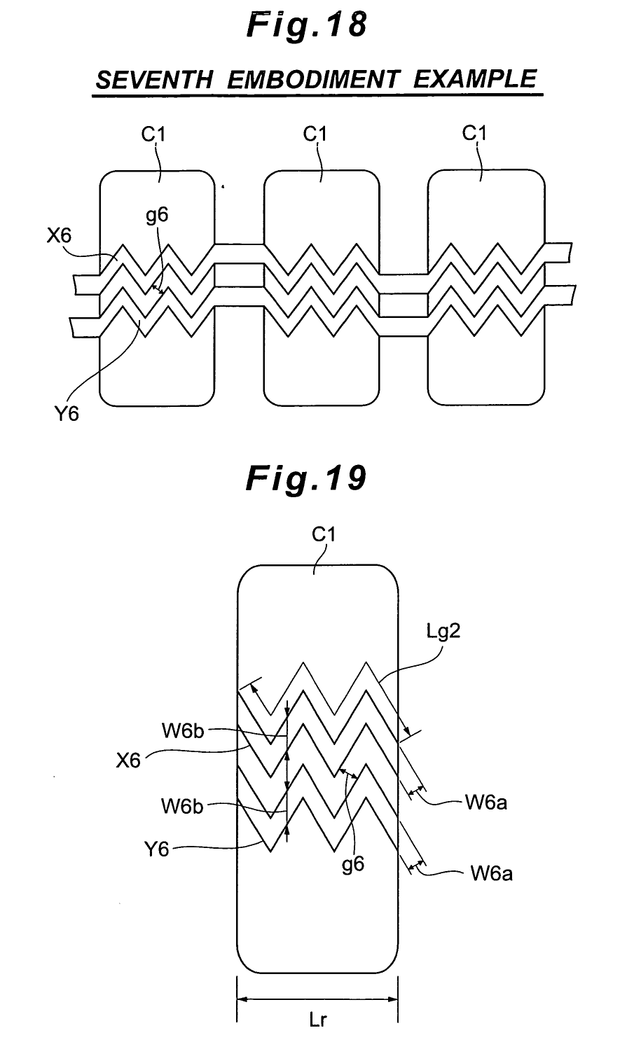

FIGS. 18, 19 illustrate a PDP of a seventh embodiment example according to the present invention. FIG. 18 is a front view showing the shape of a row electrode of the PDP in this embodiment example. FIG. 19 is an enlarged view of part of the row electrode facing a discharge cell.

In FIGS. 18, 19, row electrodes X6, Y6 constituting each of the row electrode pairs (X6, Y6) face each other across a discharge gap g6. The portions of the row electrodes X6, Y6 facing each discharge cell C1 are formed in a twisting shape by being bent in an approximately W shape while constantly keeping the discharge gap g6.

The rest of the structure of the PDP in the seventh embodiment example is approximately the same as that in the first embodiment example. Each of the row electrodes X6, Y6 may be made up of a transparent electrode and a bus electrode formed on the transparent electrode, or alternatively of a metal-made bus electrode alone, as in the case of the first embodiment example.

In each of the row electrodes X6, Y6 the width W6a in a direction at right angles to the extending direction of the row electrode is set at 150 μm or less. The discharge cell C1 is filled with a discharge gas at a total pressure of 66.7 kPa (500 Torr) including a xenon partial pressure of 6.67 kPa (50 Torr) or more.

In the PDP; although the column-direction width W6h of the portions of the row electrodes X6, Y6 facing each discharge cell C1 exceeds 150 μm, the width W6a in a direction at right angles to the extending direction of each of the row electrodes X6, Y6 is 150 μm or less. For this reason, as in the case of the sixth embodiment example, the transition area of the sustaining discharge expanding in a direction at right angles to the extending direction of the discharge gap g6 (to the direction parallel to the row electrodes X6, Y6) with the discharge gap g6 as base point is limited in the proximity of the discharge gap g6, and covers the area of development of an initial glow discharge during which vacuum ultraviolet light is generated at a very high efficiency.

In this way, because the sustaining discharge initiated between the row electrodes X6, Y6 develops as a narrow-depth-range discharge, the PDP is capable of generating vacuum ultraviolet light at a very high efficiency as compared with that in the conventional PDPs. Further, because the discharge cells C1 of the PDP is filled with a discharge gas with the xenon partial pressure of 6.67 kPa (50 Torr) or more, an increase in luminous efficiency as compared with the conventional PDPs is achieved.

If the discharge gas additionally contains helium at a partial pressure of 8.00 (60 Torr) or more, the luminous efficiency of the PDP is further improved as described in the fifth embodiment.

The portion of each of the row electrodes X6, Y6 of the PDP facing each discharge cell C1 is repeatedly bent within the area corresponding to the discharge cell C1, so as to have a length Lg2 longer than the row-direction width Lr of the discharge cell C1.

For example, when the inclining angle of the row electrodes X6, Y6 with reference to the column direction of the discharge cell C1 is 60 degrees, Lg2 is equal to 2Lr.

In this way, the area of development of the narrow-depth-range discharge in the discharge cell C1 expands along the extending direction of the discharge gap g6 (the direction parallel to the row electrodes X6, Y6), resulting in a reduction in the drive voltage of the PDP and an improvement in brightness.

In particular, when a high xenon partial pressure in the discharge gas is set as in the case of the PDP of the seventh embodiment example, the drive voltage typically rises. However, with the structure described in this embodiment example, even when a high xenon partial pressure in the discharge gas is set, a rise in the drive voltage can be successfully held down.

For example, when the width W6a is set at 150 μm and the Lg2-to-Lr ratio is set at 2.0:1.0 in FIG. 19, and the xenon partial pressure in the discharge gas of a total pressure of 66.7 kPa (500 Torr) in the discharge cell is set at 6.67 kPa (50 Torr), the drive voltage is reduced by 8% and the brightness is improved 2 times as compared with the PDP of the first embodiment example.

Eighth Embodiment Example

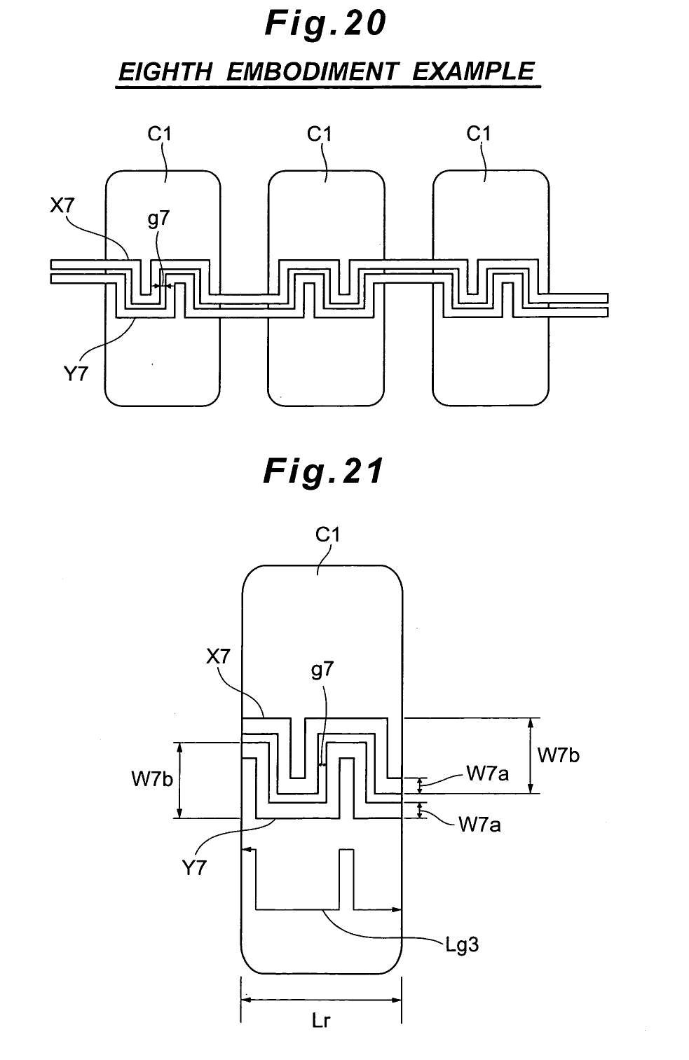

FIGS. 20, 21 illustrate a PDP of an eighth embodiment example according to the present invention. FIG. 20 is a front view showing the shape of a row electrode of the PDP in this embodiment example. FIG. 21 is an enlarged view of part of the row electrode facing a discharge cell.

In FIGS. 20, 21, row electrodes X7, Y7 constituting each of the row electrode pairs (X7, Y7) face each other across a discharge gap g7. The portions of the row electrodes X7, Y7 facing each discharge cell C1 are formed in a twisting shape by being bent in an approximate angular C shape while constantly keeping the discharge gap g7.

The rest of the structure of the PDP in the eighth embodiment example is approximately the same as that in the first embodiment example. Each of the row electrodes X7, Y7 may be made up of a transparent electrode and a bus electrode formed on the transparent electrode, or alternatively of a metal-made bus electrode alone, as in the case of the first embodiment example.

In each of the row electrodes X7, Y7 the width W7a in the extending direction of the row electrode and a direction at right angles to the extending direction (in the column direction and the row direction) is set throughout 150 μm or less. The discharge cell C1 is filled with a discharge gas at a total pressure of 66.7 kPa (500 Torr) including a xenon partial pressure of 6.67 kPa (50 Torr) or more.

In the PDP, although the width (length) W7b of the portions of the row electrodes X7, Y7 facing each discharge cell C1 and extending in the column direction exceeds 150 μm, the width W7a a direction at right angles to the extending direction of each of the row electrodes X7, Y7 is 150 μm or less. For this reason, as in the case of the sixth embodiment example, the transition area of the sustaining discharge expanding in a direction at right angles to the extending direction of the discharge gap g7 (to the direction parallel to the row electrodes X7, Y7) with the discharge gap g7 as base point is limited in the proximity of the discharge gap g7, and covers the area of development of an initial glow discharge during which vacuum ultraviolet light is generated at a very high efficiency.

In this way, because the sustaining discharge initiated between the row electrodes X7, Y7 develops as a narrow-depth-range discharge, the PDP is capable of generating vacuum ultraviolet light at a very high efficiency as compared with that in the conventional PDPs. Further, because the discharge cells C1 of the PDP is filled with a discharge gas with a xenon partial pressure of 6.67 kPa (50 Torr) or more, an increase in luminous efficiency as compared with the conventional PDPs is achieved.

If the discharge gas additionally contains helium at a partial pressure of 8.00 kPa (60 Torr) or more, the luminous efficiency of the PDP is further improved as described in the fifth embodiment.

The portion of each of the row electrodes X7, Y7 of the PDP facing each discharge cell C1 is repeatedly bent within the area corresponding to the discharge cell C1, so as to have a length Lg3 longer than the row-direction width Lr of the discharge cell C1.

For example, when the portion of each of the row electrode X7, Y7 facing the discharge cell C1 includes a portion extending in the row direction and a portion extending in the column direction, both equally Lr in length, Lg3 is equal to 2Lr.

In this way, the area of development of the narrow-depth-range discharge in the discharge cell C1 expands along the extending direction of the discharge gap g7 (the direction parallel to the row electrodes X7, Y7), resulting in a reduction in the drive voltage of the PDP and an improvement in brightness

In particular, when a high xenon partial pressure in the discharge gas is set as in the case of the PDP of the eighth embodiment example, the drive voltage typically rises. However, with the structure described in this embodiment example, even when a high xenon partial pressure in the discharge gas is set, a rise in the drive voltage can be successfully held down.

For example, when the width W7a is set at 150 μm and the Lg3-to-Lr ratio is set at 2.0:1.0 in FIG. 21, and the xenon partial pressure in the discharge gas of a total pressure of 66.7 kPa (500 Torr) in the discharge cell is set at 6.67 kPa (50 Torr), the drive voltage is reduced by 8% and the brightness is improved 2 times as compared with the PDP of the first embodiment example.

Ninth Embodiment Example

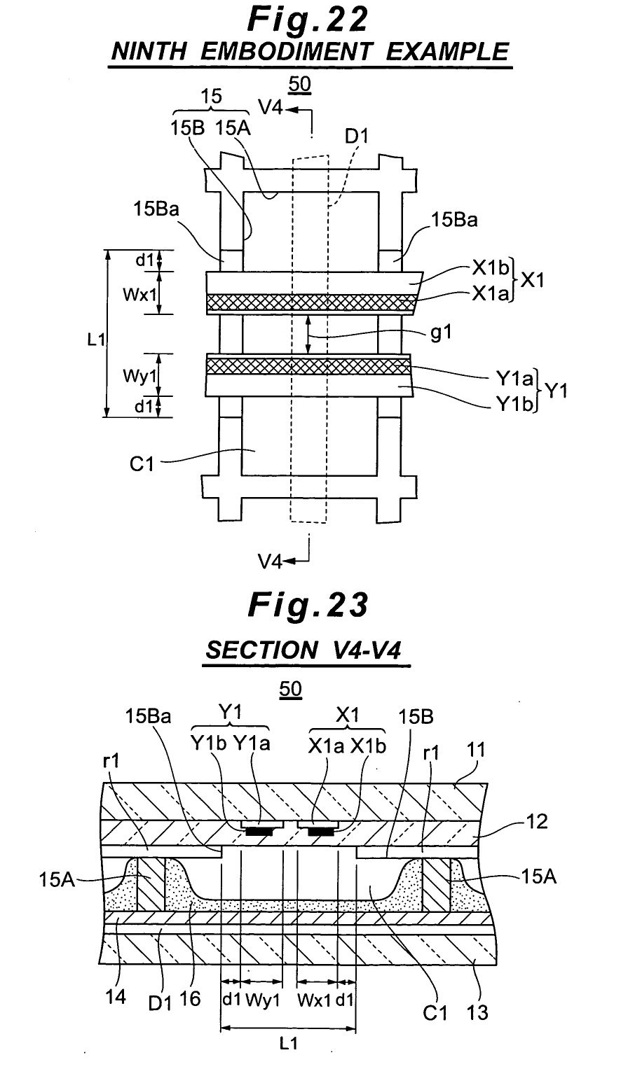

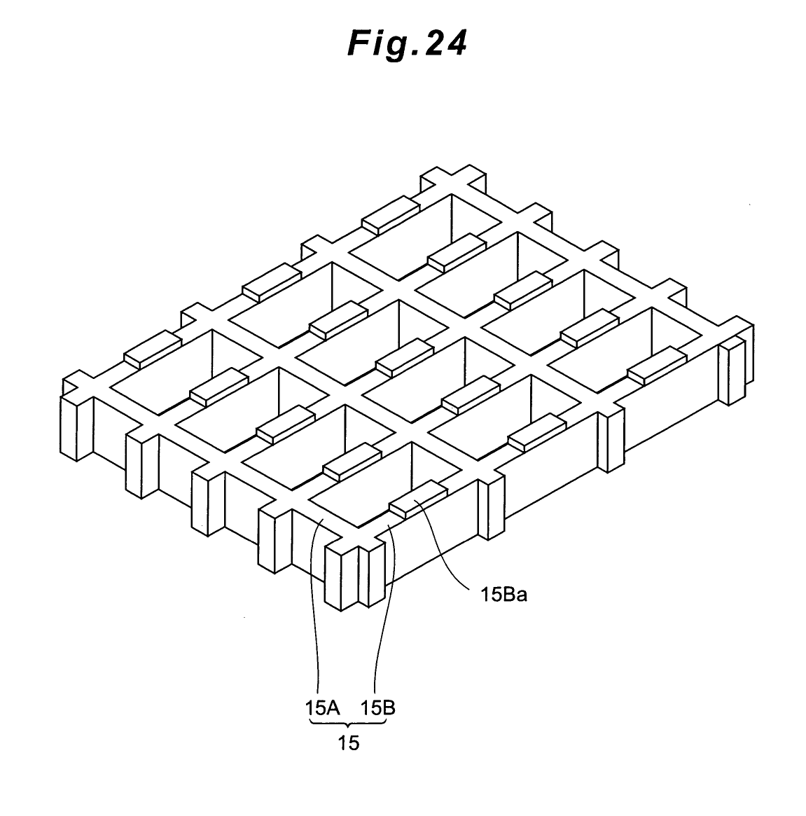

FIGS. 22 to 24 illustrate a ninth embodiment example of the PDP according to the present invention. FIG. 22 is a schematic front view showing part of the PDP of the ninth embodiment example. FIG. 23 is a sectional view taken along the V4-V4 line in FIG. 22. FIG. 24 is a perspective view showing the structure of the partition wall unit of the PDP of this embodiment example.

In FIGS. 22 and 24, the PDP 50 has a front glass substrate 11 serving as the display surface. A plurality of row electrode pairs (X1, Y1) extending in the row direction (the right-left direction in FIG. 22) are regularly arranged at required intervals in the column direction (the up-down direction in FIG. 22) on the rear-facing face (the face facing toward the rear of the PDP) of the front glass substrate 11.

One row electrode X1 constituting part of each row electrode pair (X1, Y1) is composed of a transparent electrode X1a and a bus electrode X1b. The transparent electrode X1a extends in a belt shape in the row direction on the rear-facing face of the front glass substrate 11, and is formed of a transparent conductive film such as ITO. The bus electrode X1b is formed in a belt shape extending in the row direction and having a column-direction width smaller than that of the transparent electrode X1a. The bus electrode X1b is connected to the rear-facing face of the transparent electrode X1a, and is formed of a metal film.

As is the case of the row electrode X1, the other row electrode Y1 constituting part of each row electrode pair (X1, Y1) is composed of a transparent electrode Y1a and a bus electrode Y1b. The transparent electrode Y1a is formed of a transparent conductive film such as ITO and in a belt shape extending in the row direction on the rear-facing face of the front glass substrate 11. The transparent electrode Y1a extends parallel to the transparent electrode X1a of the row electrode X1 and at a required interval from it. The bus electrode Y1b is formed of a metal film and in a belt shape extending in the row direction and having a column-direction width smaller than that of the transparent electrode Y1a. The bus electrode Y1b is connected to the rear-facing face of the transparent electrode Y1a.

The row electrodes X1, Y1 are arranged in alternate positions in the column direction of the front glass substrate 11. In each row electrode pair (X1, Y1), the distance, set at the required width, between the opposing transparent electrodes X1a, Y1a of the respective row electrodes X1, Y1 paired with each other forms a discharge gap g1.

A dielectric layer 12 is provided on the rear-facing face of the front glass substrate 11 so as to cover the row electrode pairs (X1, Y1).

The entire rear-facing face of the dielectric layer 12 is in turn overlaid with a protective layer (not shown) formed of a high γ material such as magnesium oxide (MgO).

A back glass substrate 13 is placed parallel to the front glass substrate 11 with a discharge space in between.

A plurality of column electrodes D1 extending in a belt shape in the column direction are regularly arranged at required intervals in the row direction on the face of the back glass substrate 13 facing the front glass substrate 11.

On this face of the back glass substrate 13, a column-electrode protective layer (dielectric layer) 14 is formed so as to cover the column electrodes D1.

A partition wall unit 15 having a shape as described below is in turn formed on the column-electrode protective layer 14.

The partition wall unit 15 is formed in an approximate grid shape made up of a plurality of transverse walls 15A and a plurality of vertical walls 15B. Each of the transverse walls 15A extends in the row direction in correspondence with the mid-position between two row electrode pairs (X1, Y1) which are arranged adjacent to each other in the column direction on the front glass substrate 11. The vertical walls 15B extend in the column direction and are regularly arranged at required intervals in the row direction.

The partition wall unit 15 partitions the discharge space defined between the front glass substrate 11 and the back glass substrate 13 into approximtely quadrate areas to form a plurality of discharge cells C1 arranged in matrix form over the panel surface. The row electrode pairs (X1, Y1) are arranged so as to correspond with the central portions of the respective discharge cells C1.

The structure of the partition wall unit 15 is further described here.

Raised strips 15Ba are formed on central portions of the front-facing end faces of the vertical walls 15B of the partition wall unit 15 facing the front glass substrate 11. Each of the raised strips 15Ba extends out from the vertical wall 15B toward the front glass substrate 11 and extends in the column direction.

The column-direction length L1 of the raised strip 15Ba is longer than the column-direction width of the row electrode pair (X1, Y1), specifically, the total column-direction width of the row electrode X1, row electrode Y1 and the discharge gap g1 between the row electrodes X1, Y1, and shorter than the distance between adjacent transverse walls 15A of the partition wall unit 15. When viewed from the front glass substrate 11, the two end portions of the raised strip 15Ba, which have the same predetermined length d1, respectively extend in the column direction outward from the outer sides of the respective row electrodes X1, Y1 away from the leading sides facing the discharge gap g1.

This embodiment example sets the length d1 at zero to 30 μm, for example.

The raised strip 15Ba is in contact with the rear-facing face of the protective layer overlying the dielectric layer 12.

Therefore, the portions of the vertical wall 15B, which extend from each raised strip 15Ba to the adjacent transverse walls 15A on either side of the raised strip 15Ba, are out of contact with the rear-facing face of the protective layer overlying the dielectric layer 12 to form a clearance r1. The clearance r1 allows for communication between the two discharge cells C1 adjacent to each other in the row direction on either side of the vertical wall 15B.

The width of the clearance r1 (the distance between the protective layer overlying the dielectric layer 12 and the vertical wall 15B) is desirably set at 1 μm to 20 μm.

When the width of the clearance r1 is less than 1 μm, the action of the priming effect, the improvement in luminous efficiency, the provision of an air-removal passage and the like are less than satisfaction. On the other hand, when it exceeds 20 μm, a false discharge may possibly occur between adjacent discharge cells C1 in the row direction.

As described later, the raised strip 15Ba may be formed of the same dielectric material as that of the main body of the partition wall unit 15 and integrally with it. Alternatively, the raised strip 15Ba may be formed of a low-dielectric material which is different from the dielectric material of the main body of the partition wall unit 15.

Phosphor layers 16 are provided in the respective discharge cells C1. Each of the phosphor layers 16 overlies the five faces facing the discharge space in each discharge cell C1: the face of the column-electrode protective layer 14 and the four side faces of the transverse walls 15A and the vertical walls 15B of the partition wall unit 15. The three primary colors, red, green and blue, are applied individually to the phosphor layers 16 formed in the respective discharge cells C1, so that the three primary colors are arranged in order in the row direction.

The discharge space is filled with a discharge gas that includes xenon.

The following are the size of the row electrodes X1, Y1 and the composition of the discharge gas in the above PDP 50.

The column-direction width of each row electrode X1, Y1, namely, the column-direction width Wx1 of the transparent electrode X1a and the column-direction width Wy1 of the transparent electrode Y1a (see FIG. 22), is set at 150 μm or less.

The xenon partial pressure in the discharge gas of the total pressure of 66.7 kPa (500 Torr) which fills the discharge space is set at 6.67 kPa (50 Torr) or more.

The PDP 50 applies a scan pulse sequentially to the row electrodes Y1 of the respective row electrode pairs (X1, Y1), and simultaneously applies a data pulse selectively to the column electrodes D1, whereupon an address discharge is initiated between the row electrode Y1 and the column electrode D1 in each of the discharge cells C1 located corresponding to the intersections of the row electrodes Y1 that receive the scan pulse and the column electrodes D1 that receive the data pulse. As a result of the address discharge, the light-emitting cells (which are the discharge cells C1 in which a wall charge accumulates on the portions of the dielectric layer 12 facing them) and the non-light-emitting cells (which are the discharge cells C1 in which the wall charge is erased from the portions of the dielectric layer 12 facing them) are distributed over the panel surface in accordance with the image data of the video signal.

Subsequently, a sustaining pulse is applied alternately to the row electrodes X1, Y1 in each row electrode pair (X1, Y1), whereupon a sustaining discharge is initiated across the discharge gap g1 between the transparent electrodes X1a, Y1a in each light-emitting cell.

The sustaining discharge in each light-emitting cell results in the generation of vacuum ultraviolet light from the xenon included in the discharge gas filling the discharge space. The vacuum ultraviolet light excites the red, green and blue phosphor layers 16 provided in the light-emitting cells. The excited phosphor layers 16 produce visible light, thus generating a matrix-display image on the panel surface.

In the foregoing PDP 50, the column-direction width Wx1 of each of the row electrodes X1 and the column-direction width Wy1 of each of the row electrodes Y1 are each set at 150 μm or less, and the xenon partial pressure in the discharge gas of the total pressure of 66.7 kPa (500 Torr) filling the discharge space is set at 6.67 kPa (50 Torr) or more. This setting enables the achievement of a high luminous efficiency when a sustaining discharge as described above is initiated for image generation.

The reasons for this are as described on the basis of FIGS. 4 to 6 in the first embodiment example.

In the PDP 50 each of the raised strips 15Ba is formed on a portion of the vertical wall 15B of the partition wall unit 15 corresponding to the row electrode pair (X1, Y1) and extending out from the two outer edges of the row electrode pair (X1, Y1) over a required range. In this portion, the raised strip 15Ba blocks communication between adjacent discharge cells C1 in the row direction across the vertical wall 15B.

As a result, discharge interference between the adjacent discharge cells C1 in the row direction is inhibited, leading to prevention of the occurrence of a false discharge when the sustaining discharge is initiated.

At this point, because the electrode widths Wx1, Wy1 of the row electrodes X1, Y1 are each set at 150 μm or less, the sustaining discharge initiated between the row electrodes X1, Y1 becomes a narrow-depth-range discharge with a narrow discharge range as described earlier, so that the generation area of vacuum ultraviolet light results in a so-called point light source which is smaller than that of the conventional PDPs. In consequence, it is possible to fully prevent discharge interference between the discharge cells C1 adjacent in the row direction, even when the raised strip 15Ba is formed only on a portion of the vertical wall 15B of the partition wall unit 15 corresponding to the row electrode pair (X1, Y1) and extending out from the two outer edges of the row electrode pair (X1, Y1) over a required range, so that the clearances r1 are formed on either end of the raised strip 15Ba.

In the PDP 50, the clearances r1, which are formed between the protective layer overlying the dielectric layer 12 and the vertical walls 15B at either column-direction end of the raised strips 15Ba, form the path used for removing the air from the discharge space and introducing a discharge gas into the discharge space in the process of manufacturing the PDP 50, and also form a path for introducing the priming particles generated during the sustaining discharge into the adjacent discharge cell C1 when the PDP is driven.

As described earlier, the clearances r1 present no obstacle to the prevention of discharge interference between the discharge cells C1 adjacent in the row direction.

Typically, in a PDP, as the pulse period of the sustaining pulse applied for initiation of a sustaining discharge is more and more reduced, the discharge interval is reduced, resulting in an increase in the amount of priming particles generated. Accordingly, communication between the discharge cells adjacent in the row direction enhances the priming effect, including the enhancement of discharge probability, the improvement of discharge delay and the like. However, in a conventional PDP using a large electrode width and a discharge gas with a low xenon partial pressure, even if the sustaining pulse period is shortened, the luminous efficiency seldom changes.

On the other hand, with the PDP 50, the discharge space is filled with a discharge gas including a high ratio of xenon, and the electrode width of the row electrodes X1, Y1 is set at 150 μm or less, thereby effectively exerting the priming effect induced by the clearances r1 are formed between the protective layer overlying the dielectric layers 12 and the vertical walls 15B. Also, when the sustaining pulse period is shortened in order to enhance the priming effect, the luminous efficiency is improved as compared with the conventional PDPs.

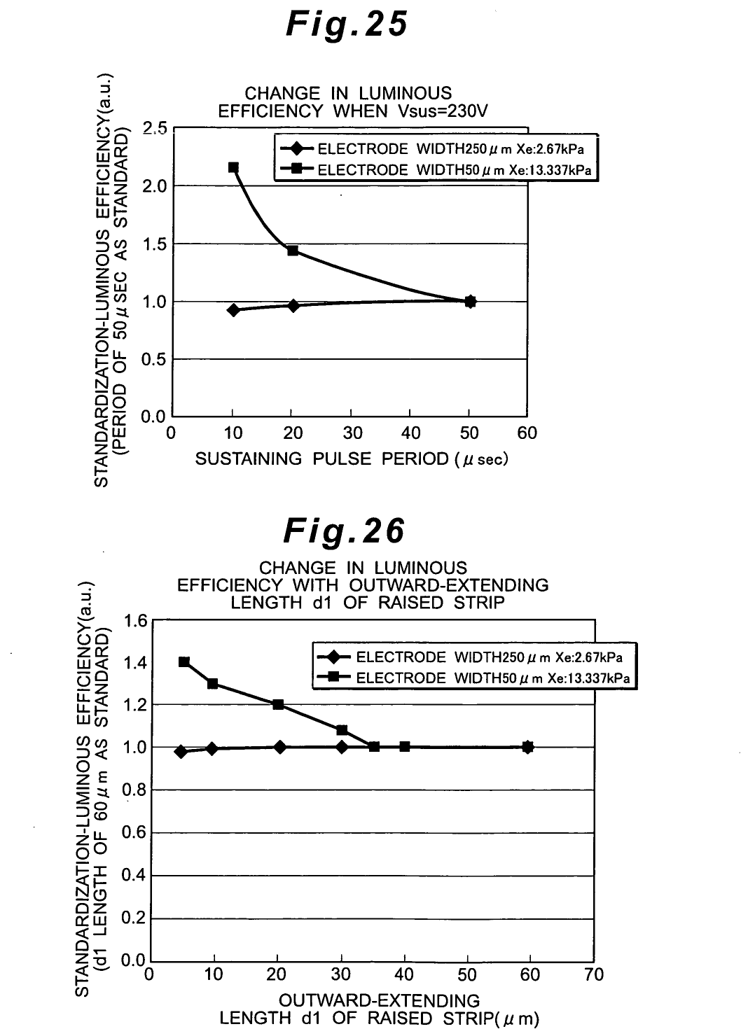

FIG. 25 shows a graph of the comparison of the relationship between the sustaining pulse periods and the luminous efficiency in a PDP in which a narrow-depth-range discharge is produced and which has row electrodes X1, Y1 each set at an electrode width 50 μm, and uses a discharge gas with a high xenon partial pressure set at 13.33 kPa, and of that in a conventional PDP which has an electrode width set at 250 μm, and uses a discharge gas with a xenon partial pressure set at 2.67 kPa, wherein these PDPs, which have no clearance formed between a dielectric layer and vertical walls of the partition wall unit, are driven at a sustaining pulse of a voltage of 230V.

The values of the luminous efficiencies represented in FIG. 25 are obtained taking the sustaining pulse period 50 μsec as the standard.

It is seen from FIG. 25 that, in the case when no clearance is formed between a dielectric layer and vertical walls of the partition wall unit, the luminous efficiency seldom changes even though the sustaining pulse period is shortened in the conventional PDP which has an electrode width set at 250 μm and uses a discharge gas with a xenon partial pressure of 2.67 kPa, but the luminous efficiency is improved with a reduction in the sustaining pulse period in the foregoing PDP 50 which has an electrode width set at 50 μm and uses a discharge gas with a xenon partial pressure of 13.33 kPa.

Thus, the PDP 50 is capable of benefiting simultaneously from the effect of the raised strip 15Ba preventing the occurrence of a false discharge and the priming effect caused by the clearance r1, leading to the enhancement of discharge probability, the improvement in discharge delay and the like, these two effects being produced between adjacent discharge cells C1 arranged in the row direction. Also, the PDP 50 is capable of further improving the luminous efficiency more than the conventional PDPs when the sustaining pulse period is shortened in order to enhance the priming effect.

FIG. 26 is a graph showing the results of the experiments conducted to verify that the priming effect is caused by providing clearances as described above between the dielectric layer and the vertical walls of the partition wall unit. The graph shows the comparison between the luminous efficiencies in relation to the lengths of the clearances between the dielectric layer and the vertical walls of the partition wall unit in a PDP having an electrode width set at 50 μm and using a discharge gas with a xenon partial pressure of 13.33 kPa, and the luminous efficiencies in relation to the lengths of the clearances between the dielectric layer and the vertical walls of the partition wall unit in a conventional PDP having an electrode width set at 250 μm and using a discharge gas with a xenon partial pressure of 2.67 kPa.

The horizontal axis in FIG. 26 represents, instead of the length of the clearance, the length of an end portion of the raised strip extending outward in the column direction from the outer side of the row electrode away from the discharge gap when viewed from the front glass substrate (i.e. the outward-extending length d1 in FIGS. 22, 23), and the vertical axis represents the values of the luminous efficiencies with a d1 length of 60 μm as the standard.

As seen from FIG. 26, in a conventional PDP having the electrode width of 250 μm and using a discharge gas with a xenon partial pressure of 2.67 kPa, even when the length of the clearance between the dielectric layer and the vertical wall of the partition wall unit is increased (that is, the length of the raised strip on the vertical wall is decreased), the luminous efficiency does not change much, and the length of the clearance between the dielectric layer and the vertical wall only slightly affects the priming effect. By contrast, in a PDP having the electrode width of 50 μm and using a discharge gas with a xenon partial pressure of 13.33 kPa, the longer the clearance between the dielectric layer and the vertical wall of the partition wall unit (the shorter the outward-extending length d1 of the raised strip on the vertical wall), the greater the priming effect, resulting in an increase in the luminous efficiency.

The difference in the luminous efficiency between the above two types of the PDPs becomes marked when the outward-extending length d1 of the raised strip formed on the vertical wall is 30 μm or less.

As described above, the priming effect induced by the clearance formed between a dielectric layer and a vertical wall of the partition wall unit is boosted by initiating a narrow-depth-range discharge and using a discharge gas that contains a high ratio of xenon. Accordingly, the PDP 50 has the clearances r1 formed in a required length or more between the dielectric layer 12 and the vertical walls 15B of the partition wall unit 15, thereby providing a higher luminous efficiency than that of the conventional PDPs.

The clearances r1 further provide for an air-removing path in the manufacturing process of the PDP 50, so that the air is satisfactorily removed from the discharge space. As a result, it is possible to increase the life of the PDP and improve the panel characteristics such as color temperature.

With the PDP 50, the formation of a clearance r1 between the vertical wall 15B and the protective layer overlying the dielectric layer 12 effects a reduction in electrostatic capacitance between the row electrode Y1 and the column electrode D1 corresponding to the clearance r1, leading to a decrease in power consumption when the address discharge is initiated.

In the PDP 50, a longer column-direction length L1 of the raised strip 15Ba is preferable for the prevention of a false discharge from occurring between the adjacent discharge cells C1 when the sustaining discharge is initiated, but a shorter length L1 is preferable for the provision of the priming effect and the air-removing path, and for a reduction in electrostatic capacitance between the row electrode Y1 and the column electrode D1.

For this reason, it is deemed that a suitable setting for the length L1 of the raised strip 15Ba is such that, when viewed from the front glass substrate 11, the length d1 of each of the ends of the raised strip 15Ba extending outward in the column direction from the outer side of the row electrode X1/Y1 away from the discharge gap g1 (see FIGS. 22, 23) falls within the range 0 μm≦d1≦30 μm.

For the purpose of the prevention of a false discharge, the top face of the raised strip 15Ba is desirably smoothed as much as possible so as to come into close contact with the protective layer overlying the dielectric layer 12.

The raised strip 15Ba is not required to have the property of a high reflectance as is necessary for the main body of the partition wall unit 15. Hence, the raised strip 15Ba can be formed of a material different from, and independently of, the main body of the partition wall unit 15.

When the raised strip 15Ba is formed of a material with a lower dielectric constant than that of the main body of the partition wall unit 15, this makes it possible to further reduce the electrostatic capacitance between the row electrode Y1 and the column electrode D1, resulting in a greater reduction in the power consumption when the address discharge is initiated.

The foregoing advantageous effects can also be exerted in a PDP having a stripe-shaped partition wall unit. In the PDP 50, the partition wall unit 15 is formed in an approximate grid shape, which thus allows for the provision of the phosphor layer 16 on the four side faces of the transverse walls 15A and vertical walls 15B surrounding each discharge cell C1 so as to increase the surface area of the phosphor layer 16, resulting in the achievement of an even higher luminous efficiency.

The column-direction width Wx1, Wy1 of the row electrodes X1, Y1 of the PDP 50 is significantly smaller than that of the conventional PDPs, which thus massively reduces the electrostatic capacity arising between the electrodes. In consequence, the amount of reactive current is reduced, thus making it possible to reduce the electrical power consumption.

The foregoing describes the example of the row electrode pair (X1, Y1) of the PDP 50 being placed facing the column-direction central portion of each discharge cell C1. However, the row electrode pair (X1, Y1) may be placed in any position higher or lower (in FIG. 22) than the central portion in the column direction in each discharge cell C1.

This is for the following reasons .

In the conventional PDPs, the sustaining discharge results in a wide-range discharge expanding throughout a discharge cell as described earlier. In this case, if the row electrode pair is placed in a position higher or lower than the central position, in the column direction, of each of the discharge cells which are defined by a grid-shaped partition wall unit, the discharge gap is located closer to the upper or lower transverse wall of the partition wall unit defining each discharge cell. As a result, variations in voltage margin, brightness, luminous efficiency and the like occur from discharge cell to discharge cell, and those then adversely affect light emission. To avoid this problem, a high precision of positioning of the row electrode pair in each discharge cell is required.

However, in the PDP 50, the sustaining discharge develops as a narrow-depth-range discharge with a narrow discharge area as described earlier, and the area in which vacuum ultraviolet light is produced is a so-called point light source which is smaller than that of the conventional PDPs. Thus, the vacuum ultraviolet light is not easily affected by the partition wall unit, which involves such things as wall loss. Also, the phosphor layer 16 is excited by use of a 172 nm-wavelength molecular beam, which is not much absorbed, in the vacuum ultraviolet light. This reduces the effects caused by the variations in distance between the phosphor layer 16 and the discharge area (the area in which the vacuum ultraviolet light is produced) of the sustaining discharge. In consequence, even if the position of the row electrode pair (X1, Y1) in each discharge cell C1 in the column direction is out of the central position of the discharge cell C1, the brightness and luminous efficiency seldom vary.

Accordingly, with the PDP 50, even when each of the discharge cells C1 is surrounded by the transverse walls 15A and the vertical walls 15B of the approximately grid-shaped partition wall unit 15, the position of the discharge gap g1 (i.e. the position of the row electrode pair) need not be aligned with the central position of the discharge cell in the column direction, resulting in an increase in tolerance in the precision of positioning of the row electrode pair (X1, Y1) in each discharge cell C1. This makes it possible to enhance the product yield in the manufacturing process and to contribute to a reduction in manufacturing costs.

The foregoing describes the example of a transparent electrode constituting part of the row electrode being formed in a belt shape continuously extending between adjacent discharge cells along the bus electrode. However, a transparent electrode may be formed independently in each discharge cell and connected to the bus electrode.

The foregoing describes the example of a row electrode made up of a transparent electrode and a bus electrode. However, the row electrode may be made up of a metal-made bus electrode alone and have a width of 150 μm or less in the column direction.

Tenth Embodiment Example

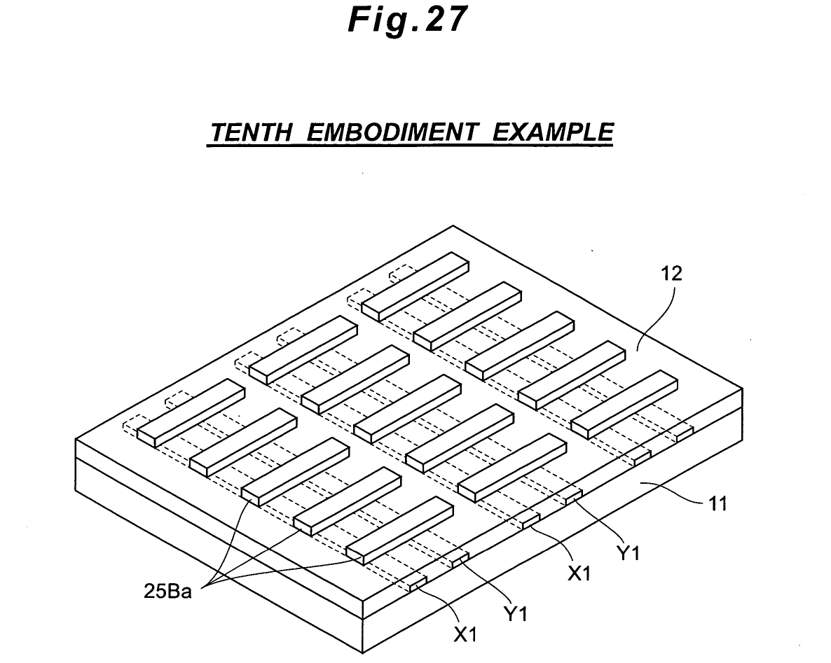

FIG. 27 is a perspective view illustrating the structure of the PDP on the front glass substrate side in a tenth embodiment example according to the present invention.

In the PDP described in the ninth embodiment example, each of the raised strips is formed integrally on the vertical wall of the partition wall unit so as to block off the adjacent discharge cells from each other in the row direction. By contrast, in the PDP described in the tenth embodiment example, raised strips 25Ba each extending in the column direction are formed on the rear-facing face of the front glass substrate 11.

Specifically, the raised strips 25Ba are formed on a protective layer (not shown) overlying the dielectric layer 12 formed on the rear-facing face of the front glass substrate 11.

The raised strips 25Ba are placed such that, when viewed from the front glass substrate 11, the central portion of each of the raised strips 25Ba intersects with the row electrode pair (X1, Y1), and the raised strip 25Ba lies on the vertical wall of the partition wall unit formed on the back glass substrate when the front glass substrate 11 and the back glass substrate are aligned and joined with each other in the manufacturing process of the PDP.

In the rest of the structure of the PDP, the size and shape of the raised strip 25Ba, the width of the clearance formed between the protective layer overlying the dielectric layer 12 and the vertical wall, the materials for the raised strip 25Ba, and the like, the tenth embodiment example is similar to the ninth embodiment example.

As in the case of the ninth embodiment example, the sustaining discharge initiated between the row electrodes X1, Y1 in the PDP develops as a narrow-depth-range discharge, and the discharge gas of a total pressure of 66.7 kPa (500 Torr) contains xenon at a partial pressure of 6.67 kPa (50 Torr) or more. In consequence, the luminous efficiency is improved and the raised strip 25Ba prevents the occurrence of a false discharge between the adjacent discharge cells C1 in the row direction when the sustaining discharge is initiated.

In the PDP, the clearances formed at either column-direction end of the raised strips 25Ba initiate the priming effect between the adjacent discharge cells C1 in the row direction, and provide the path used for removing the air from the discharge space and introducing a discharge gas into the discharge space in the manufacturing process. Further, when the sustaining pulse period is reduced for the further improvement of this priming effect, the PDP is capable of enhancing the luminous efficiency as compared with the conventional PDPs, because the discharge gas contains a high ratio of xenon and the sustaining discharge initiated between the row electrodes X1, Y1 develops as a narrow-depth-range discharge.

The priming effect caused by a clearance formed between a dielectric layer and a vertical wall of the partition wall unit is enhanced by initiating a narrow-depth-range discharge and using a discharge gas that contains a high ratio of xenon. Accordingly, the formation of the clearances formed between the dielectric layer 12 and the vertical walls makes it possible to achieve a higher luminous efficiency than that of the conventional PDPs.

As compared with the case of the ninth embodiment example, because the raised strips 25Ba are formed on the rear-facing face of the front glass substrate 11, a high positioning accuracy of the raised strip 25Ba with respect to the row electrodes X1, Y1 and the discharge gap g1 in the forming process is achieved. In consequence, it is possible to further improve the effect of the raised strip 25Ba on the prevention of the occurrence of a false discharge between the adjacent discharge cells.

The rest of the technical advantageous effects of the PDP in the tenth embodiment example are as in the case of the ninth embodiment example.

Eleventh Embodiment Example

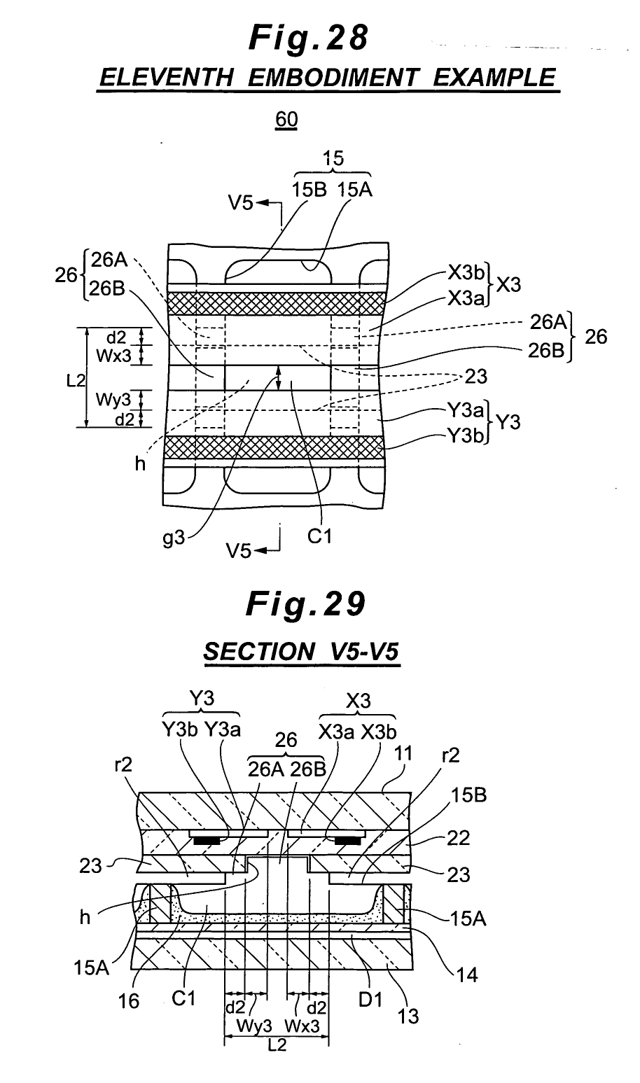

FIGS. 28, 29 illustrate an eleventh embodiment example according to the present invention. FIG. 28 is a schematic front view of part of the PDP of the eleventh embodiment example. FIG. 29 is a sectional view taken along the V5-V5 line in FIG. 28.

The same reference numerals as those used in FIGS. 8, 9 are used below to describe the same components as those of the PDP in the third embodiment example.

In the case of the PDP of the first embodiment example, the transparent electrode of each row electrode has a reduced column-direction width in order for the sustaining discharge to develop as a narrow-depth-range discharge. By contrast, in the PDP 60 of the eleventh embodiment example, row electrode pairs (X3, Y3) each similar in size to those of the conventional PDPs (see FIG. 1) are arranged facing the discharge cells C1 defined by the partition wall unit 15 of an approximate grid shape. Second dielectric layers 23 are formed on the required portions of the rear-facing face, which faces the discharge space, of a first dielectric layer 22 which is provided for covering the row electrode pairs (X3, Y3), in such a manner as to reduce the column-electrode width of each of the portions of the row electrodes X3, Y3 between which a discharge is substantially caused in each discharge cell C1. In this way, the sustaining discharge develops as a narrow-depth-range discharge.

Specifically, transparent electrodes X3a, Y3a are provided on the rear-facing face of the front glass substrate 11 of the PDP 60. The transparent electrodes X3a, Y3a are each formed in a belt shape of a similar column-direction width, e.g. 400 μm to 1000 μm, to that of the conventional PDP illustrated in FIG. 1. The transparent electrodes X3a, Y3a are spaced at a required interval (discharge gap g3) and extend parallel to each other in the row direction. Bus electrodes X3b, Y3b of a belt shape extending in the row direction are formed on the respective outer sides (away from the leading sides facing each other across the discharge gap) of the rear-facing faces of the transparent electrodes X3a, Y3a, and are connected to the respective transparent electrodes X3a, Y3a.

The row electrode pairs (X3, Y3) are overlaid with the first dielectric layer 22 formed on the rear-facing face of the front glass substrate 11.

The second dielectric layers 23 are formed on the portions of the rear-facing face of the first dielectric layer 22 other than the belt-shaped portions which each extend in the row direction in positional correspondence with the discharge gap g3, and with the leading-side portions, which have the column-direction widths Wx3, Wy3 of 150 μm or less and face each other across the discharge gap g3, of the transparent electrodes X3a, Y3a of the row electrodes X3, Y3. Between the second dielectric layers 23 adjacent to each other in the column direction, a groove h is formed in positional correspondence with the discharge gap g3 and the leading-side portions of the column-direction width Wx3, Wy3 of the transparent electrodes X3a, Y3a.

The rear-facing faces of the first dielectric layer 22 and second dielectric layers 23 are overlaid with a protective layer (not shown).

The film-thickness of the first dielectric layer 22 overlying the row electrode pairs (X3, Y3) is approximately equal to that of the conventional PDPs in which a discharge results in the accumulation of the wall charge. The film-thickness of each of the second dielectric layers 23 is greater than that of the first dielectric layer 22, such that the lamination of the first dielectric layer 22 and second dielectric layer 23 has a thickness set to exceed twice the film-thickness of the first dielectric layer 22, and to make the wall charge seldom accumulate during a discharge.

Column electrodes D1, a column-electrode protective layer 14, an approximately grid-shaped partition wall unit 15, and red, green and blue phosphor layers 16 are formed on the back glass substrate 13 in a similar structure and arrangement to those in the ninth embodiment example.

Raised strips 26 extend out toward the front glass substrate 11 and extend in the column direction on the central portions of the end faces of the vertical walls 15B of the partition wall unit 15.

Each of the raised strips 26 is formed on the vertical wall 15B and in a two-stage configuration made up of a first-stage raised strip 26A and a second-stage raised strip 26B. The first-stage raised strip 26A has a column-direction width greater than the column-direction width of a groove h created between the second dielectric layers 23. The second-stage raised strip 26B is formed on a central portion of the first-stage raised strip 26A and has a column-direction width equal to that of the groove h created between the second dielectric layers 23. The second-stage raised strip 26B is fitted into the groove h. Each of the top faces of the two ends of the first-stage raised strip 26A on which the second-stage raised strip 26A is not formed is in contact with the protective layer overlying the second dielectric layer 23.

The column-direction length L2 of the first-stage raised strip 26A of the raised strip 26 is greater than the column-direction width of the groove h (the total of the width of the discharge gap g3 and the widths Wx3, Wy3 of the leading-side portions of the respective transparent electrodes X3a, Y3a), and smaller than the distance between the adjacent vertical walls 15A of the partition wall unit 15. When viewed from the front glass substrate 11, the two ends of the first-stage raised strip 26A extend outward equally from the groove h in the column direction for a predetermined length d2.

This embodiment example sets the length d2 at zero to 30 μm, for example.

Each of the portions of the vertical wall 15B, which extend from each raised strip 26 to the adjacent transverse walls 15A on either side of the raised strip 26, is out of contact with the rear-facing face of the protective layer overlying the second dielectric layer 23 to form a clearance r2. The clearance r2 allows for communication between the two discharge cells C1 adjacent to each other in the row direction on either side of the vertical wall 15B.

The width of the clearance r2 (the distance between the protective layer overlying the second dielectric layer 23 and the vertical wall 15B) is desirably set at 1 μm to 20 μm.

When the width of the clearance r2 is less than 1 μm, the action of the priming effect, the improvement in luminous efficiency, the provision of an air-removal passage and the like are less than satisfactory. On the other hand, when it exceeds 20 μm, a false discharge may possibly occur between adjacent discharge cells C1 in the row direction.

As in the case of the ninth embodiment example, the raised strip 26 may be formed integrally with the partition wall unit 15 by use of the same dielectric material as that used for forming the partition wall unit 15. Alternatively, the raised strip 26 may be formed of a low-dielectric material which is different from the dielectric material of the main body of the partition wall unit 15.

The discharge space is filled with a discharge gas of a total pressure of 66.7 kPa (500 Torr) including a xenon partial pressure of 6.67 kPa (50 Torr) or more.

Each of the row electrodes X3, Y3 of each row electrode pair (X3, Y3) of the PDP 60 has a column-direction width approximately equal to that of the conventional PDPs. Each of the portions of the respective transparent electrodes X3a, Y3a of the row electrodes X3, Y3, other than the leading-side portions of the column-direction widths Wx3, Wy3 facing each other across the discharge gap g3, is covered with the double di electric layer made up of the laminated first and second dielectric layers 22, 23. Thus, the dielectric layer overlying these portions other than the leading-side portions of the column-direction width Wx3, Wy3 has a greater thickness than that of the dielectric layer overlying the leading-side portions. As a result, the wall charge seldom accumulates on the thicker portion of the second dielectric layer 23 deposited on the first dielectric layer 22, and accumulates on the surface of the first dielectric layer 22 overlying the leading-side portions of the column-direction widths Wx3, Wy3 of the transparent electrodes X3a, Y3a.

In this way, in the PDP 60, when a sustaining pulse is applied to the row electrode pair (X3, Y3) so as to initiate a sustaining discharge across the discharge gap g3 between the transparent electrodes X3a, Y3a, almost all of the sustaining discharge develops only on the leading-side portions of the column-direction widths Wx3, Wy3 of the transparent electrodes X3a, Y3a, resulting in the formation of a narrow-depth-range discharge as described in the first embodiment example.

With the PDP 60 designed as described above, as in the case of the first embodiment example, the sustaining discharge develops as a narrow-depth-range discharge, and the xenon partial pressure in the discharge gas is set at 6.67 kPa (50 Torr) or more, resulting in the achievement of an increase in luminous efficiency. Also, because of the raised strip 26, a false discharge is prevented from occurring between the adjacent discharge cells C1 in the row direction when the sustaining discharge is initiated.

In the PDP, the clearances r2 formed at either column-direction end of the raised strips 26 initiate the priming effect between the adjacent discharge cells C1 in the row direction, and provide the path used for removing the air from the discharge space and introducing a discharge gas into the discharge space in the manufacturing process. Further, when the sustaining pulse period is reduced for the further improvement of the priming effect, the PDP is capable of enhancing the luminous efficiency as compared with the conventional PDPs, because the discharge gas contains a high ratio of xenon and the sustaining discharge initiated between the row electrodes X3, Y3 develops as a narrow-depth-range discharge.

The priming effect caused by a clearance formed between a dielectric layer and a vertical wall of the partition wall unit is enhanced by initiating a narrow-depth-range discharge and using a discharge gas that contains a high ratio of xenon. Accordingly, the formation of the clearances r2 formed between the second dielectric layer 23 and the vertical walls 15B makes it possible to achieve a higher luminous efficiency than that of the conventional PDPs.

The PDP 60 has the raised strips 26 each formed in a two-stage configuration made up of a first-stage raised strip 26A and a second-stage raised strip 26B which is fitted into the groove h formed in the front glass substrate 11. Thus, with the PDP 60, the alignment between the front glass substrate 11 and the back glass substrate 13 is facilitated when they are joined together in the manufacturing process.

In the PDP 60, because each of the transparent electrodes X3a, Y3a has a column-direction width similar to that of the conventional PDPs and the bus electrodes X3b, Y3b are placed at a distance from the discharge gap g3, the hindrance effect of the metal-film-formed bus electrodes X3b, Y3b on visible-light emission from the phosphor layer is reduced, resulting in enhancement of the efficiency of the extraction of visible light.

In other words, the characteristics of the eleventh embodiment example are that the intensity of the light emission increases gradually toward the discharge gap and decreases gradually toward the transverse walls. In the case of this structure, the portion in which the light is emitted at a high intensity is not obstructed by the bus electrode, resulting in the achievement of an increase in the efficiency of the extraction of visible light.

The rest of the technical advantageous effects of the PDP 60 are as in the case of the first embodiment example.

Twelfth Embodiment Example

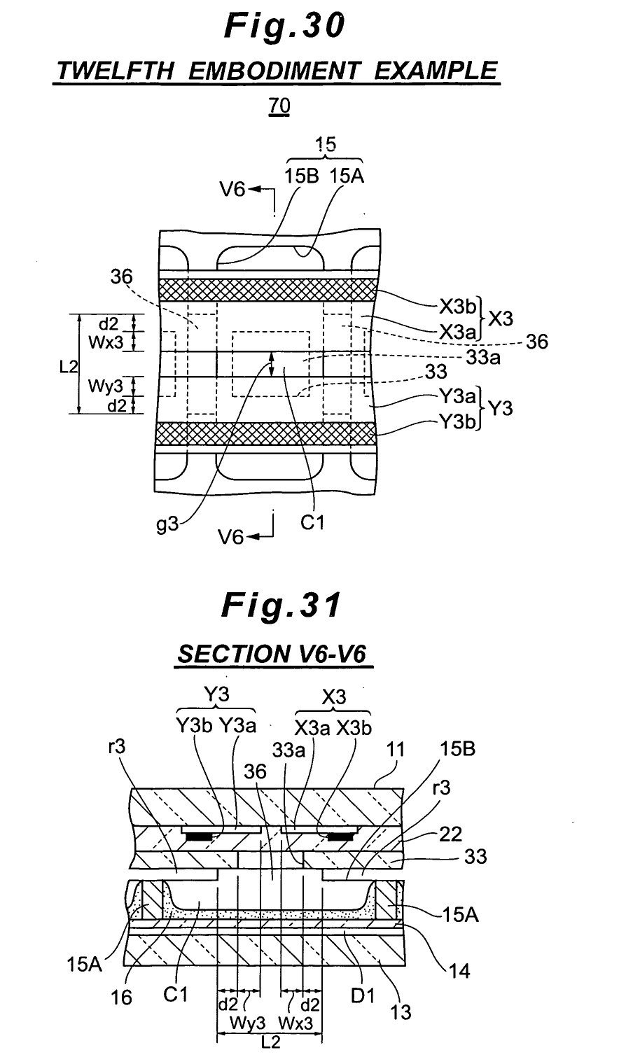

FIGS. 30, 31 illustrate a twelfth embodiment example according to the present invention. FIG. 30 is a schematic front view of part of the PDP in the twelfth embodiment example. FIG. 31 is a sectional view taken along the V6-V6 line in FIG. 30.

In the PDP of the eleventh embodiment example, the belt-shaped groove extending in the row direction is formed between the second dielectric layers in positional correspondence with the discharge gap and the portion of the row electrodes across which the sustaining discharge is initiated. By contrast, in the PDP 70 of this embodiment example, a second dielectric layer 33 deposited on the first dielectric layer 22 is formed in an approximate grid shape having quadrate apertures 33a, each formed in correspondence with the leading-side portions of the widths Wx3, Wy3 of the transparent electrodes X3a, Y3a, on the open face of each discharge cell C1 and the discharge gap g3 between them. Due to the aperture 33a, the sustaining discharge initiated between the row electrodes X3, Y3 develops as a narrow-depth-range discharge which is defined by the aperture 33a.

Each of the vertical walls 15B of the partition wall unit 15 is placed in correspondence with a belt-shaped area extending in the column direction between the apertures 33a of the second dielectric layer 33.

Raised strips 36 are formed on the central portions of the vertical walls 15B of the partition wall unit 15.

The position and size of each of the raised strips 36 of the PDP 70 are similar to the first-stage raised strip of the raised strip of the eleventh embodiment example. The raised strip 36 is contact with the protective layer overlying the second dielectric layer 33 so as to block off the portions of the adjacent discharge cells C1 in the row direction corresponding to the respective apertures 33a from each other.

Clearances r3 are each formed between the protective layer overlying the second dielectric layer 33 and the portions of the vertical walls 15B at the opposite ends of the raised strip 36, so that the clearance r3 allows for communication between the discharge cells C1 adjacent in the row direction.

The width of the clearance r3 (the distance between the protective layer overlying the second dielectric layer 33 and the vertical wall 15B) is desirably set at 1 μm to 20 μm.

When the width of the clearance u3 is less than 1 μm, the action of the priming effect, the improvement in luminous efficiency, the provision of an air-removal passage and the like are less than satisfactory. On the other hand, when it exceeds 20 μm, a false discharge may possibly occur between adjacent discharge cells C1 in the row direction.

The rest of the structure of the PDP 70 is approximately the same as that of the PDP described in the eleventh embodiment example. The same reference numerals as those used in FIGS. 28, 29 are used in FIGS. 30, 31 to describe the same components as those of the PDP in the eleventh embodiment example.

As in the case of the ninth embodiment example, in the PDP 70 the sustaining discharge develops as a narrow-depth-range discharge, and the discharge gas of a total pressure of 66.7 kPa (500 Torr) contains xenon at a partial pressure of 6.67 kPa (50 Torr) or more. In consequence, the luminous efficiency is improved and the raised strip 36 prevents occurrence of a false discharge between the adjacent discharge cells C1 in the row direction when the sustaining discharge is initiated.

In the PDP 70, the clearances r3 formed at the opposite ends of the raised strips 36 initiate the priming effect between the adjacent discharge cells C1 in the row direction, and provide the path used for removing the air from the discharge space and introducing a discharge gas into the discharge space in the manufacturing process. Further, when the sustaining pulse period is reduced for the further improvement of this priming effect, the PDP is capable of further enhancing the luminous efficiency as compared with the conventional PDPs, because the discharge gas contains a high ratio of xenon and the sustaining discharge initiated between the row electrodes X3, Y3 develops as a narrow-depth-range discharge.

The priming effect caused by a clearance formed between the dielectric layer and the vertical wall of the partition wall unit is enhanced by initiating a narrow-depth-range discharge and using a discharge gas that contains a high ratio of xenon. Accordingly, the formation of the clearances r3 formed between the second dielectric layer 33 and the vertical walls 15B makes it possible to achieve a higher luminous efficiency than that of the conventional PDPs.

The rest of the technical advantageous effects of the PDP 70 are as in the case of the eleventh embodiment example.

Thirteenth Embodiment Example

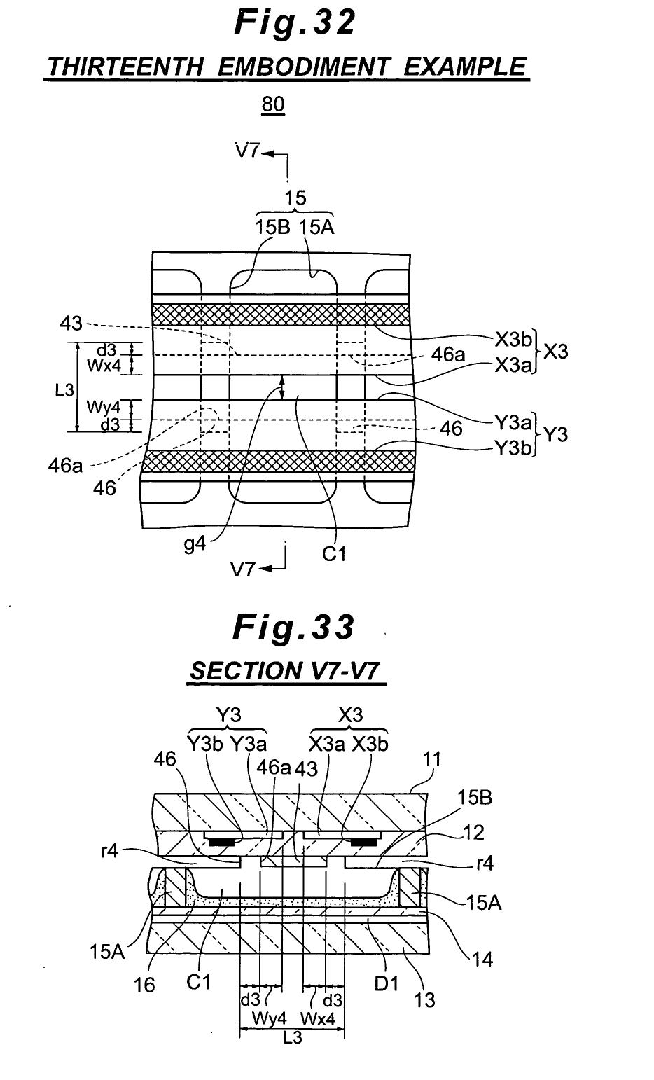

FIGS. 32, 33 illustrate a thirteenth embodiment example according to the present invention. FIG. 32 is a schematic front view of part of a PDP 80 of the thirteenth embodiment example. FIG. 33 is a sectional view taken along the V7-V7 line in FIG. 32.

The same reference numerals as used in FIGS. 12, 13 are used below to describe the same components as those of the PDP in the fourth embodiment example.

In the PDPs described in the eleventh and twelfth embodiment examples, the discharge range of the sustaining discharge is limited by the use of a second dielectric layer formed on the first dielectric layer overlying the row electrode pairs, such that the sustaining discharge results in a narrow-depth-range discharge. By contrast, in the PDP 80 in the thirteenth embodiment example, row electrode pairs (X3, Y3) each having a similar size to that of the conventional PDPs (see FIG. 1) are arranged facing the discharge cells C1 defined by a partition wall unit 15 of an approximate grid shape. Secondary electron emission layers 43, which are formed of a high γ material such as MgO, are formed in a belt shape extending in the row direction only on the required portions of the rear-facing face, which faces the discharge space, of a dielectric layer 12 which is provided for covering the row electrode pairs (X3, Y3). A sustaining discharge initiated between the transparent electrodes X3a, Y3a develops as a narrow-depth-range discharge due to the secondary electron emission layer 43.

Specifically, the transparent electrodes X3a, Y3a are provided on the rear-facing face of the front glass substrate 11 of the PDP 80. The transparent electrodes X3a, Y3a are each formed in a belt shape of a similar column-direction width, e.g. 400 μm to 1000 μm, to that of the conventional PDP illustrated in FIG. 1. The transparent electrodes X3a, Y3a are spaced at a required interval (discharge gap g4) and extend parallel to each other in the row direction. The bus electrodes X3b, Y3b of a belt shape extending in the row direction are formed on the respective outer sides of the rear-facing faces of the transparent electrodes X3a, Y3a, and are connected to the respective transparent electrodes X3a, Y3a.

The row electrode pairs (X3, Y3) are overlaid with the dielectric layer 12 formed on the rear-facing face of the front glass substrate 11.

The secondary electron emission layers 43 are in turn formed on the rear-facing face of the dielectric layer 12. Each of the secondary electron emission layers 43 is formed of a high γ material such as MgO and extends in a belt shape in the row direction in positional correspondence with the discharge gap g4 and the leading-side portions of column-direction width Wx4, Wy4 of the respective transparent electrodes X3a, Y3a placed across the discharge gap g4.

The column-direction widths Wx4, Wy4 of the portions of each of the secondary electron emission layers 43 facing the respective transparent electrodes X3a, Y3a are each set at 150 μm or less.

Column electrodes D1, a column-electrode protective layer 14, an approximately grid-shaped partition wall unit 15, and red, green and blue phosphor layers 16 are formed on the back glass substrate 13 in a similar structure and arrangement to those in the first embodiment example.

Raised strips 46 extend out toward the front glass substrate 11 and extend in the column direction on the central portions of the end faces, facing toward the front glass substrate 11, of the vertical walls 15B of the partition wall unit 15.

The column-direction length L3 of each of the raised strips 46 is longer than the column-direction width of the secondary electron emission layer 43 (the sum of the width of the discharge gap g4 and the widths Wx4, Wy4 of the leading-side portions of the transparent electrodes X3a, Y3a), and shorter than the distance between adjacent transverse walls 15A of the partition wall unit 15. When viewed from the front glass substrate 11, the two end portions of the raised strip 46, which have the same predetermined length d3, respectively extend in the column direction outward from the secondary electron emission layer 43.

This embodiment example sets the length d3 at zero to 30 μm, for example.

Recesses 46a are formed in the front-facing faces of the raised strips 46 facing toward the front glass substrate 11. Each of the recess 46a has the same column-direction cross-sectional profile as that of the secondary electron emission layer 43. The secondary electron emission layer 43 is fitted into the recess 46a and the end portions of the raised strip 46 at either end of the recess 46a in the column direction are in contact with the protective layer overlying the dielectric layer 12.

At the opposite ends of each raised strip 46 in the column direction, clearances r4 are formed between the protective layer overlying the dielectric layer 12 and the vertical wall 15B.

The width of the clearance r4 (the distance between the protective layer overlying the dielectric layer 12 and the vertical wall 15B) is desirably set at l μm to 20 μm.

When the width of the clearance r4 is less than 1 μm, the action of the priming effect, the improvement in luminous efficiency, the provision of an air-removal passage and the like, as described later, are less than satisfactory. On the other hand, when it exceeds 20 μm, a false discharge may possibly occur between adjacent discharge cells C1 in the row direction.

In this way, as in the case of the ninth embodiment example, in each area where the raised strip 46 is formed, the raised strip 46 blocks communication between the adjacent discharge cells C1 in the row direction, and the clearances r4 formed on the opposite ends of the raised strip 46 allow for communication between the adjacent discharge cells C1 in the row direction.

As in the case of the ninth embodiment example, the raised strip 46 may be formed integrally with the main body of the partition wall unit 15 and formed of the same dielectric material as that used for forming it. Alternatively, the raised strip 46 may be formed of a low dielectric material different from the dielectric layer used for forming the main body of the partition wall unit 15.

The xenon partial pressure in the discharge gas of a total pressure of 66.7 kPa (500 Torr) filling the discharge space is set at 6.67 kPa (50 Torr) or more.

Although the column-direction width of each of the row electrodes X3, Y3 of the row electrode pair (X3, Y3) of the PDP 80 has approximately the same size as that of the conventional PDPs, the PDP 80 has the secondary electron emission layers 43, which are formed of a high γ material, each placed only on the portion of the dielectric layer 12 corresponding to the discharge gap g4 and the leading-side portion of the column-direction width Wx4, Wy4 of the transparent electrodes X3a, Y3a across the discharge gap g4. As a result, almost all of the sustaining discharge initiated between the transparent electrodes X3a, Y3a develops within the area in which the secondary electron emission layer 43 is formed. This means that the sustaining discharge appears as a narrow-depth-range discharge as described in the first embodiment example.

As in the case of the first embodiment example, in the PDP 80 the sustaining discharge develops as a narrow-depth-range discharge, and the discharge gas includes xenon at a high partial pressure of 6.67 kPa (50 Torr) or more, resulting in an increase in luminous efficiency. Also, the formation of the raised strip 46 results in the prevention of the occurrence of a false discharge between the adjacent discharge cells C1 in the row direction.

In the PDP 80, the clearances r4 formed at the opposite ends of the raised strips 46 initiate the priming effect between the adjacent discharge cells C1 in the row direction, and provide the path used for removing the air from the discharge space and introducing a discharge gas into the discharge space in the manufacturing process. Further, when the sustaining pulse period is reduced for the further improvement of this priming effect, the PDP is capable of enhancing the luminous efficiency as compared with the conventional PDPs, because the discharge gas contains a high ratio of xenon and the sustaining discharge initiated between the row electrodes X3, Y3 develops as a narrow-depth-range discharge.

The priming effect induced by a clearance formed between the dielectric layer and the vertical wall of the partition wall unit is enhanced by initiating a narrow-depth-range discharge and using a discharge gas that contains a high ratio of xenon. Accordingly, the formation of the clearances r4 formed between the dielectric layer 12 and the vertical walls 15B makes it possible to achieve a higher luminous efficiency than that of the conventional PDPs.

With the structure of the PDP 80, the area of producing a narrow-depth-range discharge can be freely determined by changing the size and/or the position of the secondary electron emission layers 43. In consequence, the degree of flexibility in design and manufacturing is increased, and thus the PDP 80 is flexibly adaptable to a modification in design and the like.

The rest of the technical advantageous effects of the PDP 80 are as in the case of the third embodiment example.

Fourteenth Embodiment Example

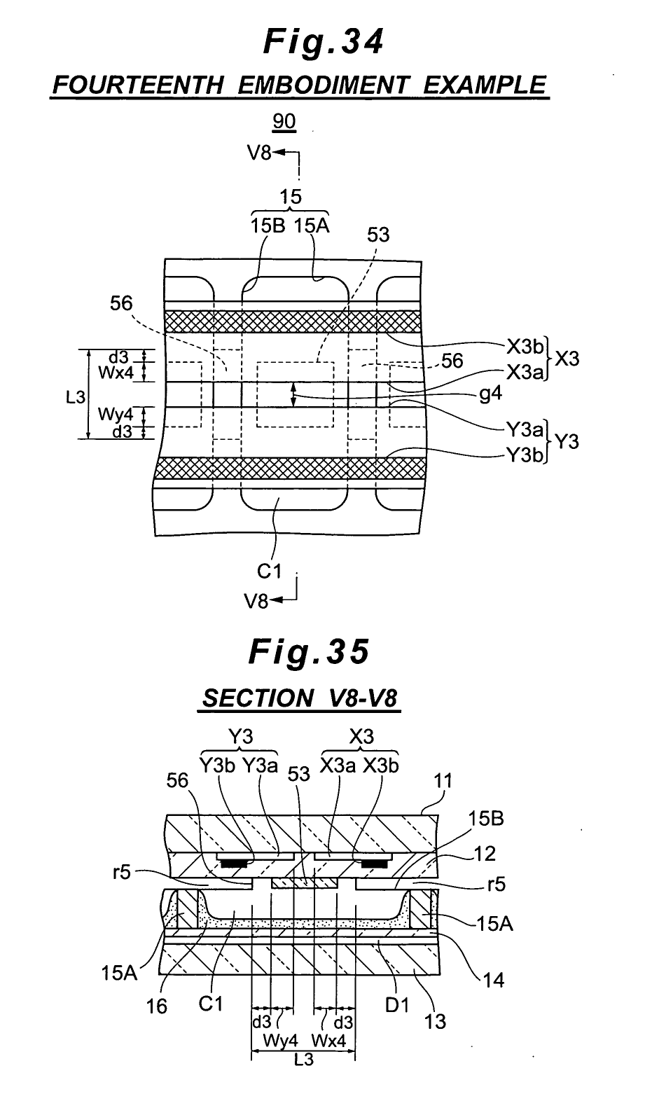

FIGS. 34, 35 illustrate a fourteenth embodiment example according to the present invention. FIG. 34 is a schematic front view of part of a PDP 90 of the fourteenth embodiment example. FIG. 35 is a sectional view taken along the V8-V8 line in FIG. 34.

In the PDP described in the thirteenth embodiment example, the secondary electron emission layers each extending in a belt shape in the row direction are formed on the rear-facing face of the dielectric layer overlying the row electrode pairs. By contrast, in the PDP 90 in the fourteenth embodiment example, secondary electron emission layers 53 formed on the rear-facing face of the dielectric layer 12 are each quadrate in a shape and in positional correspondence with the leading-side portions of the widths Wx4, Wy4 of the respective transparent electrodes X3a, Y3a located on the opening face of each discharge cell C1 and with the discharge gap g4 between the leading-side portions. Due to the quadrate-shaped secondary electron emission layer 53, the sustaining discharge initiated between the row electrodes X3, Y3 develops as a narrow-depth-range discharge which is defined by the quadrate-shaped secondary electron emission layer 53.

Each of the vertical walls 15B of the partition wall unit 15 faces the belt-shaped portion of the dielectric layer 12 extending in the column direction between the adjacent secondary electron emission layers 53 in the row direction.

Raised strips 56 are formed respectively on the central portions of the vertical walls 15B of the partition wall unit 15. Each of the raised strips 56 has the same column-direction width L3 as that of the raised strip in the thirteenth embodiment example, and is in contact with the protective layer overlying the dielectric layer 12 so as to block off the adjacent discharge cells C1 in the row direction from each other.

At the opposite ends of each raised strip 56 in the column direction, clearances r5 are formed between the protective layer overlying the dielectric layer 12 and the vertical wall 15B, and allow for communication between the adjacent discharge cells C1 in the row direction.

The width of the clearance r5 (the distance between the protective layer overlying the dielectric layer 12 and the vertical wall 15B) is desirably set at 1 μm to ²⁰ μm.

When the width of the clearance r5 is less than 1 μm, the action of the priming effect, the improvement in luminous efficiency, the provision of an air-removal passage and the like, as described later, are less than satisfactory. On the other hand, when it exceeds ²⁰ μm, a false discharge may possibly occur between adjacent discharge cells C1 in the row direction.

The rest of the structure of the PDP 90 is approximately the same as that of the PDP of the thirteenth embodiment example. The same components of those of the PDP of the thirteenth embodiment example are indicated in FIGS. 34, 35 with the same reference numerals as those in FIGS. 32, 33.

As in the case of the thirteenth embodiment example, in the PDP 90 the sustaining discharge develops as a narrow-depth-range discharge, and the discharge gas includes xenon at a high partial pressure of 6.67 kPa (50 Torr) or more, resulting in an increase in luminous efficiency. Also, the formation of the raised strip 56 results in the prevention of the occurrence of a false discharge between the adjacent discharge cells C1 in the row direction.

In the PDP 90, the clearances r5 formed at the opposite ends of the raised strips 56 initiate the priming effect between the adjacent discharge cells C1 in the row direction, and provide the path used for removing the air from the discharge space and introducing a discharge gas into the discharge space in the manufacturing process. Further, when the sustaining pulse period is reduced for the further improvement of this priming effect, the PDP is capable of further enhancing the luminous efficiency as compared with the conventional PDPs, because the discharge gas contains a high ratio of xenon and the sustaining discharge initiated between the row electrodes X3, Y3 develops as a narrow-depth-range discharge.

The priming effect induced by a clearance formed between the dielectric layer and the vertical wall of the partition wall unit is enhanced by initiating a narrow-range discharge and using a discharge gas that contains a high ratio of xenon. Accordingly, the formation of the clearances r5 formed between the dielectric layer 12 and the vertical walls 15B makes it possible to achieve a higher luminous efficiency than that of the conventional PDPs.

With the structure of the PDP 90, the area in which a narrow-depth-range discharge is produced can be freely determined by changing the size and/or the position of the secondary electron emission layers 53. In consequence, the degree of flexibility in design and manufacturing is increased, and thus the PDP 80 is flexibly adaptable to a modification in design and the like.

The rest of the technical advantageous effects of the PDP 90 are as in the case of the eleventh embodiment example.

Fifteenth Embodiment Example

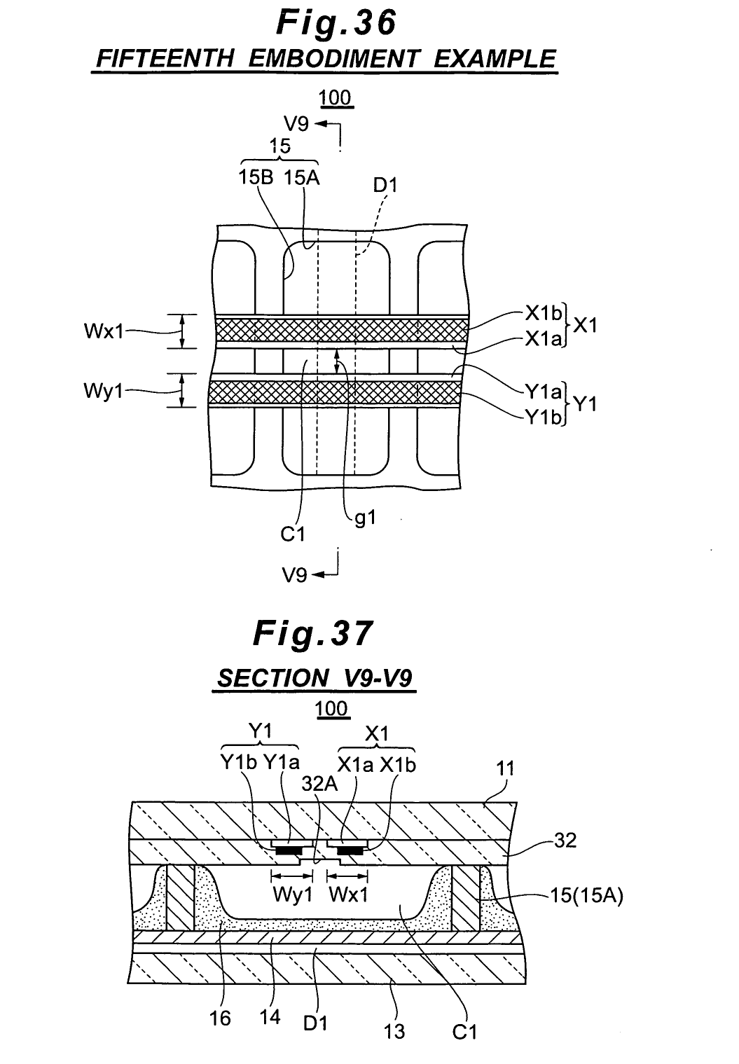

FIGS. 36, 37 illustrate a fifteenth embodiment example of PDP according to the present invention. FIG. 36 is a schematic front view showing part of the PDP in the fifteenth embodiment example. FIG. 37 is a sectional view taken along the V9-V9 line in FIG. 36.

In FIGS. 36 and 37, the PDP 100 has a front glass substrate 11 serving as the display surface. A plurality of row electrode pairs (X1, Y1) extending in the row direction (the right-left direction in FIG. 36) are regularly arranged at required intervals in the column direction (the up-down direction in FIG. 36) on the rear-facing face (the face facing toward the rear of the PDP) of the front glass substrate 11.

One row electrode X1 constituting part of each row electrode pair (X1, Y1) is composed of a transparent electrode X1a and a bus electrode X1b. The transparent electrode X1a extends in a belt shape in the row direction on the rear-facing face of the front glass substrate 11, and is formed of a transparent conductive film such as ITO. The bus electrode X1b extends in a belt shape in the row direction on a central portion of the rear-facing face of the transparent electrode X1a, and has a width in the column direction smaller than that of the transparent electrode X1a. The bus electrode X1b is formed of a metal film.

As is the case of the row electrode X1, the other row electrode Y1 constituting part of each row electrode pair (X1, Y1) is composed of a transparent electrode Y1a and a bus electrode Y1b. The transparent electrode Y1a extends in a belt shape in the row direction and is placed on the rear-facing face of the front glass substrate 11 parallel to the transparent electrode X1a of the row electrode X1 and at a required interval from it. The transparent electrode Y1a is formed of a transparent conductive film such as ITO. The bus electrode Y1b extends in a belt shape in the row direction on a central portion of the rear-facing face of the transparent electrode Y1a, and has a width in the column direction smaller than that of the transparent electrode Y1a. The bus electrode Y1b is formed of a metal film.

The row electrodes X1, Y1 are arranged in alternate positions in the column direction of the front glass substrate 11. In each row electrode pair (X1, Y1), the distance, set at the required width, between the opposing transparent electrodes X1a, Y1a of the respective row electrodes X1, Y1 paired with each other forms a discharge gap g1.

A dielectric layer 32 is provided on the rear-facing face of the front glass substrate 11 so as to cover the row electrode pairs (X1, Y1).

Recesses 32A are formed in the rear-facing face of the dielectric layer 32. Each of the recesses 32A is placed in correspondence with the discharge gap g1 between the row electrodes X1, Y1 constituting each row electrode pair (X1, Y1). Accordingly, the thickness (in the vertical direction with respect to the front glass substrate 11) of the portion of the dielectric layer 32 in which the recess 32A is formed is thinner than that of the other portions of the dielectric layer 32.

The recess 32A may be formed in a belt shape extending along the row electrodes X1, Y1. Alternatively, it may be formed in a quadrate island shape for each discharge cell as described later.

The entire rear-facing face of the dielectric layer 32, including the recesses 32A, is overlaid with a protective layer (not shown) formed of a high γ material such as magnesium oxide (MgO).

A back glass substrate 13 is placed parallel to the front glass substrate 11 with a discharge space in between.

A plurality of column electrodes D1 extending in a belt shape in the column direction are regularly arranged at required intervals in the row direction on the face of the back glass substrate 13 facing the front glass substrate 11.

On this face of the back glass substrate 13, a column-electrode protective layer (dielectric layer) 14 is formed so as to cover the column electrodes D1.

A partition wall unit 15 having a shape as described below is in turn formed on the column-electrode protective layer 14.

The partition wall unit 15 is formed in an approximate grid shape made up of a plurality of transverse walls 15A and a plurality of vertical walls 15B. Each of the transverse walls 15A extends in the row direction in correspondence with the mid-position between two row electrode pairs (X1, Y1) which are arranged adjacent to each other in the column direction on the front glass substrate 11. The vertical walls 15B extend in the column direction and are regularly arranged at required intervals in the row direction.

The partition wall unit 15 partitions the discharge space defined between the front glass substrate 11 and the back glass substrate 13 into approximately quadrate areas to form a plurality of discharge cells C1 arranged in matrix form over the panel surface.

The row electrode pairs (X1, Y1) are arranged so as to correspond with the central portions of the respective discharge cells C1.

Phosphor layers 16 are provided in the respective discharge cells C1. Each of the phosphor layers 16 fully overlies the five faces facing the discharge space in each discharge cell C1: the face of the column-electrode protective layer 14 and the four side faces of the transverse walls 15A and the vertical walls 15B of the partition wall unit 15. The three primary colors, red, green and blue, are individually applied to the phosphor layers 16 formed in the respective discharge cells C1, so that the three primary colors are arranged in order in the row direction.

The discharge space is filled with a discharge gas that includes xenon.

The following are the dimensions of the row electrodes X1, Y1 and the composition of the discharge gas in the above PDP 100.

The column-direction width of each row electrode X1, Y1, namely, the column-direction width Wx1 of the transparent electrode X1a and the column-direction width Wy1 of the transparent electrode Y1a (see FIG. 36), is set at 150 μm or less.

The xenon partial pressure in the discharge gas of the total pressure of 66.7 kPa (500 Torr) which fills the discharge space is set at 6.67 kPa (50 Torr) or more.

The PDP 100 applies a scan pulse sequentially to the row electrodes Y1 of the respective row electrode pairs (X1, Y1), and simultaneously applies a data pulse selectively to the column electrodes D1, whereupon an address discharge is initiated between the row electrode Y1 and the column electrode D1 in each of the discharge cells C1 located corresponding to the intersections of the row electrodes Y1 that receive the scan pulse and the column electrodes D1 that receive the data pulse. As a result of the address discharge, the light-emitting cells (which are the discharge cells C1 in which a wall charge accumulates on the portions of the dielectric layer 32 facing them) and the non-light-emitting cells (which are the discharge cells C1 in which the wall charge is erased from the portions of the dielectric layer 32 facing them) are distributed over the panel surface in accordance with the image data of the video signal.

Subsequently, a sustaining pulse is applied alternately to the row electrodes X1, Y1 in each row electrode pair (X1, Y1), whereupon a sustaining discharge is initiated across the discharge gap g1 between the transparent electrodes X1a, Y1a in each light-emitting cell.

The sustaining discharge in each light-emitting cell results in the generation of vacuum ultraviolet light from the xenon included in the discharge gas filling the discharge space. The vacuum ultraviolet light excites the red, green and blue phosphor layers 16 provided in the light-emitting cells. The excited phosphor layers 16 produce visible light, thus generating a matrix-display image on the panel surface.

In the foregoing PDP 100, the column-direction width Wx1 of each of the row electrodes X1 and the column-direction width Wy1 of each of the row electrodes Y1 are each set at 150 μm or less, and the xenon partial pressure in the discharge gas of a total pressure-of 66.7 kPa (500 Torr) filling the discharge space is set at 6.67 kPa (50 Torr) or more. This setting enables the achievement of a high luminous efficiency when a sustaining discharge as described above is initiated for the image generation.

The reasons for this are the same as described in the first embodiment example on the basis of FIGS. 4 to 6.

A high xenon partial pressure in the discharge gas as described above brings about a rise in the drive voltage of the PDP. To avoid this, the use of a drive circuit with a high withstand-voltage property is required, resulting in an increase in product cost.

In the PDP 100, each of the recesses 32A is formed in a portion of the rear-facing face of the dielectric layer 32 corresponding to the discharge gap g1 between the row electrodes X1, Y1 constituting each row electrode pair (X1, Y1), so that the dielectric layer 32 has a smaller thickness in the portion in which the recess 32A is formed than the thickness of the other portions without the recess 32A. As a result, the drive voltage of the PDP 100 is checked at a low level.

In this way, the luminous efficiency is enhanced by making the sustaining discharge between the row electrodes X1, Y1 develop as a narrow-depth-range discharge, and by using a discharge gas with a high xenon partial pressure. Even though a discharge gas with a high xenon partial pressure is used, a reduction in the drive voltage is achieved by forming the recess 32A in order thereby to reduce the thickness of the portion of the dielectric layer 32 in positional correspondence with the discharge gap g1 to less than the thickness of the other portions of the dielectric layer 32 without the recess 32A. In consequence, PDP 100 is capable of simultaneously achieving an improvement in the luminous efficiency and a reduction in the drive voltage.

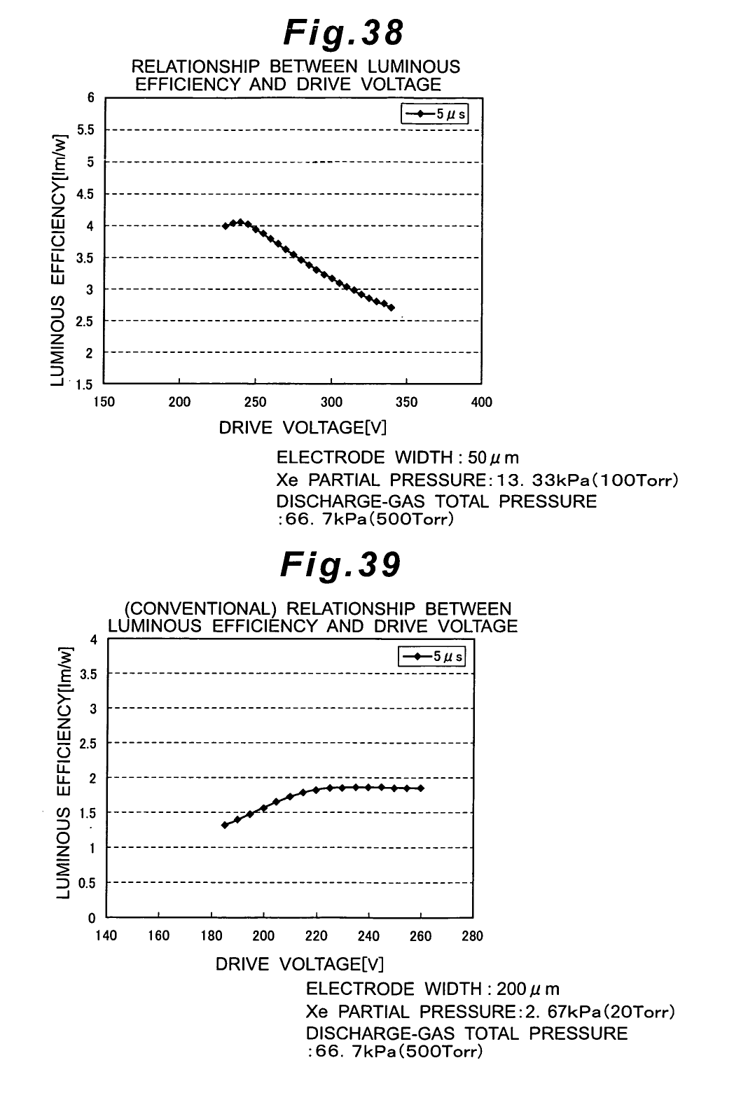

FIG. 38 is a graph showing the relationship between the luminous efficiency and the drive voltage of a PDP which has an electrode width set at 50 μm, and uses a discharge gas of a total pressure of 66.7 Kpa (500 Torr) with a xenon partial pressure set at 13.33 kPa (100 Torr). FIG. 39 is a graph showing the relationship between the luminous efficiency and the drive voltage of a conventional PDP which has an electrode width set at 200 μm, and uses a discharge gas of a total pressure of 66.7 kPa (500 Torr) with a xenon partial pressure set at 2.67 kPa (20 Torr).

In both FIGS. 38, 39, the measurements have been carried out with the sustaining pulse period set at 5 μsec.

As seen from the comparison between FIG. 38 and FIG. 39, the conventional PDP in FIG. 39 needs a high drive voltage in order to increase the luminous efficiency, and moreover even if the drive voltage is increased, the luminous efficiency reaches its maximum at a value equal to or less than the 2.0 (1 m/W) which is required by the PDP. On the other hand, in the PDP in FIGS. 38 in which the sustaining discharge develops as a narrow-depth-range discharge and a discharge gas with a high xenon partial pressure is used, with a reduction in the drive voltage, the luminous efficiency is able to be greatly increased in contrast to the case of the conventional PDP, and the resulting luminous efficiency can have a value approximately twice that of the conventional PDP in FIG. 39.

Thus, the PDP 100 makes the sustaining discharge develop as a narrow-depth-range discharge and uses a discharge gas with a high xenon partial pressure as described above, leading to the achievement of a high luminous efficiency. Further, the rise in the drive voltage which is produced by the use of a discharge gas with a high xenon partial pressure is held down by forming the recess 32A in order to reduce the thickness of the portion of the dielectric layer 32 in positional correspondence with the discharge gap g1 to less than the thickness of the other portions thereof. In consequence, the PDP 100 is capable of reducing the cost for providing a drive circuit and further increasing the

The foregoing advantageous effects can also be exerted in a PDP having a stripe-shaped partition wall unit. In the PDP 100, the partition wall unit 15 is formed in an approximate grid shape, which thus allows for the provision of the phosphor layer 16 on the four side faces of the transverse walls 15A and vertical walls 15B surrounding each discharge cell C1 so as to increase the surface area of the phosphor layer 16, resulting in the achievement of an even higher luminous efficiency.

The column-direction width of the row electrodes X1, Y1 of the PDP 100 is significantly smaller than that of the conventional PDPs, which thus massively reduces the electrostatic capacity arising between the electrodes. In consequence, the amount of reactive current is reduced, thus making it possible to reduce the electrical power consumption. Also, the formation of the recess 32A in the portion of the dielectric layer 32 in correspondence with the discharge gap g1 leads to a reduction in the electrostatic capacity arising between the electrodes so as to reduce the amount of reactive current, which in turn makes it possible to reduce the electrical power consumption.

The foregoing describes the example of the row electrode pair (X1, Y1) of the PDP 100 being placed in a column-direction central portion of each discharge cell C1. However, the row electrode pair (X1, Y1) may be placed in any position higher or lower (in FIG. 36) than the central portion in the column direction in each discharge cell C1.

This is for the following reasons.

In the conventional PDPs, the sustaining discharge results in a wide-range discharge expanding throughout a discharge cell as described earlier. In this case, if the row electrode pair is placed in a position higher or lower than the central position, in the column direction, of each of the discharge cells which are defined by a grid-shaped partition wall unit, the discharge gap is located closer to the upper or lower transverse wall of the partition wall unit defining each discharge cell. As a result, variations in voltage margin, brightness, luminous efficiency and the like occur from discharge cell to discharge cell, and those then adversely affect the light emission. To avoid this problem, a high precision of positioning of the row electrode pair in each discharge cell is required.

However, in the PDP 100, the sustaining discharge results in a narrow-depth-range discharge with a narrow discharge area as described earlier, and the area in which vacuum ultraviolet light is produced is a so-called point light source which is smaller than that of the conventional PDPs. Thus, the vacuum ultraviolet light is not easily affected by the partition wall unit, which involves such things as wall loss. Also, the phosphor layer 16 is excited by use of a 172 nm-wavelength molecular beam, which is not much absorbed, in the vacuum ultraviolet light. This reduces the effects caused by the variations in distance between the phosphor layer 16 and the discharge area (the area in which the vacuum ultraviolet light is produced) of the sustaining discharge. In consequence, even if the position of the row electrode pair (X1, Y1) in each discharge cell C1 in the column direction is away from the central position of the discharge cell C1, the brightness and luminous efficiency seldom vary.

Accordingly, with the PDP 100, even when each of the discharge cells C1 is surrounded by the transverse walls 15A and the vertical walls 15B of the approximately grid-shaped partition wall unit 15, the position of the discharge gap (i.e. the position of the row electrode pair) need not be accurately aligned with the central position of the discharge cell in the column direction, resulting in an increase in tolerance in the precision of positioning of the row electrode pair (X1, Y1) in each discharge cell C1. This makes it possible to enhance the product yield in the manufacturing process and to contribute to a reduction in manufacturing costs.

The foregoing describes the example of a transparent electrode constituting part of the row electrode being formed in a belt shape continuously extending between adjacent discharge cells along the bus electrode. However, a transparent electrode may be formed independently in each discharge cell and connected to the bus electrode.

The foregoing describes the example of a row electrode made up of the transparent electrode and the bus electrode. However, the row electrode may be made up of a metal-made bus electrode alone and have a width of 150 μm or less in the column direction.

Sixteenth Embodiment Example

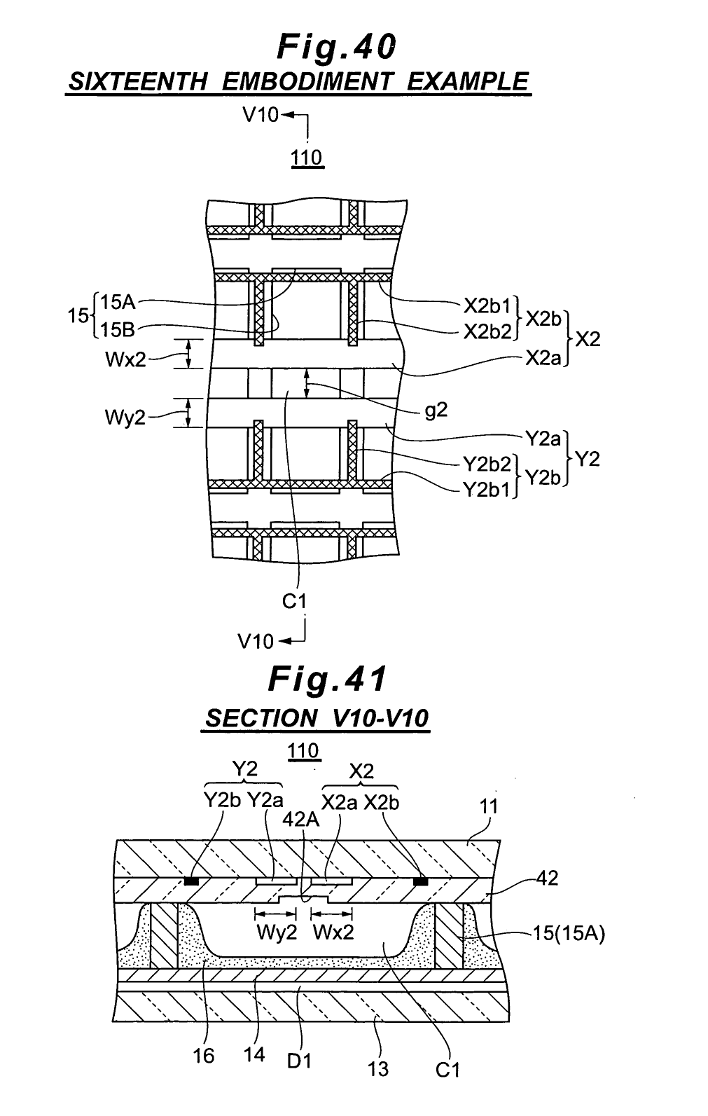

FIGS. 40, 41 are a schematic front view illustrating part of the PDP of a sixteenth embodiment example according to the present invention. FIG. 40 is a schematic front view illustrating part of the PDP in the sixteenth embodiment example. FIG. 41 is a sectional view taken along the V10-V10 line in FIG. 40.

In FIGS. 40, 41, the same components as those of the PDP described in the second embodiment example are indicated with the same reference numerals as those in FIG. 7.

The bus electrode of each of the row electrodes making up the row electrode pair of the PDP of the fifteenth embodiment example is positioned in an approximately central portion of the rear-facing face of the transparent electrode. By contrast, in the PDP 110 of the sixteenth embodiment example, row electrodes X2, Y2 constituting each of the row electrode pairs (X2, Y2) are each made up of transparent electrodes X2a, Y2a and bus electrodes X2b, Y2b. The transparent electrodes X2a, Y2a are placed facing the column-direction central portion of each discharge cell C1 defined by an approximately-grid-shaped partition wall unit 15. The bus electrodes X2b, Y2b are placed close to the respective transverse walls 15A defining the two opposing sides of the discharge cell C1, and are connected to the respective transparent electrodes X2a, Y2a.

In FIGS. 40, 41, the discharge space of the PDP 110 is partitioned into approximately quadrate areas by the partition wall unit 15 which is of an approximate grid shape made up of transverse walls 15A and vertical walls 15B to form the discharge cells C1, as in the case of the fifteenth embodiment example.

The belt-shaped transparent electrodes X2a, Y2a of the respective row electrodes X2, Y2 constituting the row electrode pair (X2, Y2) are spaced at a required interval (discharge gap g2) and extend parallel to each other in the row direction in correspondence to the column-direction central portion of each discharge cell C1.

The transparent electrodes X2a, Y2a each have a column-direction width (Wx2, Wy2) set at 150 μm or less.

The bus electrodes X2b, Y2b are each made up of bus-electrode bodies X2b1, Y2b1 and bus-electrode connecting portions X2b2, Y2b2. Each of the bus-electrode bodies X2b1, Y2b1 extends in a belt shape in the row direction along the inner edge of the transverse wall 15A of the partition wall unit 15. The bus-electrode connecting portions X2b2, Y2b2 each extend in the column direction between the bus-electrode bodies X2b1, Y2b1 and the transparent electrodes X2a, Y2a in parallel to the vertical wall 15B of the partition wall unit 15 for forming the connection between the bus-electrode bodies X2b1, Y2b1 and the transparent electrodes X2a, Y2a.

Recesses 42A are formed in the rear-facing face of the dielectric layer 42 overlying the row electrodes (X2, Y2). Each of the recesses 42A is placed in correspondence with the discharge gap g2 between the row electrodes X2, Y2 constituting each row electrode pair (X2, Y2). Accordingly, the thickness (in the vertical direction with respect to the front glass substrate 11) of the portion of the dielectric layer 42 in which the recess 42A is formed is thinner than that of the rest of the dielectric layer 42.

The recess 42A may be formed in a belt shape extending along the row electrodes X2, Y2. Alternatively, it may be formed in a quadrate island shape for each discharge cell as described later.

The rest of the structure in the sixteenth embodiment example is similar to that in the fifteenth embodiment example. The xenon partial pressure in the discharge gas of a total pressure of 66.7 kPa (500 Torr) filling the discharge gas is set at 6.67 kPa or more (50 Torr or more).

In the fifteenth embodiment example, the bus electrode formed of a metal film is positioned facing the central portion of the discharge cell. Therefore, the opening of the discharge cell is divided into two in the column direction by the bus electrodes that do not have light transmission properties. By contrast, in the PDP 110, the bus-electrode bodies X2b1, Y2b1 of the bus electrodes X2b, Y2b formed of a metal film are placed close to the transverse walls 15A of the partition wall 15. In this way, the opening of the discharge cell C1 is not divided into two by the bus electrodes X2b, Y2b as is done in the fifteenth embodiment example.

The characteristics of the sixteenth embodiment example are that the intensity of the light emission increases gradually toward the discharge gap and decreases gradually toward the transverse walls. With this structure, the portion in the discharge cell with a high intensity of light emission is not obstructed by the bus electrode, resulting in the achievement of a higher luminous efficiency.

In the PDP 110, further, because the bus-electrode connecting portions X2b2, Y2b2 are placed opposite to the transverse walls 15B of the partition wall unit 15, part of the opening of the discharge cell C1 is not blocked by the formation of the bus-electrode connecting portions X2b2, Y2b2.

The foregoing describes the example of the bus-electrode bodies X2b1, Y2b1 of the bus electrodes X2b, Y2b being placed close to the transverse walls 15A of the partition wall unit 15 and facing the discharge cell C1. However, the bus-electrode bodies X2b1, Y2b1 may be placed opposite to the transverse walls 15A of the partition wall unit 15. In this case, the bus-electrode bodies X2b1, Y2b1 do not block the opening of the discharge cell C1, thus eliminating the risk of the entire area of the bus electrodes X2b, Y2b becoming obstacles to light emission from the phosphor layer.

In the PDP 110, the column-direction width (electrode width) Wx2 of the transparent electrode X2a of the row electrode X2 and the column-direction width (electrode width) Wy2 of the transparent electrode Y2a of the row electrode Y2 are each set at 150 μm or less. With this setting, as in the case of the fifteenth embodiment example, the sustaining discharge initiated between the transparent electrodes X2a and Y2a results in a narrow-depth-range discharge. In consequence, the vacuum ultraviolet light is generated at avery high efficiency as compared with the conventional PDPs. Also, by setting the xenon partial pressure in the discharge gas filling the discharge space at 6.67 kPa (50 Torr) or more, the phosphor layer 16 is excited mainly by the 172 nm-wavelength molecular beam, which is seldom attenuated, in the vacuum ultraviolet light generated from the xenon in the discharge gas, resulting in the achievement of an increase in luminous efficiency as compared with the conventional PDPs.

In the PDP 110, the rise in the drive voltage induced by the use of a discharge gas with a high xenon partial pressure is held down by forming the recess 42A in order thereby to reduce the thickness of the portion of the dielectric layer 42 in correspondence with the discharge gap g2 to less than the thickness of the other portions thereof. This makes it possible to reduce the drive circuit cost and also further enhance the luminous efficiency.

The foregoing advantageous effects can also be exerted in a PDP having a stripe-shaped partition wall unit. In the PDP 110, the partition wall unit 15 is formed in an approximate grid shape, which thus allows for the provision of the phosphor layer on the four side faces of the transverse walls 15A and vertical walls 15B surrounding each discharge cell C1 so as to increase the surface area of the phosphor layer, resulting in a further improvement in the luminous efficiency.

The column-di-rection width of each of the transparent electrodes X2a, Y2a of the row electrodes X2, Y2 of the PDP 110 is significantly smaller than that of the conventional PDPs. This means that the electrostatic capacity arising between the electrodes is massively reduced. In consequence, the amount of reactive current is reduced, thus making it possible to reduce the electrical power consumption. Also, the formation of the recess 42A in the portion of the dielectric layer 42 in correspondence with the discharge gap g2 leads to a reduction in the electrostatic capacity arising between the electrodes so as to reduce the amount of reactive current, which in turn makes it possible to reduce the electrical power consumption.

The row electrode pair (X2, Y2) of the PDP 110 may be placed in any position higher or lower (in FIG. 40) than the central portion in the column direction in each discharge cell C1 for the same reasons as those described in the fifteenth embodiment example. In consequence, the tolerance in the precision of positioning of the row electrode pair (X2, Y2) in each discharge cell C1 is increased. Accordingly, it is possible to contribute to a reduction in manufacturing costs because of the enhancement of the product yield in the manufacturing process.

The foregoing describes the example of a transparent electrode constituting part of the row electrode being formed in a belt shape continuously extending between adjacent discharge cells along the bus electrode. However, a transparent electrode may be formed independently in each discharge cell and connected to the bus electrode.

Seventeenth Embodiment Example

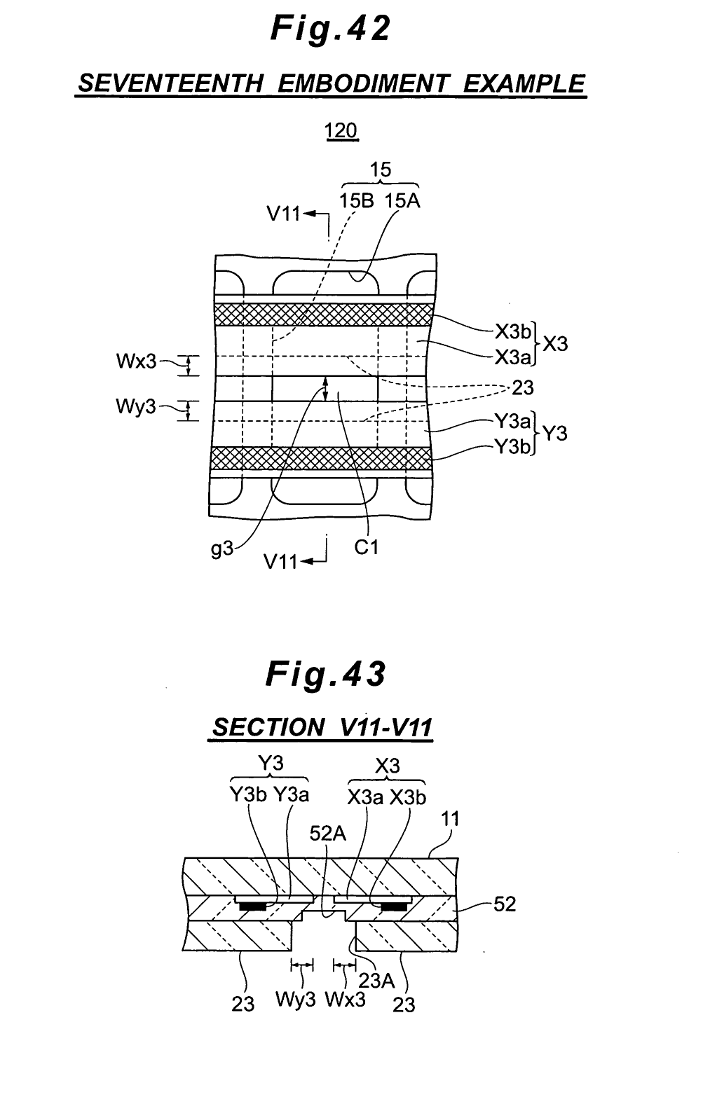

FIGS. 42, 43 illustrate a seventeenth embodiment example according to the present invention. FIG. 42 is a schematic front view showing part of the PDP of the seventeenth embodiment example. FIG. 43 is a sectional view taken along the V11-V11 line in FIG. 42.

In FIGS. 42, 43, the same components as those of the PDP in the third embodiment example are indicated with the same reference numerals as those in FIGS. 8, 9.

In the case of the PDP of the fifteenth embodiment example, the column-direction width of the transparent electrode of each row electrode is changed in order for the sustaining discharge to develop as a narrow-range discharge. By contrast, in the PDP 120 of the seventeenth embodiment example, row electrode pairs (X3, Y3) each similar in size to those of the conventional PDPs (see FIG. 1) are arranged facing the discharge cells C1 defined by a partition wall unit 15 of an approximate grid shape. Second dielectric layers 23 are formed on the required portions of the rear-facing face, which faces the discharge space, of a first dielectric layer 52 which is provided for covering the row electrode pairs (X3, Y3), in such a manner as to reduce the column-electrode width of each of the portions of the row electrodes X3, Y3 between which a discharge is substantially caused in each discharge cell C1. In this way, the sustaining discharge develops as a narrow-depth-range discharge.

Specifically, transparent electrodes X3a, Y3a are provided on the rear-facing face of the front glass substrate 11 of the PDP 120. The transparent electrodes X3a, Y3a are each formed in a belt shape of a similar column-direction width, e.g. 400 μm to 1000 μm, to that of the conventional PDP illustrated in FIG. 1. The transparent electrodes X3a, Y3a are spaced at a required interval (discharge gap g3) and extend parallel to each other in the row direction. Bus electrodes X3b, Y3b of a belt shape extending in the row direction are formed on the respective outer sides (away from the leading sides facing each other across the discharge gap) of the rear-facing faces of the transparent electrodes X3a, Y3a, and are connected to the respective transparent electrodes X3a, Y3a.

The row electrode pairs (X3, Y3) are overlaid with the first dielectric layer 52 formed on the rear-facing face of the front glass substrate 11.

Recesses 52A are formed in the rear-facing face of the first dielectric layer 52. Each of the recesses 52A is placed in correspondence with the discharge gap g3 between the row electrodes X3, Y3 constituting each row electrode pair (X3, Y3). Accordingly, the thickness (in the vertical direction with respect to the front glass substrate 11) of the portion of the first dielectric layer 52 in which the recess 52A is formed is thinner than that of the other portions of the first dielectric layer 52 without the recess 52A.

The recess 52A may be formed in a belt shape extending along the row electrodes X3, Y3. Alternatively, it may be formed in a quadrate island shape for each discharge cell as described later.

The second dielectric layers 23 are laid, as described below, on the required portions of the rear-facing face of the first dielectric layer 52.

A secondary electron emission layer (not shown) is in turn formed so as to overlie the entire rear-facing faces of the first dielectric layer 52 and second dielectric layers 23 including the recesses 52A.

The second dielectric layers 23 are formed on the portions of the rear-facing face of the first dielectric layer 52 other than the belt-shaped portions which each extend in the row direction in positional correspondence with the discharge gap g3, and with the leading-side portions, having the column-direction widths Wx3, Wy3 of 150 μor less and facing each other across the discharge gap g3, of the transparent electrodes X3a, Y3a of the row electrodes X3, Y3.

The thickness of the first dielectric layer 52 overlying the row electrode pairs (X3, Y3) is approximately equal to that of the conventional PDPs in which a discharge results in the accumulation of a wall charge. The thickness of each of the second dielectric layers 23 is greater than that of the first dielectric layer 52. The total thickness of the lamination of the first dielectric layer 52 and second dielectric layer 23 is set at a thickness which exceeds twice the thickness of the first dielectric layer 52 so as to make a wall charge seldom accumulate during a discharge.

Each of the recesses 52A formed in the first dielectric layer 52 is placed in correspondence with the belt-shaped groove 23A between the second dielectric layers 23.

The discharge space is filled with a discharge gas at a total pressure of 66.7 kPa (500 Torr) with a xenon partial pressure of 6.67 kPa (50 Torr) or more.

Each of the row electrodes X3, Y3 of each row electrode pair (X3, Y3) of the PDP 120 has a column-direction width approximately equal to that of the conventional PDPs. The portions of the respective transparent electrodes X3a, Y3a, facing each other across the discharge gap g3, of the row electrodes X3, Y3, other than the leading-side portions having the column-direction widths Wx3, Wy3, are covered with a double dielectric layer made up of the laminated first and second dielectric layers 52, 23. Thus, the dielectric layer overlying the portions other than the leading-side portions having the column-direction width Wx3, Wy3 has a greater thickness than that of the dielectric layer overlying the leading-side portions. As a result, a wall charge seldom accumulates on the thicker portion of the second dielectric layer 23 deposited on the first dielectric layer 52, and accumulates on the surface of the first dielectric layer 52 overlying the leading-side portions having the column-direction widths Wx3, Wy3 of the transparent electrodes X3a, Y3a.

In this way, in the PDP 120, when a sustaining pulse is applied to the row electrode pair (X3, Y3) so as to initiate a sustaining discharge across the discharge gap g3 between the transparent electrodes X3a, Y3a, almost all of the sustaining discharge develops only on the leading-side portions having the column-direction widths Wx3, Wy3 of the transparent electrodes X3a, Y3a, resulting in the formation of a narrow-depth-range discharge as described in the first embodiment example.

With the PDP 120 designed as described above, as in the case of the fifteenth embodiment example, the sustaining discharge develops as a narrow-depth-range discharge. This means that vacuum ultraviolet light is generated at a very high efficiency as compared with the conventional PDPs. Also, the xenon partial pressure in the discharge gas filling the discharge space at a total pressure of 66.7 kPa (500 Torr) is set at 6.67 kPa (50 Torr) or more. In this way, the phosphor layer is excited mainly by a 172 nm-wavelength molecular beam which is seldom attenuated, resulting in the achievement of an increase in luminous efficiency as compared with the conventional PDPs.

In the PDP 120, the rise in the drive voltage induced by the use of the discharge gas with a high xenon partial pressure is held down by forming the recess 52A in order thereby to reduce the thickness of the portion of the first dielectric layer 52 in correspondence with the discharge gap g3 to less than the thickness of the other portions thereof. This makes it possible to reduce the drive circuit cost and also further enhance the luminous efficiency.

Also, in the PDP 120 the formation of the recess 52A in the portion of the first dielectric layer 52 in correspondence with the discharge gap g3 leads to a reduction in the electrostatic capacity arising between the electrodes so as to reduce the amount of reactive current, which in turn makes it possible to reduce the electrical power consumption.

The row electrodes (X3, Y3) of the PDP 120 may be placed in any position higher or lower (in FIG. 42) than the column-direction central position of each discharge cell C1 for the same reasons as those described in the fifteenth embodiment example. In consequence, the tolerance in the precision of positioning of the row electrode pair (X3, Y3) in each discharge cell C1 is increased. Accordingly, it is possible to contribute to a reduction in manufacturing costs because of the enhancement of the product yield in the manufacturing process.

In addition to similar advantageous effects of the PDP 120 to those in the fifteenth embodiment example, because the column-direction width of the transparent electrodes X3a, Y3a is similar to that in the conventional PDPs, and the bus electrodes X3b, Y3b are placed at a distance from the discharge gap g3, the effect of the metal-film-formed bus electrodes X3b, Y3b on light emission from the phosphor layer is reduced, resulting in enhancement of the efficiency of the extraction of visible light.

The characteristics of the seventeenth embodiment example are that the intensity of the light emission increases gradually toward the discharge gap and decreases gradually toward the transverse walls. With this structure, the portion in the discharge cell with a high intensity of light emission is not obstructed by the bus electrode, resulting in the achievement of a higher luminous efficiency.

The design of the PDP 120 enables a simplification of the structure for reducing the effect of the bus electrode on the light emission from the phosphor layer as compared with the case of the PDP of the second embodiment example.

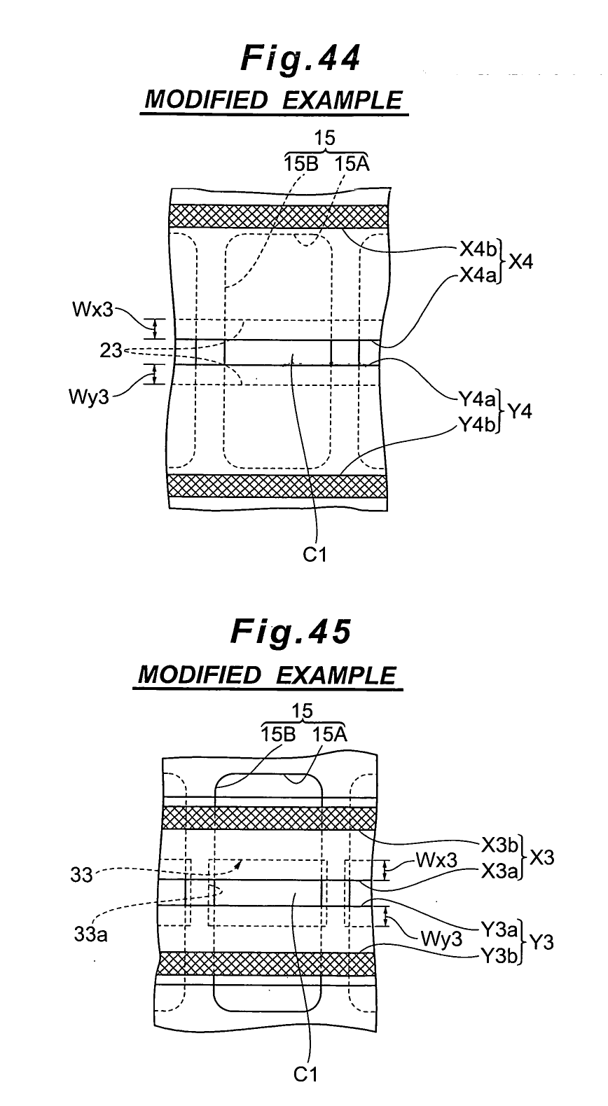

For example, FIGS. 42, 43 show the example of the bus electrodes X3b, Y3b being placed facing the opening of the discharge cell C1, but, as illustrated in FIG. 44, bus electrodes X4b, Y4b of the respective row electrodes X4, Y4 constituting a row electrode pair (X4, Y4) may be placed away from the opening of the discharge cell C1. This placement eliminates the effect of the bus electrodes X4b, Y4b on the light emission from the phosphor layer, leading to the achievement of a massive increase in the efficiency of the extraction of visible light.

Since the structure of the row electrode pair (X3, Y3) of the PDP 120 is similar to the conventional structure, an extensive change in the manufacturing process is unnecessary. Further, since the position for forming the second dielectric layer 23 can be freely determined, the degree of flexibility in design and manufacturing is increased. Accordingly, it is possible to reduce the manufacturing costs and contribute to product yield.

The foregoing describes the example of the transparent electrode, making up part of the row electrode, being formed in a belt shape continuously extending between adjacent discharge cells along the associated bus electrode. However, a transparent electrode may be formed independently in each discharge cell and connected to the associated bus electrode.

The foregoing describes the example of the second dielectric layers each extending in a belt shape in the row direction. However, the second dielectric layer placed on the first dielectric layer may be a second dielectric layer 33 as illustrated in FIG. 45 which may be formed in an approximate grid shape having quadrate openings 33a aligned with the openings of the respective discharge cells C1. By use of the openings 33a, the thickness of the dielectric layer overlying the portions other than the leading-side portions of the column-direction widths Wx3, Wy3 of the respective transparent electrodes X3a, Y3a and the discharge gap g3 between them may be set such that a wall charge does not

Eighteenth Embodiment Example

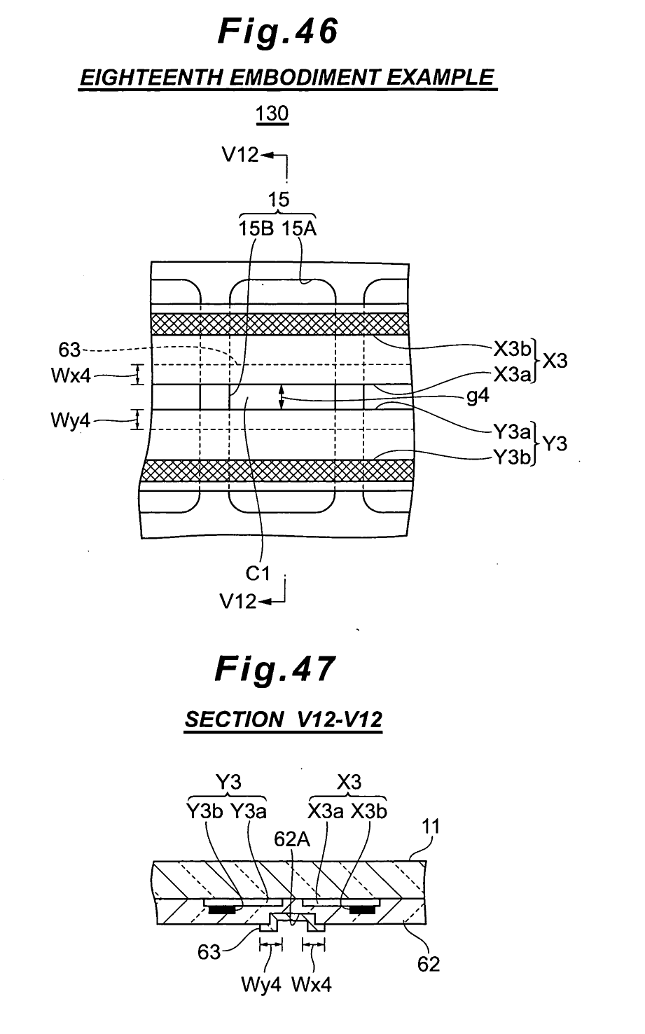

FIGS. 46, 47 illustrate an eighteenth embodiment example according to the-present invention. FIG. 46 is a schematic front view showing part of the PDP of the eighteenth embodiment example. FIG. 47 is a sectional view taken along the V12-V12 line in FIG. 46.

In FIGS. 46, 47, the same components as those of the PDP in the fourth embodiment example are indicated with the same reference numerals as those used in FIGS. 12, 13.

In the PDP of the seventeenth embodiment example, the second dielectric layer is formed on the first dielectric layer overlying the row electrode pairs, whereby the discharge range of a sustaining discharge is limited to produce a narrow-depth-range discharge. By contrast, in the PDP 130 of the eighteenth embodiment example, row electrode pairs (X3, Y3) each having a similar size to that of the conventional PDPs (see FIG. 1) are arranged facing the discharge cells C1 defined by a partition wall unit 15 of an approximate grid shape. The row electrode pairs (X3, Y3) are overlaid with a dielectric layer 62. Recesses 62A are formed in portions of the dielectric layer 62 in correspondence with the discharge gaps g4 between the row electrodes X3, Y3. Secondary electron emission layers 43, which are formed of a high γ material such as MgO, are formed in a belt shape extending in the row direction only on the required portions of the rear-facing face, which faces the discharge space, of the dielectric layer 62. The sustaining discharge initiated between the transparent electrodes X3a, Y3a develops as a narrow-depth-range discharge due to the secondary electron emission layer 63.

Specifically, the transparent electrodes X3a, Y3a are provided on the rear-facing face of the front glass substrate 11 of the PDP 130. The transparent electrodes X3a, Y3a are each formed in a belt shape of a similar column-direction width, e.g. 400 μm to 1000 μm, to that of the conventional PDP illustrated in FIG. 1. The transparent electrodes X3a, Y3a are spaced at a required interval (discharge gap g4) and extend parallel to each other in the row direction. The bus electrodes X3b, Y3b of a belt shape extending in the row direction are formed on the respective outer sides of the rear-facing faces of the transparent electrodes X3a, Y3a, and are connected to the respective transparent electrodes X3a, Y3a.

The row electrode pairs (X3, Y3) are overlaid with the dielectric layer 62 formed on the rear-facing face of the front glass substrate 11. Each of the recesses 62A is formed in the portion of the dielectric layer 62 in correspondence with the discharge gap g4 between the row electrodes X3, Y3. The thickness (in the vertical direction with respect to the front glass substrate 11) of the portion of the dielectric layer 62 in which the recess 62A is formed is smaller than that of the other portions of the dielectric layer 62.

The recess 62A may be formed in a belt shape extending along the row electrodes X3, Y3. Alternatively, it may be formed in a quadrate island shape for each discharge cell as described later.

The secondary electron emission layers 63 are in turn formed on the rear-facing face of the dielectric layer 62. Each of the secondary electron emission layer 63 is formed of a high γ material such as MgO and extends in a belt shape in the row direction in positional correspondence with the discharge gap g4 and the leading-side portions of the column-direction width Wx4, Wy4 of the respective transparent electrodes X3a, Y3a placed across the discharge gap g4.

Accordingly, the secondary electron emission layer 63 is formed on the inside of the recess 62A so as to cover the inner wall face of the recess 62A.

An example of various methods of forming the secondary electron emission layers 63 is here described: a mask having openings made in positional correspondence with the secondary electron emission layers 63 is laid between the dielectric layer 62 and a material evaporation source of a high γ material, and then a high γ material vapor is generated from the material evaporation source and deposited on the portions of the dielectric layer 62 corresponding to the mask openings so as to form layers.

The column-direction widths Wx4, Wy4 of the portions of each of the secondary electron emission layers 63 facing the respective transparent electrodes X3a, Y3a are each set at 150 μm or less.

The xenon partial pressure in a discharge gas of a total pressure of 66.7 kPa (500 Torr) filling the discharge space is set at 6.67 kPa (50 Torr) or more.

The column-direction width of each of the row electrodes X3, Y3 of the row electrode pair (X3, Y3) of the PDP 130 has approximately the same size as that of the conventional PDPs. However, the PDP 130 has the secondary electron emission layers 63 formed of a high γ material and each placed on the portion of the dielectric layer 62 corresponding to the discharge gap g4 and the leading-side portion of the column-direction width Wx4, Wy4 of the transparent electrodes X3a, Y3 a across the discharge gap g4. As a result, almost all of the sustaining discharge initiated between the transparent electrodes X3a, Y3a develops within the area in which the secondary electron emission layer 63 is formed. This means that the sustaining discharge appears as a narrow-depth-range discharge as described in the first embodiment example.

As described above, the sustaining discharge develops as a narrow-depth-range discharge as in the case of the first embodiment example. Thus, in the PDP 130, the vacuum ultraviolet light is generated at a very high efficiency as compared with the conventional PDPs. Also, by setting the xenon partial pressure in the discharge gas filling the discharge space at 6.67 kPa (50 Torr) or more, the phosphor layer is excited mainly by the 172 nm-wavelength molecular beam, which is seldom attenuated, in the vacuum ultraviolet light generated from the xenon in the discharge gas, resulting in the achievement of an increase in luminous efficiency as compared with the conventional PDPs.

In the PDP 130, the rise in the drive voltage induced by the use of the discharge gas with a high xenon partial pressure is held down by forming the recess 62A in order thereby to reduce the thickness of the portion of the dielectric layer 62 in correspondence with the discharge gap g4 to less than the thickness of the other portions thereof. This makes it possible to reduce the drive circuit cost and also further enhance the luminous efficiency.

Also, in the PDP 130 the formation of the recess 62A in the portion of the dielectric layer 62 in correspondence with the discharge gap g4 leads to a reduction in the electrostatic capacity arising between the electrodes so as to reduce the amount of reactive current, which in turn makes it possible to reduce the electrical power consumption.

The row electrodes (X3, Y3) of the PDP 130 may be placed in any position higher or lower (in FIG. 46) than the column-direction central position of each discharge cell C1 for the same reasons as those described in the fifteenth embodiment example. In consequence, the tolerance in the precision of positioning of the row electrode pair (X3, Y3) in each discharge cell C1 is increased. Accordingly, it is possible to contribute to a reduction in manufacturing costs because of the enhancement of the product yield in the manufacturing process.

In addition to similar advantageous effects of the PDP 130 to those in the fifteenth embodiment example, because the column-direction width of the transparent electrodes X3a, Y3a has a similar size to those in the conventional PDPs and the bus electrodes X3b, Y3b are placed at a distance from the discharge gap g4, the effect of the metal-film-formed bus electrodes X3b, Y3b on light emission from the phosphor layer is reduced, resulting in enhancement of the efficiency of the extraction of visible light.

The characteristics of the eighteenth embodiment example are that the intensity of the light emission increases gradually toward the discharge gap and decreases gradually toward the transverse walls. With this structure, the portion in the discharge cell with a high intensity of light emission is not obstructed by the bus electrode, resulting in the achievement of a higher luminous efficiency.

The design of the PDP 130 enables simplification of the structure for reducing the effect of the bus electrode on the light emission from the phosphor layer as compared with the case of the PDP of the second embodiment example.

With the structure of the PDP 130, the area in which a narrow-depth-range discharge is produced can be freely set by changing the size and/or the position of the secondary electron emission layers 63. In consequence, the degree of flexibility in design and manufacturing is increased, and thus the PDP 130 is flexibly adaptable to a modification in design and the like.

The foregoing describes the example of the secondary electron emission layer 63 being formed in a belt shape in the row direction. However, a secondary electron emission layer may be formed independently in a so-called island form in each discharge cell.

The foregoing describes the example of a transparent electrode constituting part of the row electrode being formed in a belt shape continuously extending between adjacent discharge cells along the bus electrode. However, a transparent electrode may be formed independently in each discharge cell and connected to the bus electrode.

Nineteenth Embodiment Example

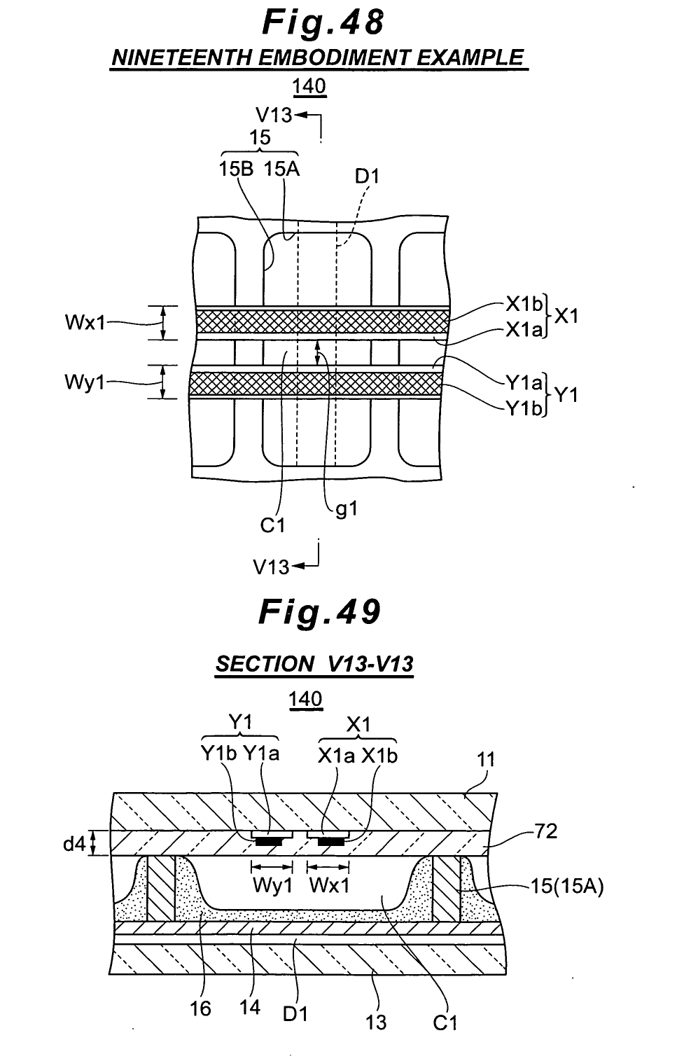

FIGS. 48, 49 illustrate a nineteenth embodiment example of the embodiment of a PDP according to the present invention. FIG. 48 is a schematic front view showing part of the PDP in the nineteenth embodiment example. FIG. 49 is a sectional view taken along the V13-V13 line in FIG. 48.

In FIGS. 48 and 49, the PDP 140 has a front glass substrate 11 serving as the display surface. A plurality of row electrode pairs (X1, Y1) extending in the row direction (the right-left direction in FIG. 48) are regularly arranged at required intervals in the column direction (the up-down direction in FIG. 48) on the rear-facing face (the face facing toward the rear of the PDP) of the front glass substrate 11.

One row electrode X1 constituting part of each row electrode pair (X1, Y1) is composed of a transparent electrode X1a and a bus electrode X1b. The transparent electrode X1a extends in a belt shape in the row direction on the rear-facing face of the front glass substrate 11, and is formed of a transparent conductive film such as ITO. The bus electrode X1b extends in a belt shape in the row direction on a central portion of the rear-facing face of the transparent electrode X1a, and has a width in the column direction smaller than that of the transparent electrode X1a. The bus electrode X1b is formed of a metal film.

As is the case of the row electrode X1, the other row electrode Y1 constituting part of each row electrode pair (X1, Y1) is composed of a transparent electrode Y1a and a bus electrode Y1b. The transparent electrode Y1a extends in a belt shape in the row direction an displaced on the rear-facing face of the front glass substrate 11 parallel to the transparent electrode X1a of the row electrode X1 and at a required interval from it. The transparent electrode Y1a is formed of a transparent conductive film such as ITO. The bus electrode Y1b extends in a belt shape in the row direction on a central portion of the rear-facing face of the transparent electrode Y1a, and has a width in the column direction smaller than that of the transparent electrode Y1a. The bus electrode Y1b is formed of a metal film.

The row electrodes X1, Y1 are arranged in alternate positions in the column direction of the front glass substrate 11. In each row electrode pair (X1, Y1), the distance, set at the required width, between the opposing transparent electrodes X1a, Y1a of the respective row electrodes X1, Y1 paired with each other forms a discharge gap g1.

A dielectric layer 72 is provided on the rear-facing face of the front glass substrate 11 so as to cover the row electrode pairs (X1, Y1).

For reasons which will be described later, the dielectric layer 72 is formed of a low dielectric material with a relative dielectric constant of 9.3 or less, desirably, 8 or less. The dielectric layer 72 has a film-thickness d4 in a direction at right angles to the front glass substrate 11 set at 35 μm or more.

Examples of a low dielectric material with a relative dielectric constant of 9.3 or less for the dielectric layer 72 include zinc oxide (ZnO) glass, a mixture of ZnO glass and phosphorus oxide (P₂O₅) glass, and the like.

The rear-facing face of the dielectric layer 72 is in turn overlaid with a protective layer (not shown) formed of a high γ material such as magnesium oxide (MgO).

A back glass substrate 13 is placed parallel to the front glass substrate 11 with a discharge space in between.

A plurality of column electrodes D1 extending in a belt shape in the column direction are regularly arranged at required intervals in the row direction on the face of the back glass substrate 13 facing the front glass substrate 11.

On this face of the back glass substrate 13, a column-electrode protective layer (dielectric layer) 14 is formed so as to cover the column electrodes D1.

A partition wall unit 15 having a shape as described below is in turn formed on the column-electrode protective layer 14.

The partition wall unit 15 is formed in an approximate grid shape made up of a plurality of transverse walls 15A and a plurality of vertical walls 15B. Each of the transverse walls 15A extends in the row direction in correspondence with the mid-position between two row electrode pairs (X1, Y1) which a rearrangedadjacent to each other in the column direction on the front glass substrate 11. The vertical walls 15B extend in the column direction and are regularly arranged at required intervals in the row direction.

The partition wall unit 15 partitions the discharge space defined between the front glass substrate 11 and the back glass substrate 13 into approximately quadrate areas to form a plurality of discharge cells C1 arranged in matrix form over the panel surface.

The row electrode pairs (X1, Y1) are arranged so as to correspond with the central portions of the respective discharge cells C1.

Phosphor layers 16 are provided in the respective discharge cells C1. Each of the phosphor layers 16 fully overlies the five faces facing the discharge space in each discharge cell C1: the face of the column-electrode protective layer 14 and the four side faces of the transverse walls 15A and the vertical walls 15B of the partition wall unit 15. The three primary colors, red, green and blue, are applied individually to the phosphor layers 16 formed in the respective discharge cells C1, so that the three primary colors are arranged in order in the row direction.

The discharge space is filled with a discharge gas having a total pressure of 66.7 kPa (500 Torr) that includes xenon.

The following are the dimensions of the row electrodes X1, Y1 and the composition of the discharge gas in the above PDP 140.

The column-direction width of each row electrode X1, Y1, namely, the column-direction width Wx1 of the transparent electrode X1a and the column-direction width Wy1 of the transparent electrode Y1a (see FIG. 48), is set at 150 μm or less.

The xenon partial pressure in the discharge gas which fills the discharge space is set at 6.67 kPa (50 Torr) or more.

The PDP 140 applies a scan pulse sequentially to the row electrodes Y1 of the respective row electrode pairs (X1, Y1), and simultaneously applies a data pulse selectively to the column electrodes D1, whereupon an address discharge is initiated between the row electrode Y1 and the column electrode D1 in each of the discharge cells C1 located corresponding to the intersections of the row electrodes Y1 that receive the scan pulse and the column electrodes D1 that receive the data pulse. As a result of the address discharge, the light-emitting cells (which are the discharge cells C1 in which a wall charge accumulates on the portions of the dielectric layer 72 facing them) and the non-light-emitting cells (which are the discharge cells C1 in which the wall charge is erased from the portions of the dielectric layer 72 facing them) are distributed over the panel surface in accordance with the image data of the video signal.

Subsequently, a sustaining pulse is applied alternately to the paired row electrodes X1, Y1 in each row electrode pair (X1, Y1), whereupon a sustaining discharge is initiated across the discharge gap g1 between the transparent electrodes X1a, Y1a in each light-emitting cell.

The sustaining discharge in each light-emitting cell results in the generation of vacuum ultraviolet light from the xenon included in the discharge gas filling the discharge space. The vacuum ultraviolet light excites the red, green and blue phosphor layers 16 provided in the light-emitting cells. The excited phosphor layers 16 produce visible light, thus generating a matrix-display image on the panel surface.

In the foregoing PDP 140, the column-direction width Wx1 of each of the row electrodes X1 and the column-direction width Wy1 of each of the row electrodes Y1 are each set at 150 μm or less, and the xenon partial pressure in the discharge gas of the total pressure of 66.7 kPa (500 Torr) filling the discharge space is set at 6.67 kPa (50 Torr) or more. This setting enables the achievement of a high luminous efficiency when a sustaining discharge as described above is initiated for the image generation.

The reasons for this are the same as those described in the first embodiment example on the basis of FIGS. 4 to 6.

Next, a description will be given of the relationshipbetween the relationship between a discharged current and a relative dielectric constant, and a relative dielectric constant of the dielectric layer 72 provided in the PDP 140 which a narrow-depth-range discharge is produced and a discharge gas with a high xenon partial pressure is used as described above.

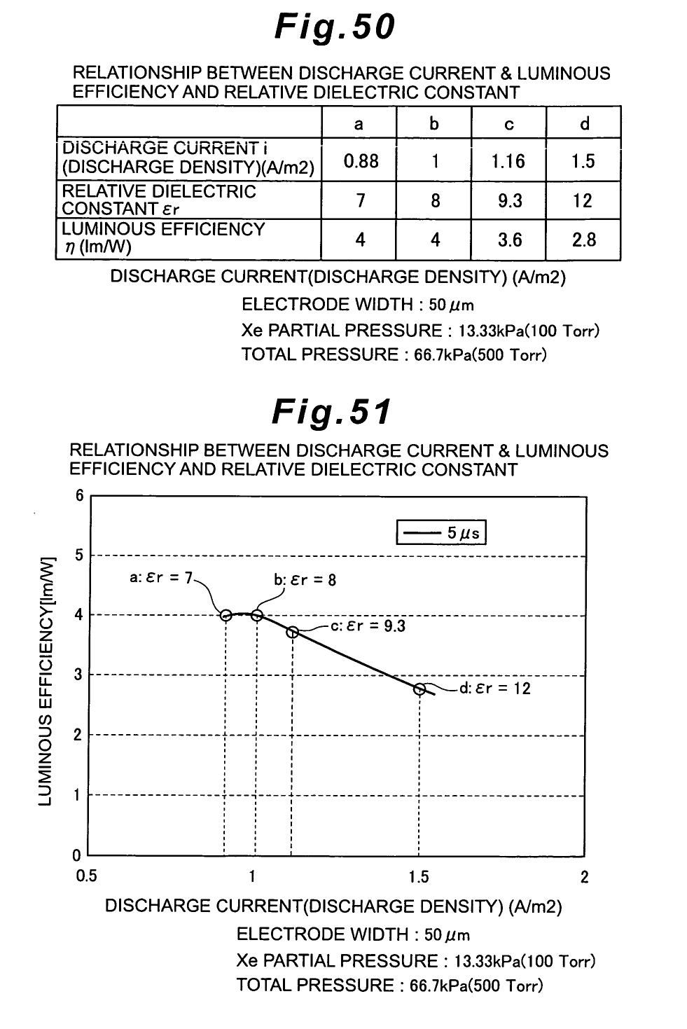

FIG. 50 is a table showing the relationship between the discharged current (current density) plus luminous efficiency and the relative dielectric constant of a dielectric layer overlying the row electrode pairs, in a PDP in which an electrode width is set at 50 μm, and the xenon partial pressure in a discharge gas of a total pressure of 66.7 Kpa (500 Torr) is set at 13.33 kPa (100 Torr) and a narrow-depth-range discharge is produced. FIG. 51 is a graph representing the table in FIG. 50.

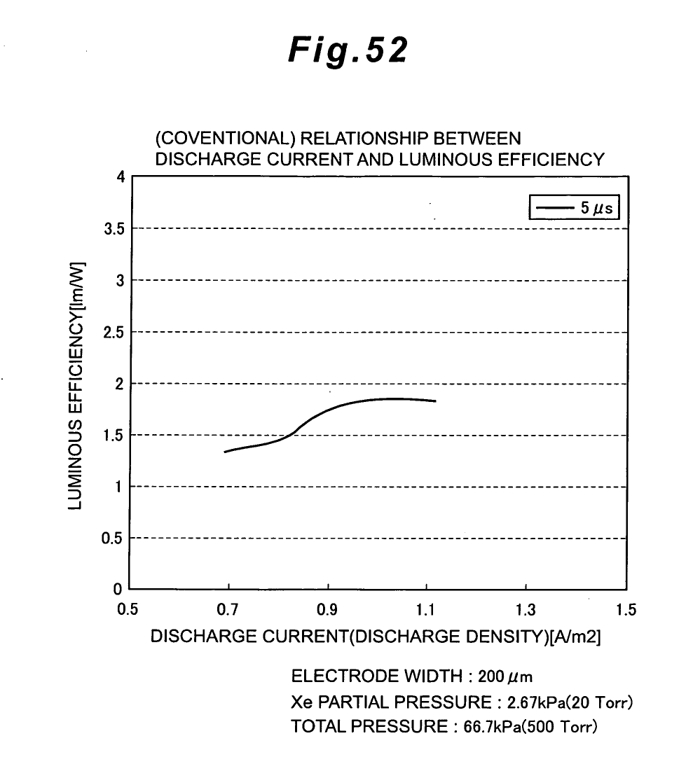

FIG. 52 is a graph showing the relationship between the discharged current (current density) and the luminous efficiency in a conventional PDP which has an electrode width of 200 μm and uses a discharge gas of a total pressure of 66.7 kPa (500 Torr) with the xenon partial pressure set at 2.67 kPa (20 Torr).

In FIGS. 50 to 52, the measurements have been carried out with the sustaining pulse period set at 5 μsec. In the table and graph here shown, “i” represents the discharged current (current density) and “η” represents the luminous efficiency.

The relationship between the discharged current (current density) when the sustaining discharge is initiated and the relative dielectric constant of a dielectric layer overlying the row electrode pairs in a PDP is that the greater the relative dielectric constant of the dielectric layer, the greater the discharged current becomes. In the conventional PDP shown in FIG. 52, as the discharged current increases, the luminous efficiency increases.

By contrast, in the PDP shown in FIG. 51 in which a narrow-depth-range discharge is produced and a discharge gas with a high xenon partial pressure is used, the relative dielectric constant of the dielectric layer overlying the row electrode pair becomes small, and as the discharged current decreases, the luminous efficiency increases. When the discharged current reaches 1.0 A/m² or less, the luminous efficiency is kept steady at approximately 41 m/W.

Such a phenomenon in which the luminous efficiency increases with the reduction in the discharged current occurs in a PDP in which a narrow-depth-range discharge is produced and a discharge gas with a high xenon partial pressure is used, and it does not occur in the conventional PDPs as described earlier.

Typically, in a PDP, the maximum luminous efficiency and the effective luminous efficiency are desirably approximately equal to each other, and, preferably, the effective luminous efficiency has at least a value equal to or greater than 90 percent of the maximum luminous efficiency.

Accordingly, as shown in FIGS. 50, 51, in the PDP 140, in order to obtain a value equal to or greater than 90 percent of the maximum luminous efficiency of 41 m/W, that is, an effective luminous efficiency of 3.61 m/W or more, the discharged current (current density) is set at 1.16 A/m² or less, so that the relative dielectric constant of the dielectric layer 72 is set at 9.3 or less.

In the PDP 140, in order for the effective luminous efficiency to be approximately equal to the maximum luminous efficiency of 41 m/W, the discharged current (current density) is required to be set at 1 A/m²or less. For this purpose, the relative dielectric constant of the dielectric layer 72 is desirably set at 8 or less.

A description will be given below of the reasons why, in a PDP in which a narrow-depth-range discharge is produced and a discharge gas with a high xenon partial pressure is used, the luminous efficiency increases with the decrease in the discharged current (current density) and the relative dielectric constant of the dielectric layer overlying the row electrode pairs.

If the relative dielectric constant of the dielectric layer overlying the row electrode pairs is increased, the discharged current (current density) increases, which in turn increase the amount of ionization when the sustaining discharge is initiated between the row electrodes. This results in an increase in the probability that electrons produced by the ionization collide with xenon atoms in an excited state which leads to the initiation of vacuum ultraviolet emission, and deactivate the excited xenon atom.

In particular, in a PDP, such as the PDP 140, in which a narrow-depth-range discharge is initiated and a discharge gas with a high xenon partial pressure is used, an increase in the discharged current (current density) induces the deactivation of the excited xenon atoms, resulting in a decrease in the efficiency of generating vacuum ultraviolet light. In turn, the decrease in the quantity of vacuum ultraviolet light applied to the phosphor layer results in a decrease in the luminous efficiency.

For this reason, it is deemed that, in a PDP in which a narrow-depth-range discharge is produced and a discharge gas with a high xenon partial pressure is used, a reduction in the discharged current is necessary in order to achieve an increase in the luminous efficiency.

As described above, in the PDP 140, each of the electrode widths Wx1, Wy1 of the row electrodes X1, Y1 is set at 150 μm or less, and the xenon partial pressure in the discharge gas is set at 6.67 kPa (50 Torr) or more, and also the relative dielectric constant of the dielectric layer 72 overlying the row electrode pairs (X1, Y1) is set at 9.3 or less, desirably, 8 or less. In this way, the amount of ionization in the sustaining discharge is held down so as to decrease the probability that electrons produced by the ionization collide with xenon atoms in an excited state which leads to the initiation of vacuum ultraviolet emission, and deactivate the excited xenon atoms. This produces an improvement in the generation of the vacuum ultraviolet light, which in turn increases the quantity of vacuum ultraviolet light applied to the phosphor layer, resulting in the improvement of the luminous efficiency.

Further, the dielectric layer 72 of the PDP 140 is formed of a low dielectric material with a relative dielectric constant of 9.3 or less. Thus, as compared with the conventional PDPs having a dielectric layer formed of a dielectric material with a larger relative dielectric constant than that of the dielectric layer 72, the electrostatic capacity arising between the row electrodes X1 and Y1 and between the row electrode Y1 and the column electrode D1 is reduced, leading to a reduction in the amount of reactive current in the PDP 140.

In a PDP using a discharge gas with a high xenon partial pressure, a rise in the drive voltage leads to an increase in the discharged current. However, in the PDP 140, even though the xenon partial pressure in a discharge gas is set at 6.67 kPa (50 Torr) or more, the discharged current is reduced because of the dielectric layer 72 formed of a low dielectric material with a relative dielectric constant of 9.3 or less. In consequence, a reduction in the luminous efficiency is prevented.

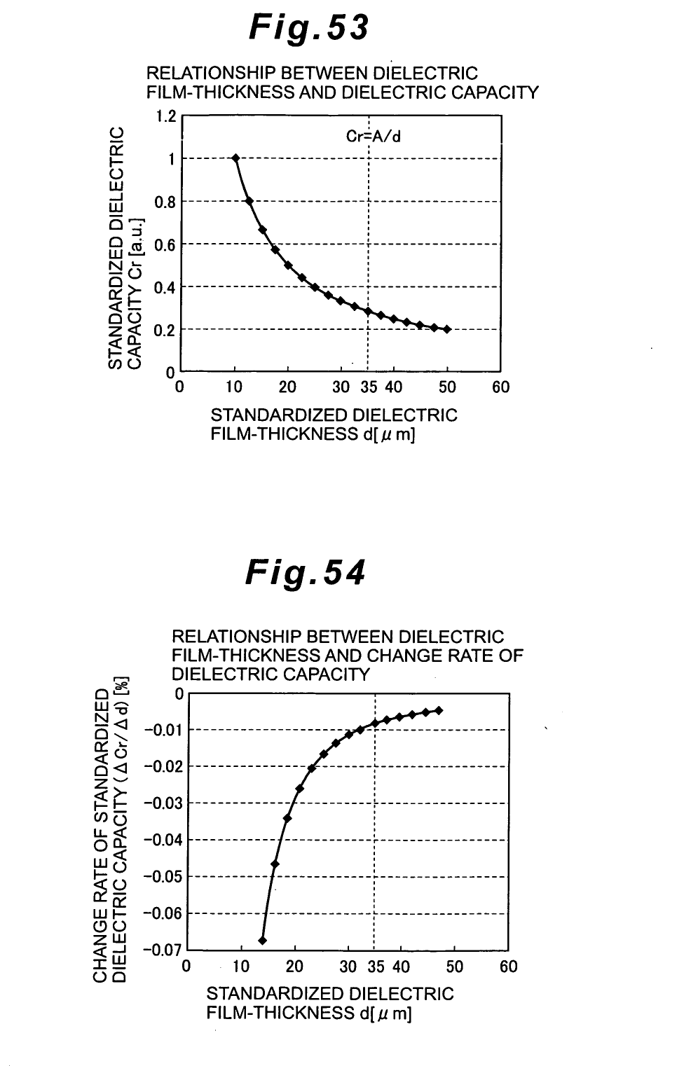

Next, the reason why the film-thickness of the dielectric layer 72 of the PDP 140 is set at 35 μm or more is described with reference to FIGS. 53, 54.

FIG. 53 is a graph showing the relationship between the standardized thickness of the dielectric film and the standardized dielectric capacity. FIG. 54 is a graph showing the rate of change (the gradient of the graph in FIG. 53 (differentiated values)) in the standardized dielectric capacity with respect to the standardized thickness of the dielectric film.

The standardized dielectric capacity Cr in FIGS. 53, 54 is obtained by the equation:
Cr=εr·ε₀ (S/d)
where εr is a relative dielectric constant, ε₀ is avacuum dielectric constant, S is the electrode area, and d is the dielectric film-thickness.

The dielectric capacity shown in FIGS. 53, 54 is calculated on the basis of the above equation where the film-thickness of a dielectric layer typically formed in a PDP is within the numerical value range of several tens of μm.

In the above equation, the standardized dielectric capacity Cr is inversely proportional only to the dielectric film-thickness, and decreases with an increase in the dielectric film-thickness as shown in FIGS. 53, 54.

As seen from FIGS. 53, 54, when the dielectric film-thickness is smaller than 35 μm, the rate of decrease in the dielectric capacity with an increase in the dielectric film-thickness is high.

On the other hand, when the dielectric film-thickness is 35 μm or more, the rate of decrease in the dielectric capacity with an increase in the dielectric film-thickness is lower than that in the case where the dielectric film-thickness is smaller than 35 μm.

As described earlier, a PDP has a correlation between the discharged current and the luminous efficiency. Therefore, in a PDP in which a narrow-depth-range discharge is produced and a discharge gas with a high xenon partial pressure is used, a smaller value of the discharged current brings an increase in the luminous efficiency.

For this reason, if the discharged current varies from discharge cell to discharge cell, the luminous efficiency disadvantageously varies from discharge cell to discharge cell.

The discharged current is changed by the dielectric capacity of the dielectric layer. The dielectric capacity is changed by the dielectric film-thickness as described earlier.

The formation of a dielectric layer having a uniform thickness in all the discharge cells is difficult in the manufacturing process of the PDP, and inevitably some variation in the thickness of the dielectric layer results.

As described earlier, when the thickness of the dielectric layer is 35 μm or more, a small rate of change in dielectric capacity with respect to the change in film-thickness is shown as compared with the case of a film-thickness of less than 35 μm. Therefore, the dielectric layer is deposited so as to have a thickness of 35 μm or more, thus decreasing the variations in the discharged current which are caused by the variations of the discharge cell-to-discharge cell film-thickness. This in turn causes the variations in the discharge cell-to-discharge cell luminous efficiency-to be held down at a lower level than that of the conventional PDPs, thus making it possible to manufacture a PDP capable of exhibiting a steady luminous efficiency throughout the entire surface of the panel.

The foregoing advantageous effects can also be exerted in a PDP having a stripe-shaped partition wall unit. In the PDP 140, the partition wall unit 15 is formed in an approximate grid shape, which thus allows for the provision of the phosphor layer 16 on the four side faces of the transverse walls 15A and vertical walls 15B surrounding each discharge cell C1 so as to increase the surface area of the phosphor layer 16, resulting in the achievement of an even higher luminous efficiency.

The column-direction width of the row electrodes X1, Y1 of the PDP 140 is significantly smaller than that of the conventional PDPs, which thus massively reduces the electrostatic capacity arising between the electrodes. In consequence, the amount of reactive current is reduced, thus making it possible to reduce the electrical power consumption. Also, by forming the recess 12A in the portion of the dielectric layer 12 in positional correspondence with the discharge gap g1, the electrostatic capacity arising between the electrodes is reduced, thereby achieving a reduction in the amount of reactive current, which leads to a reduction in the electrical power consumption.

The foregoing describes the example of the row electrode pair (X1, Y1) of the PDP 140 being placed facing a column-direction central portion of each discharge cell C1. However, the row electrode pair (X1, Y1) may be placed in any position higher or lower (in FIG. 48) than the column-direction central portion in each discharge cell C1.

This is for the following reasons.

In the conventional PDPs, the sustaining discharge results in a wide-range discharge expanding throughout a discharge cell as described earlier. In this case, if the row electrode pair is placed in a position higher or lower than the column-direction central position of each of the discharge cells which are defined by a grid-shaped partition wall unit, the discharge gap is located closer to the upper or lower transverse wall of the partition wall unit defining each discharge cell. As a result, variations in voltage margin, brightness, luminous efficiency and the like occur from discharge cell to discharge cell, and those then adversely affect light emission. To avoid this problem, a high precision of positioning of the row electrode pair in each discharge cell is required.

However, in the PDP 140, the sustaining discharge results in a narrow-depth-range discharge with a narrow discharge area as described earlier, and the area in which vacuum ultraviolet light is produced is a so-called point light source which is smaller than that of the conventional PDPs. Thus, the vacuum ultraviolet light is not easily affected by the partition wall unit, which involves such things as wall loss. Also, the phosphor layer 16 is excited by use of a 172 nm-wavelength molecular beam, which is not much absorbed, in the vacuum ultraviolet light. This reduces the effects caused by the variations in distance between the phosphor layer 16 and the discharge area (the area in which the vacuum ultraviolet light is produced) of the sustaining discharge. In consequence, even if the position of the row electrode pair (X1, Y1) in each discharge cell C1 in the column direction is away from the central position of the discharge cell C1, the brightness and luminous efficiency seldom vary.

Accordingly, with the PDP 140, even when each of the discharge cells C1 is surrounded by the transverse walls 15A and the vertical walls 15B of the approximately grid-shaped partition wall unit 15, the position of the discharge gap (i.e. the position of the row electrode pair) need not be precisely aligned with the column-direction central position of the discharge cell, resulting in an increase in tolerance in the precision of positioning of the row electrode pair (X1, Y1) in each discharge cell C1. This makes it possible to enhance the product yield in the manufacturing process and to contribute to a reduction in manufacturing costs.

The foregoing describes the example of a transparent electrode constituting part of the row electrode being formed in a belt shape continuously extending between adjacent discharge cells along the bus electrode. However, a transparent electrode may be formed independently in each discharge cell and connected to the bus electrode.

The foregoing describes the example of a row electrode made up of a transparent electrode and a bus electrode. However, the row electrode may be made up of a metal-made bus electrode alone and have a width of 150 μm or less in the column direction.

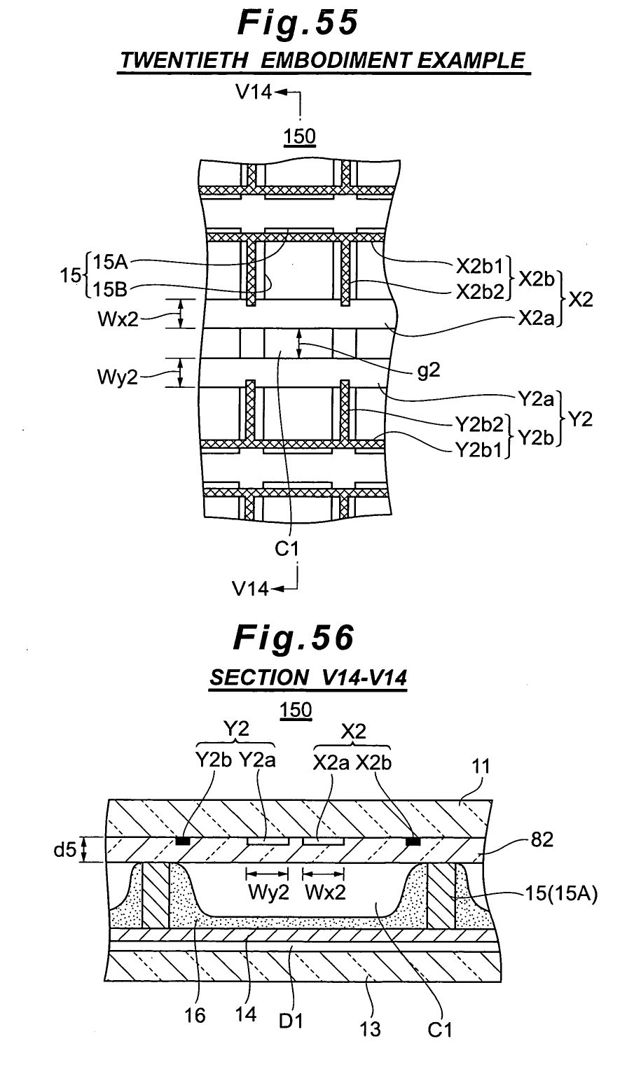

Twentieth Embodiment Example FIGS. 55, 56 illustrate a twentieth embodiment example of a PDP according to the present invention. FIG. 55 is a schematic front view illustrating part of the PDP of the twentieth embodiment example. FIG. 56 is a sectional view taken along the V14-V14 line in FIG. 55.

In FIGS. 55, 56, the same components as those in the PDP in the second embodiment example are indicated with the same reference numerals as those in FIG. 7.

In the nineteenth embodiment example, the bus electrode of each of the row electrodes making up the row electrode pair of the PDP is disposed in an approximately central portion of the rear-facing face of the transparent electrode. By contrast, in the PDP 150 of the twentieth embodiment example, row electrodes X2, Y2 constituting each of the row electrode pairs (X2, Y2) are each made up of transparent electrodes X2a, Y2a and bus electrodes X2b, Y2b. The transparent electrodes X2a, Y2a are placed facing the column-direction central portion of each discharge cell C1 defined by an approximately-grid-shaped partition wall unit 15. The bus electrodes X2b, Y2b are placed close to the respective transverse walls 15A defining the two opposing sides of the discharge cell C1, and are connected to the respective transparent electrodes X2a, Y2a.

In FIGS. 55, 56, the discharge space of the PDP 150 is partitioned into approximately quadrate areas by the partition wall unit 15 which is of an approximate grid shape made up of transverse walls 15A and vertical walls 15B to form the discharge cells C1, as in the case of the nineteenth embodiment example.

The belt-shaped transparent electrodes X2a, Y2a of the respective row electrodes X2, Y2 constituting the row electrode pair (X2, Y2) are spaced at a required interval (discharge gap g2) and extend parallel to each other in the row direction in correspondence to the column-direction central portion of each discharge cell C1.

The transparent electrodes X2a, Y2a each have a column-direction width (Wx2, Wy2) set at 150 μm or less.

The bus electrodes X2b, Y2b are each made up of bus-electrode bodies X2b1, Y2b1 and bus-electrode connecting portions X2b2, Y2b2. Each of the bus-electrode bodies X2b1, Y2b1 extends in a belt shape in the row direction along the inner edge of the transverse wall 15A of the partition wall unit 15. The bus-electrode connecting portions X2b2, Y2b2 each extend in the column direction between the bus-electrode bodies X2b1, Y2b1 and the transparent electrodes X2a, Y2a in parallel to the vertical wall 15B of the partition wall unit 15 for the connection between the bus-electrode bodies X2b1, Y2b1 and the transparent electrodes X2a, Y2a.

A dielectric layer 82 overlying the row electrode pairs (X2, Y2) is formed of a low dielectric material with a relative dielectric constant of 9.3 or less, desirably, 8 or less, such as zinc oxide (ZnO) glass, a mixture of ZnO glass and phosphorus oxide (P₂O₅) s and the like. The dielectric layer 82 is deposited such that the film-thickness d5 in the vertical direction with respect to the front glass substrate 11 reaches 35 μm or more.

The rest of the structure in the twentieth embodiment example is similar to that in the nineteenth embodiment example. The xenon partial pressure in the discharge gas of the total pressure of 66.7 kPa (500 Torr) filling the discharge gas is set at 6.67 kPa or more (50 Torr or more).

In the nineteenth embodiment example, the bus electrode formed of a metal film is disposed facing the central portion of the discharge cell. Therefore, the opening of the discharge cell is divided into two in the column direction by the bus electrodes that do not have light transmission properties. By contrast, in the PDP 150, the bus-electrode bodies X2b1, Y2b1 of the bus electrodes X2b, Y2b formed of a metal film are placed close to the transverse walls 15A of the partition wall 15. In this way, the opening of the discharge cell C1 is not divided into two by the bus electrodes X2b, Y2b as is done in the nineteenth embodiment example.

The characteristics of the twentieth embodiment example are that the intensity of the light emission increases gradually toward the discharge gap and decreases gradually toward the transverse walls. With this structure, the portion in the discharge cell with a high intensity of light emission is not obstructed by the bus electrode, resulting in the achievement of a higher luminous efficiency.

In the PDP 150, further, because the bus-electrode connecting portions X2b2, Y2b2 are placed facing the transverse walls 15B of the nartition wall unit 15, part of the opening of the discharge cell C1 is not blocked by the formation of the bus-electrode connecting portions X2b2, Y2b2.

The foregoing describes the example of the bus-electrode bodies X2b1, Y2b1 of the bus electrodes X2b, Y2b being placed close to the transverse walls 15A of the partition wall unit 15 and facing the discharge cell C1. However, the bus-electrode bodies X2b1, Y2b1 may be placed facing the transverse walls 15A of the partition wall unit 15. In this case, the bus-electrode bodies X2b1, Y2b1 do not block the opening of the discharge cell C1, thus eliminating the risk of the entire area of the bus electrodes X2b, Y2b becoming obstacles to light emission from the phosphor layer.

In the PDP 150, the column-direction width (electrode width) Wx2 of the transparent electrode X2a of the row electrode X2 and the column-direction width (electrode width) Wy2 of the transparent electrode Y2a of the row electrode Y2 are each set at 150 μm or less. With this setting, as in the case of the nineteenth embodiment example, the sustaining discharge initiated between the transparent electrodes X2a and Y2a results in a narrow-depth-range discharge. In consequence, the vacuum ultraviolet light is generated at a very high efficiency as compared with the conventional PDPs. Also, by setting the xenon partial pressure in the discharge gas filling the discharge space at 6.67 kPa (50 Torr) or more, the phosphor layer 16 is excited mainly by the 172 nm-wavelength molecular beam, which is seldom attenuated, in the vacuum ultraviolet light generated from the xenon in the discharge gas, resulting in achievement of an increase in luminous efficiency as compared with the conventional PDPs.

As in the case of the nineteenth embodiment example, the dielectric layer 82 overlying the row electrode pairs (X2, Y2) in the PDP 150 is formed of a low dielectric material with a relative dielectric constant of 9.3 or less. In consequence, in a PDP in which a narrow-depth-range discharge is produced and a discharge gas with a high xenon partial pressure is used, the amount of ionization in the sustaining discharge is held down, which gives rise to an improvement in the efficiency of generating the vacuum ultraviolet light, which in turn increases the quantity of vacuum ultraviolet light applied to the phosphor layer, resulting in an enhancement in the luminous efficiency. Also, the setting of the film-thickness of the dielectric layer 82 at 35 μm or more effects a decrease in variations in discharged current caused by the variations in the film-thickness d5 of the dielectric layer 82 from discharge cell C1 to discharge cell C1. In consequence, the discharge cell-to-discharge cell variations in luminous efficiency are decreased as compared with the case of the conventional PDPs. This means the achievement of the manufacture of a PDP capable of exhibiting steady luminous efficiency throughout the entire surface of the panel.

The foregoing advantageous effects can also be exerted in a PDP having a stripe-shaped partition wall unit. In the PDP 150, the partition wall unit 15 is formed in an approximate grid shape, which thus allows for the provision of the phosphor layer on the four side faces of the transverse walls 15A and vertical walls 15B surrounding each discharge cell C1 so as to increase the surface area of the phosphor layer, resulting in a further improvement of the luminous efficiency.

The column-direction width of each of the transparent electrodes X2a, Y2a of the row electrodes X2, Y2 of the PDP 150 is significantly smaller than that of the conventional PDPs. This means that the electrostatic capacity arising between the electrodes is massively reduced. In consequence, the amount of reactive current is reduced, thus making it possible to reduce the electrical power consumption.

The row electrode pair (X2, Y2) of the PDP 150 may be placed in any position higher or lower (in FIG. 55) than the central portion of each discharge cell C1 in the column direction for the same reasons as those described in the nineteenth embodiment example. In consequence, the tolerance in the precision of positioning of the row electrode pair (X2, Y2) in each discharge cell C1 is increased. Accordingly, it is possible to contribute to a reduction in manufacturing costs because of the enhancement of the product yield in the manufacturing process.

The foregoing describes the example of a transparent electrode constituting part of the row electrode being formed in a belt shape continuously extending between adjacent discharge cells along the bus electrode. However, a transparent electrode may be formed independently in each discharge cell and connected to the bus electrode.

Twenty-first Embodiment Example

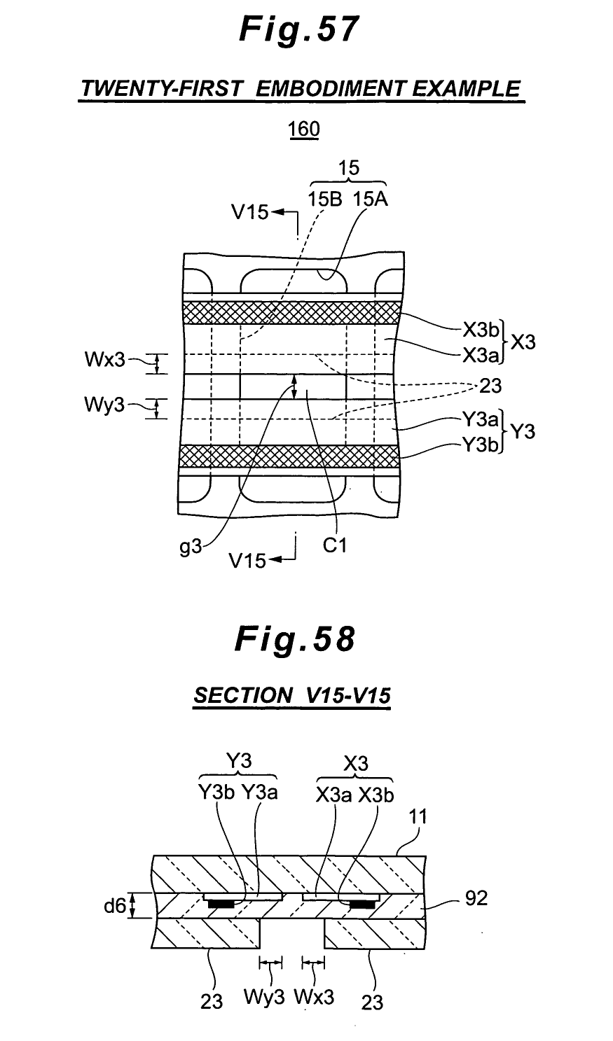

FIGS. 57, 58 illustrate a twenty-first embodiment example according to the present invention. FIG. 57 is a schematic front view showing part of the PDP of the twenty-first embodiment example. FIG. 5R is a sectional view taken alone the V15-V15 line in FIG. 57.

In FIGS. 57, 58, the same components as those in the third embodiment example are indicated with the same reference numerals as those in FIGS. 8, 9.

In the case of the PDP of the nineteenth embodiment example, the column-direction width of the transparent electrode of each row electrode is changed in order for the sustaining discharge to develop as a narrow-range discharge. By contrast, in the PDP 160 of the twenty-first embodiment example, row electrode pairs (X3, Y3) each similar in size to those of the conventional PDPs (see FIG. 1) are arranged facing the discharge cells C1 defined by a partition wall unit 15 of an approximate grid shape. Second dielectric layers 23 are formed on the required portions of the rear-facing face, which faces the discharge space, of a first dielectric layer 92 covering the row electrode pairs (X3, Y3), in such a manner as to reduce the column-electrode width of each of the portions of the row electrodes X3, Y3 across which a discharge is substantially initiated in each discharge cell C1. In this way, the sustaining discharge develops as a narrow-depth-range discharge.

Specifically, transparent electrodes X3a, Y3a are provided on the rear-facing face of a front glass substrate 11 of the PDP 160. The transparent electrodes X3a, Y3a are each formed in a belt shape of a similar column-direction width, e.g. 400 μm to 1000 μm, to that of the conventional PDP illustrated in FIG. 1. The transparent electrodes X3a, Y3a are spaced at a required interval (discharge gap g3) and extend parallel to each other in the row direction. Bus electrodes X3b, Y3b of a belt shape extending in the row direction are formed on the respective outer sides (away from the leading sides facing each other across the discharge gap g3) of the rear-facing faces of the transparent electrodes X3a, Y3a, and are connected to the respective transparent electrodes X3a, Y3a.

The row electrode pairs (X3, Y3) are over laid with the first dielectric layer 92 formed on the rear-facing face of the front glass substrate 11.

The dielectric layer 92 is formed of a low dielectric material with a relative dielectric constant of 9.3 or less, desirably, 8 or less, such as zinc oxide (ZnO) glass, a mixture of ZnO glass and phosphorus oxide (P₂O₅) glass, and the like. The dielectric layer 92 is deposited such that the film-thickness d6 in the vertical direction with respect to the front glass substrate 11 reaches 35 μm or more.

The second dielectric layers 23 are laid, as described below, on the required portions of the rear-facing face of the first dielectric layer 92.

A secondary electron emission layer (not shown) is in turn formed so as to fully overlie the first dielectric layer 92 and second dielectric layers 23.

The second dielectric layers 23 are formed on the portions of the rear-facing face of the first dielectric layer 92 other than the belt-shaped portions which each extend in the row direction in positional correspondence with the discharge gap g3, and with the leading-side portions, which have a column-direction widths Wx3, Wy3 of 150 μm or less and face each other across the discharge g3, of the transparent electrodes X3a, Y3a of the row electrodes X3, Y3.

The first dielectric layer 92 overlying the row electrode pairs (X3, Y3) is formed to have a film-thickness d6 of 35 μm or more in the vertical direction with respect to the front glass substrate 11. The film-thickness of each of the second dielectric layers 23 is greater than that of the first dielectric layer 92, such that the lamination of the first dielectric layer 92 and second dielectric layer 23 has a film-thickness set to exceed twice the film-thickness of the first dielectric layer 92 and make a wall charge seldom accumulate during a discharge.

The discharge space is filled with a discharge gas at a total pressure of 66.7 kPa (500 Torr) with a xenon partial pressure of 6.67 kPa (50 Torr) or more.

Each of the row electrodes X3, Y3 of each row electrode pair (X3, Y3) of the PDP 160 has a column-direction width approximately equal to that of the conventional PDPs. Each of the portions of the respective transparent electrodes X3a, Y3a of the row electrodes X3, Y3, other than the leading-side portions of the column-direction widths Wx3, Wy3 facing each other across the discharge gap g3, is covered with the double dielectric layer made up of the laminated first and second dielectric layers 92, 23. Thus, the dielectric layer overlying these portions other than the leading-side portions of the column-direction width Wx3, Wy3 has a greater thickness than that of the dielectric layer overlying the leading-side portions. As a result, the wall charge seldom accumulates on the thicker portion of the second dielectric layer 23 formed on the first dielectric layer 92, and accumulates on the surface of the first dielectric layer 92 overlying the leading-side portions of the column-direction widths Wx3, Wy3 of the transparent electrodes X3a, Y3a.

In this way, in the PDP 160, when a sustaining pulse is applied to the row electrode pair (X3, Y3) so as to initiate a sustaining discharge across the discharge gap g3 between the transparent electrodes X3a, Y3a, almost all of the sustaining discharge develops only on the leading-side portions of the column-direction widths Wx3, Wy3 of the transparent electrodes X3a, Y3a, resulting in the formation of a narrow-depth-range discharge as described in the first embodiment example.

With the PDP 160 designed as described above, as in the case of the nineteenth embodiment example, a sustaining discharge develops as a narrow-depth-range discharge. This means that vacuum ultraviolet light is generated at a very high efficiency as compared with the conventional PDPs. Also, the xenon partial pressure in the discharge gas of a total pressure 66.7 kPa (500 Torr) filling the discharge space is set at 6.67 kPa (50 Torr) or more. In this way, the phosphor layer is excited mainly by a 172 nm-wavelength molecular beam, which is seldom attenuated, in the vacuum ultraviolet light generated from the xenon in the discharge gas. This results in the achievement of an increase in luminous efficiency as compared with the conventional PDPs.

As in the case of the nineteenth embodiment example, the first dielectric layer 92 overlying the row electrode pairs (X3, Y3) in the PDP 160 is formed of a low dielectric material with a relative dielectric constant of 9.3 or less. In consequence, in a PDP in which a narrow-depth-range discharge is produced and a discharge gas with a high xenon partial pressure is used, the amount of ionization in the sustaining discharge is held down, which gives rise to an improvement in the efficiency of generating the vacuum ultraviolet light, which in turn increases the quantity of vacuum ultraviolet light applied to the phosphor layer, resulting in an enhancement in the luminous efficiency. Also, the setting of the film-thickness d6 of the first dielectric layer 92 at 35 μm or more effects a decrease in variations in discharged current caused by the variations in the film-thickness d6 of the first dielectric layer 92 from discharge cell C1 to discharge cell C1. In consequence, the discharge cell-to-discharge cell variations in luminous efficiency are decreased as compared with the case of the conventional PDPs. This means the achievement of the manufacture of a PDP capable of exhibiting steady luminous efficiency throughout the entire surface of the panel.

The row electrode pair (X3, Y3) of the PDP 160 may be placed in any position higher or lower (in FIG. 57) than the column-direction central position of each discharge cell C1 for the same reasons as those described in the nineteenth embodiment example. In consequence, the tolerance in the precision of positioning of the row electrode pair (X3, Y3) in each discharge cell C1 is increased. Accordingly, it is possible to contribute to a reduction in manufacturing costs because of the enhancement of the product yield in the manufacturing process.

In addition to similar advantageous effects to those in the nineteenth embodiment example, because the column-direction width of the transparent electrodes X3a, Y3a of the PDP 160 has a similar size to those in the conventional PDPs, and the bus electrodes X3b, Y3b are placed at a distance from the discharge gap g3, the effect of the metal-film-formed bus electrodes X3b, Y3b on light emission from the phosphor layer is reduced, resulting in enhancement of the efficiency of the extraction of visible light.

The characteristics of the twenty-first embodiment example are that the intensity of the light emission increases gradually toward the discharge gap and decreases gradually toward the transverse walls. With this structure, the portion in the discharge cell with a high intensity of light emission is not obstructed by the bus electrode, resulting in the achievement of a higher luminous efficiency.

The design of the PDP 160 enables a simplification of the structure for reducing the effect of the bus electrode on the light emission from the phosphor layer as compared with the case of the PDP of the twentieth embodiment example.

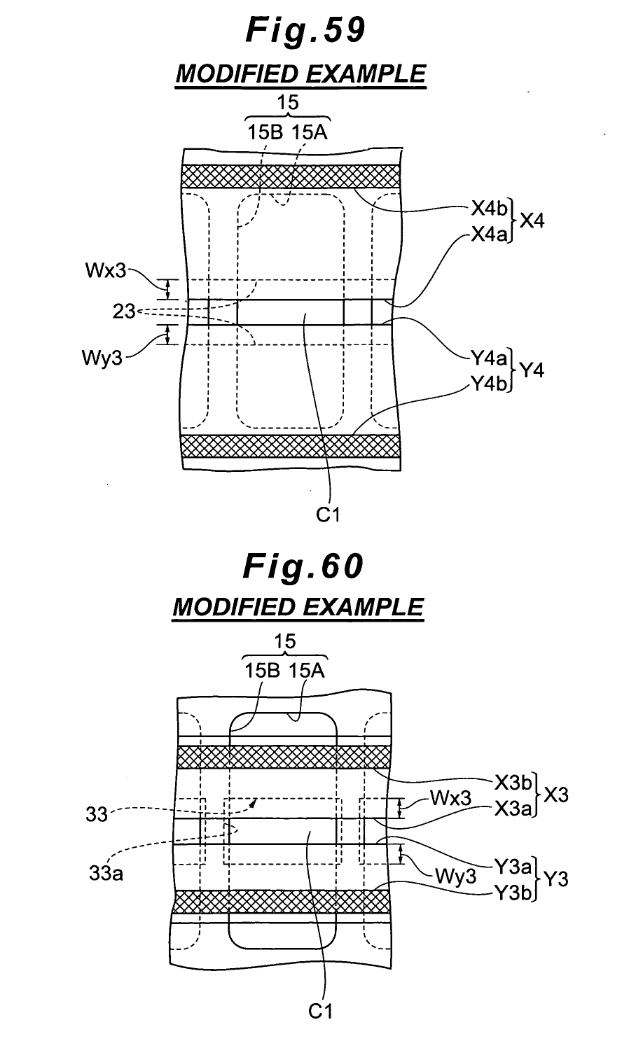

For example, FIGS. 57, 58 show the example of the bus electrodes X3b, Y3b being placed facing the opening of the discharge cell C1, but, as illustrated in FIG. 59, bus electrodes X4b, Y4b of the respective row electrodes X4, Y4 constituting a row electrode pair (X4, Y4) may be placed away from the opening of the discharge cell C1. This placement eliminates the effect of the bus electrodes X4b, Y4b on the light emission from the phosphor layer, leading to the achievement of a massive increase in the efficiency of the extraction of visible light.

Since the structure of the row electrode pair (X3, Y3) of the PDP 160 is similar to the conventional structure, an extensive change in the manufacturing process is unnecessary. Further, can be freely determined, the degree of flexibility in design and manufacturing is increased. Accordingly, it is possible to reduce the manufacturing costs and contribute to product yield.

The foregoing describes the example of the transparent electrode, which makes up part of the row electrode, being formed in a belt shape continuously extending between adjacent discharge cells along the associated bus electrode. However, a transparent electrode may be formed independently in each discharge cell and connected to the associated bus electrode.

The foregoing describes the example of the second dielectric layers each extending in a belt shape in the row direction. However, the second dielectric layers placed on the first dielectric layer may consist of a second dielectric layer 33 as illustrated in FIG. 60 which may be formed in an approximate grid shape having quadrate openings 33a aligned with the respective openings of the discharge cells C1. By use of the openings 33a, the film-thickness of the dielectric layer overlying the portions other than the leading-side portions of the column-direction widths Wx3, Wy3 of the respective transparent electrodes X3a, Y3a and the discharge gap g3 between them may be set such that a wall charge is not accumulated thereon.

Twenty-second Embodiment Example

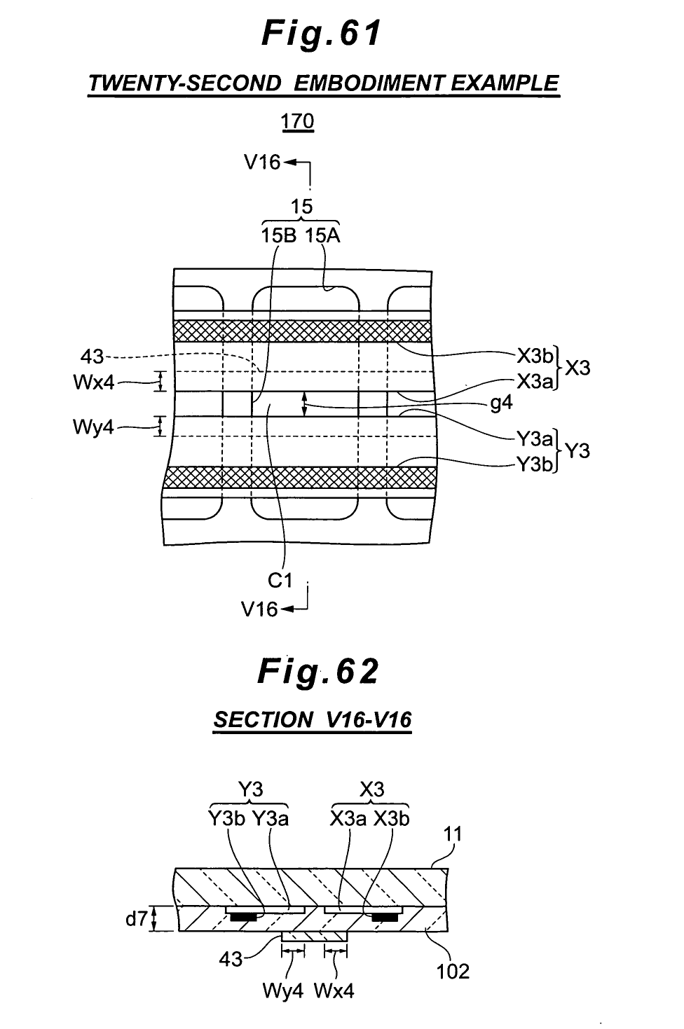

FIGS. 61, 62 illustrate a twenty-second embodiment example according to the present invention. FIG. 61 is a schematic front view showing part of the PDP of the twenty-second embodiment example. FIG. 62 is a sectional view taken along the V16-V16 line in FIG. 61.

In FIGS. 61, 62, the same components as those in the fourth embodiment example are indicated with the same reference numerals as those in FIGS. 12, 13.

In the PDP of the twenty-first embodiment example, a narrow-range discharge is produced by using the second dielectric layer, which is deposited on the first dielectric layer overlying the row electrode pairs, to limit the discharge range of the sustaining discharge. By contrast, in the PDP 170 of the twenty-second embodiment example, row electrode pairs (X3, Y3) each having a similar size to that of the conventional PDPs (see FIG. 1) are arranged facing the discharge cells C1 defined by a partition wall unit 15 of an approximate grid shape. Secondary electron emission layers 43, which are formed of a high γ material such as MgO, are formed in a belt shape extending in the row direction only on the required portions of the rear-facing face, which faces the discharge space, of a dielectric layer 102 which is provided for covering the row electrode pairs (X3, Y3). A sustaining discharge initiated between the transparent electrodes X3a, Y3a develops as a narrow-depth-range discharge due to the secondary electron emission layer 43.

Specifically, the transparent electrodes X3a, Y3a are provided on the rear-facing face of the front glass substrate 11 of the PDP 170. The transparent electrodes X3a, Y3a are each formed in a belt shape of a similar column-direction width, e.g. 400 μm to 1000 μm, to that of the conventional PDP illustrated in FIG. 1. The transparent electrodes X3a, Y3a are spaced at a required interval (discharge gap g4) and extend parallel to each other in the row direction. The bus electrodes X3b, Y3b of a belt shape extending in the row direction are formed on the respective outer sides of the rear-facing faces of the transparent electrodes X3a, Y3a, and are connected to the respective transparent electrodes X3a, Y3a.

The row electrode pairs (X3, Y3) are cover with the dielectric layer 102 formed on the rear-facing face of the front glass substrate 11.

The dielectric layer 102 overlying the row electrodes (X3, Y3) is formed of a low dielectric material with a relative dielectric constant of 9.3 or less, desirably, 8 or less, such as zinc oxide (ZnO) glass, a mixture of ZnO glass and phosphorus oxide (P₂O₅) glass, and the like. The dielectric layer 102 is deposited such that the film-thickness d7 in the vertical direction with respect to the front glass substrate 11 reaches 35 μm or more.

The secondary electron emission layers 43 are in turn formed on the rear-facing face of the dielectric layer 102. Each of the secondary electron emission layers 43 is formed of a high γ material such as MgO and extends in a belt shape in the row direction in positional correspondence with the discharge gap g4 and the leading-side portions of the column-direction width Wx4, Wy4 of the respective transparent electrodes X3a, Y3a placed across the discharge gap g4.

An example of various methods of forming the secondary electron emission layers 43 is here described: a mask having openings made in positional correspondence with the secondary electron emission layers 43 is laid between the dielectric layer 102 and a material evaporation source of a high γ material, and then a high γ material vapor is generated from the material evaporation source and deposited on the portions of the dielectric layer 102 corresponding to the mask openings so as to form layers.

The column-direction widths Wx4, Wy4 of the portions of each of the secondary electron emission layers 43 facing the respective transparent electrodes X3a, Y3a are each set at 150 μm or less.

The xenon partial pressure in the discharge gas of a total pressure of 66.7 kPa (500 Torr) filling the discharge space is set at 6.67 kPa (50 Torr) or more.

The column-direction width of each of the row electrodes X3, Y3 of the row electrode pair (X3, Y3) of the PDP 170 has approximately the same size as that of the conventional PDPs. However, the PDP 170 has the secondary electron emission layers 43 formed of a high γ material and each placed only on the portion of the dielectric layer 102 corresponding to the discharge gap g4 and the leading-side portion of the column-direction width Wx4, Wy4 of the transparent electrodes X3a, Y3a across the discharge gap g4. As a result, almost all of the sustaining discharge initiated between the transparent electrodes X3a, Y3a develops within the area in which the secondary electron emission layer 43 is formed. This means that the sustaining discharge appears as a narrow-depth-range discharge as described in the first embodiment example.

As described above, the sustaining discharge develops as a narrow-depth-range discharge as in the case of the nineteenth embodiment example. Thus, in the PDP 170, the vacuum ultraviolet light is generated at a very high efficiency as compared with the conventional PDPs Also, by setting the xenon partial pressure in the discharge gas filling the discharge space at 6.67 kPa (50 Torr) or more, the phosphor layer is excited mainly by the 172 nm-wavelength molecular beam, which is seldom attenuated, in the vacuum ultraviolet light generated from the xenon in the discharge gas, resulting in the achievement of an increase in luminous efficiency as compared with the conventional PDPs.

As in the case of the nineteenth embodiment example, the dielectric layer 102 overlying the row electrode pairs (X3, Y3) in the PDP 170 is formed of a low dielectric material with a relative dielectric constant of 9.3 or less. This allows a PDP, in which a narrow-depth-range discharge is produced and a discharge gas with a high xenon partial pressure is used, to hold down the amount of ionization in the sustaining discharge. As a result, the efficiency of generating the vacuum ultraviolet light is improved, which means an increase in the quantity of vacuum ultraviolet light applied to the phosphor layer, leading to an enhancement in the luminous efficiency. Also, the setting of the film-thickness d7 of the dielectric layer 102 at 35 μm or more effects a decrease in variations in discharged current caused by the variations in the film-thickness of the dielectric layer 102 from discharge cell C1 to discharge cell C1. In consequence, the discharge cell-to-discharge cell variations in luminous efficiency are decreased as compared with the case of the conventional PDPs. This means the achievement of the manufacture of a PDP capable of exhibiting steady luminous efficiency throughout the entire surface of the panel.

The row electrodes (X3, Y3) of the PDP 170 may be placed in any position higher or lower (in FIG. 61) than the column-direction central position of each discharge cell C1 for the same reasons as those described in the nineteenth embodiment example. In consequence, the tolerance in the precision of positioning of the row electrode pair (X3, Y3) in each discharge cell C1 is increased. Accordingly, it is possible to contribute to a reduction in manufacturing costs because of the enhancement of the product yield in the manufacturing process.

In addition to similar advantageous effects to those in the nineteenth embodiment example, because the column-direction width of the transparent electrodes X3a, Y3a of the PDP 170 has a similar size to those in the conventional PDPs and the bus electrodes X3b, Y3b are placed at a distance from the discharge gap 94, the effect of the metal-film-formed bus electrodes X3b, Y3b on light emission from the phosphor layer is reduced in the PDP 170, resulting in enhancement of the efficiency of the extraction of visible light.

The characteristics of the twenty-second embodiment example are that the intensity of the light emission increases gradually toward the discharge gap and decreases gradually toward the transverse walls. With this structure, the portion in the discharge cell with a high intensity of light emission is not obstructed by the bus electrode, resulting in the achievement of a higher luminous efficiency.

The design of the PDP 170 enables simplification of the structure for reducing the effect of the bus electrode on the light emission from the phosphor layer as compared with the case of the PDP of the twentieth embodiment example.

With the structure of the PDP 170, the area of producing a narrow-depth-range discharge can be freely set by changing the size and/or the position of the secondary electron emission layers 43. In consequence, the degree of flexibility in design and manufacturing is increased, and thus the PDP 170 is flexibly adaptable to a modification in design and the like.

The foregoing describes the example of the secondary electron emission layer 43 being formed in a belt shape in the row direction. However, a secondary electron emission layer may be formed independently in a so-called island form in each discharge cell.

The foregoing describes the example of a transparent electrode constituting part of the row electrode being formed in a belt shape continuously extending between adjacent discharge cells along the bus electrode. However, a transparent electrode may be formed independently in each discharge cell and connected to the bus electrode.

The terms and description used herein are set forth by way of illustration only and are not meant as limitations. Those skilled in the art will recognize that numerous variations are possible within the spirit and scope of the invention as defined in the following claims.

What is claimed is:

1. A plasma display panel, comprising: a pair of first and second substrates placed parallel to each other across a discharge space; a plurality of row electrode pairs that are placed on the first substrate, each extend in a row direction, are regularly arranged in a column direction, and are each constituted of row electrodes paired with and facing each other across a discharge gap; a dielectric layer that is formed on the first substrate and covers the row electrode pairs; and a plurality of column electrodes that are placed on the second substrate, each extend in the column direction and are regularly arranged in the row direction, wherein
unit light emission areas are respectively formed in portions of the discharge space corresponding to intersections of the column electrodes and the row electrode pairs,
the discharge space is filled with a discharge gas that includes xenon,
portions of the respective row electrodes paired with each other and constituting each of the row electrode pairs, which are involved in a discharge initiated across the discharge gap, each have a width set at 150 μm or less in a transverse direction with respect to a longitudinal direction of the row electrode, and
the xenon included in the discharge gas has a partial pressure set at 6.67 kPa or more.

2. A plasma display panel according to claim 1, wherein each of the portions of the row electrodes which are involved in a discharge has a column-direction width set at 150 μm or less.

3. A plasma display panel according to claim 2, wherein each of the row electrodes has a column-direction width set at 150 μm or less.

4. A plasma display panel according to claim 3, wherein each of the row electrodes constituting each of the row electrode pairs comprises a transparent electrode that has a required column-direction width and faces the counterpart row electrode in the row electrode pair across the discharge gap, and a metallic bus electrode that has a column-direction width smaller than that of the transparent electrode, extends in a belt shape in the row direction, and is connected to the transparent electrode, and
a column-direction width of each of the paired transparent electrodes is set at 150 μm or less.

5. A plasma display panel according to claim 3, wherein each of the row electrodes constituting each row electrode pair comprises a metallic bus electrode that has a required column-direction width and faces the counterpart row electrode in the row electrode pair across the discharge gap, and
a column-direction width of each of the paired bus electrodes is set at 150 μm or less.

6. A plasma display panel according to claim 3, further comprising:
a partition wall unit that is placed between the first and second substrates, is formed in an approximate grid shape composed of a plurality of transverse walls extending parallel to each other in the row direction and a plurality of vertical walls extending parallel to each other in the column direction, and thereby partitions the discharge space into the unit light emission areas,
wherein the row electrodes are placed facing the unit light emission areas defined by the partition wall unit.

7. A plasma display panel according to claim 4, further comprising:
a partition wall unit that is placed between the first and second substrates, is formed in an approximate grid shape composed of a plurality of transverse walls extending parallel to each other in the row direction and a plurality of vertical walls extending parallel to each other in the column direction, and there by partitions the discharge space in to the unit light emission areas, p1 wherein the transparent electrodes of the row electrodes are placed approximately facing a central portion of each of the unit light emission areas, and the bus electrodes of the row electrodes are respectively placed facing portions of the unit light emission area close to the transverse walls of the partition wall unit.

8. A plasma display panel according to claim 7, wherein
the transparent electrode and the bus electrode of each of the row electrodes constituting each row electrode pair are connected by a metal-made connecting portion that extends in the column direction and faces each of the vertical walls of the partition wall unit.

9. A plasma display panel according to claim 1, wherein
the discharge gas includes helium at a partial pressure of 8 kPa or more.

10. A plasma display panel according to claim 9, wherein the partial pressure of the helium is set at 10 kPa or more.

11. A plasma display panel according to claim 2, wherein
the dielectric layer includes thin-film portions and thick-film portions having a thickness greater than that of the thin-film portion, and each of the thin-film portions of the dielectric layer faces leading-side portions of the paired row electrodes which are close to the discharge gap, whereby the column-direction width of the portion of each of the row electrodes which is involved in a discharge is set at 150 μm or less.

12. A plasma display panel according to claim 11, wherein
the thickness of the thick-film portion of the dielectric layer is set at approximately twice or more the thickness of the thin-film portion of the dielectric layer.

13. A plasma display panel according to claim 11, wherein
the thin-film portion of the dielectric layer extends in a belt shape in the row direction.

14. A plasma display panel according to claim 11, wherein
each of the thin-film portions of the dielectric layer is shaped in an island form for each unit light emission area, and the thick-film portions are formed in an approximate grid shape surrounding the thin-film portions.

15. A plasma display panel according to claim 11, further comprising:
a partition wall unit that is placed between the first and second substrates, is formed in an approximate grid shape composed of a plurality of transverse walls extending parallel to each other in the row direction and a plurality of vertical walls extending parallel to each other in the column direction, and there by partitions the discharge space into the unit light emission areas,
wherein the row electrodes are placed facing the unit light emission areas defined by the partition wall unit.

16. A plasma display panel according to claim 11, wherein
each of the row electrodes constituting each of the row electrode pairs comprises a transparent electrode that has a required column-direction width and faces the counterpart row electrode in the row electrode pair across the discharge gap, and a metallic bus electrode that has a column-direction width smaller than that of the transparent electrode, extends in a belt shape in the row direction, and is connected to the transparent electrode, and
a partition wall unit, formed in an approximate grid shape composed of a plurality of transverse walls extending parallel to each other in the row direction and a plurality of vertical walls extending parallel to each other in the column direction, is formed between the first and second substrates and partitions the discharge space into the unit light emission areas, and the bus electrode of each of the row electrodes is placed facing the transverse wall of the partition wall unit.

17. A plasma display panel according to claim 2, further comprising:
secondary electron emission layers that are each formed of a high gamma material and on a portion of the dielectric layer facing a leading portion of each of the paired row electrodes close to the discharge gap, whereby the column-direction width of each of the portions of the row electrodes which are involved in a discharge is set at 150 μm or less.

18. A plasma display panel according to claim 1, wherein
the portion of each of the row electrodes constituting each row electrode pair, which faces each of the unit light emission areas and is involved in a discharge, is formed in a shape having a length greater than a row-direction width of the unit light emission area.

19. A plasma display panel according to claim 18, wherein
the portion of each of the row electrodes constituting each row electrode pair, which faces the unit light emission area, is formed in a shape extending in a direction inclined with respect to the row direction.

20. A plasma display panel according to claim 18, wherein
the portion of each of the row electrodes constituting each row electrode pair, which faces the unit light emission area, is formed in a shape zigzagging or twisting in the row direction.

21. A plasma display panel according to claim 18, wherein
each of the row electrodes constituting each row electrode pair comprises a transparent electrode that has a required width in a transverse direction with respect to a longitudinal direction of the row electrode and faces the counterpart row electrode in the row electrode pair across the discharge gap, and a metallic bus electrode that has a smaller width in the transverse direction with respect to the longitudinal direction of the row electrode than that of the transparent electrode, extends in a belt shape, and is connected to the transparent electrode, and
the width of each of the paired transparent electrodes in the transverse direction with respect to the longitudinal direction of the row electrode is set at 150 μm or less.

22. A plasma display panel according to claim 18, wherein
each of the row electrodes constituting each row electrode pair comprises a metallic bus electrode that has a required width in a transverse direction with respect to a longitudinal direction of the row electrode and faces the counterpart row electrode in the row electrode pair with the discharge gap in between, and
the width of each of the paired bus electrodes in the transverse direction with respect to the longitudinal direction is set at 150 μm or less.

23. A plasma display panel according to claim 1, further comprising:
a partition wall unit that is placed between the first and second substrates and provides a partition at least between the unit light emission areas adjacent to each other in the row direction; and
wall members that are formed between the dielectric layer and the portions, facing the row electrode pairs, of the partition wall unit which partitions the adjacent unit light emission areas in the row direction from each other, and each have a required column-direction width greater than a column-direction width of the row electrode pair and smaller than a column-direction width of each of the unit light emission areas, wherein the wall member blocks off, from each other, portions, on opposite sides of the wall member, of the respective unit light emission areas adjacent each other in the row direction, and
clearances are formed between the dielectric layer and portions of the partition wall unit on both ends of the wall member in the column direction, and thereby provide communication between the unit light emission areas adjacent to each other in the row direction.

24. A plasma display panel according to claim 23, wherein the wall members are formed on the partition wall unit.

25. A plasma display panel according to claim 23, wherein
the wall members are formed on the dielectric layer overlying the row electrode pairs.

26. A plasma display panel according to claim 23, wherein
the wall members are formed of a same material as a dielectric material used for forming the partition wall unit.

27. A plasma display panel according to claim 23, wherein
the wall members are formed of a low dielectric material different from a dielectric material used for forming the partition wall unit.

28. A plasma display panel according to claim 23, wherein
each of the wall members has a central portion placed facing the paired row electrodes constituting each row electrode pair and the discharge gap between the paired row electrodes, and when viewed from the first substrate, two ends of the wall member are respectively located in positions extending outward from the paired row electrodes in the column direction by an equal length.

29. A plasma display panel according to claim 28, wherein
the column-direction length of each of the two ends of the wall member extending outward from the paired row electrodes in the column direction when viewed from the first substrate is set at 30 μm or less.

30. A plasma display panel according to claim 11, further comprising:
a partition wall unit that is placed between the first and second substrates and provides a partition at least between the unit light emission areas adjacent to each other in the row direction; and
wall members that are formed between the dielectric layer and portions, facing the row electrode pairs, of the partition wall unit which partitions the adjacent unit light emission areas in the row direction from each other, and each have a required column-direction width greater than the column-direction width of the portion of the row electrode pair involved in a discharge and smaller than a column-direction width of the unit light emission area, wherein
each of the wall members blocks off, from each other, portions, on opposite sides of the wall member, of the respective unit light emission areas adjacent each other in the row direction, and
clearances are formed between the dielectric layer and portions of the partition wall unit on both ends of the wall member in the column direction, and thereby provide communication between the unit light emission areas adjacent each other in the row direction.

31. A plasma display panel according to claim 30, wherein
each of the thin-film portions of the dielectric layer is formed in a belt shape extending in the row direction,
the wall member has a first-stage portion placed close to the partition wall unit and having a longer column-direction length and a second-stage portion placed close to the first substrate and having a shorter column-direction length than that of the first-stage portion,
the second-stage portion of the wall member is fitted into a groove that is created on the thin-film portion of the dielectric layer by the thin-film portion and the thick-film portions.

32. A plasma display panel according to claim 30, wherein
each of the thin-film portions of the dielectric layer is shaped in an island form for each unit light emission area,
the thick-film portions are formed in an approximate grid shape surrounding the thin-film portions, and
each of the wall members is placed between the partition wall unit and the thick-film portion of the dielectric layer situated between the island-form thin-film portions adjacent to each other in the row direction.

33. A plasma display panel according to claim 30, wherein
the wall members are formed of a same material as a dielectric material used for forming the partition wall unit.

34. A plasma display panel according to claim 30, wherein
the wall members are formed of a low dielectric material different from a dielectric material used for forming the partition wall unit.

35. A plasma display panel according to claim 30, wherein
each of the wall members has a column-direction central line approximately aligned, in the row direction, with a column-direction central line of the thin-film portion of the dielectric layer, and when viewed from the first substrate, two ends of the wall member are respectively located in positions extending outward from the thin-film portion of the dielectric layer in the column direction by an equal length.

36. A plasma display panel according to claim 35, wherein
the column-direction length of each of the two ends of the wall member extending outward from the thin-film portion of the dielectric layer in the column direction when viewed from the first substrate is set at 30 μm or less.

37. A plasma display panel according to claim 17, further comprising:
a partition wall unit that is placed between the first and second substrates and provides a partition at least between the unit light emission areas adjacent to each other in the row direction; and
wall members that are formed between the dielectric layer and portions, facing the row electrode pairs, of the partition wall unit which partitions the adjacent unit light emission areas in the row direction from each other, and each have a required column-direction width greater than the column-direction width of the portion of the row electrode pair involved in a discharge and smaller than a column-direction width of the unit light emission area, wherein
each of the wall members blocks off, from each other, portions, on opposite sides of the wall member, of the respective unit light emission areas adjacent each other in the row direction, and
clearances are formed between the dielectric layer and portions of the partition wall unit on both ends of the wall member in the column direction, and there by provide communication between the unit light emission areas adjacent each other in the row direction.

38. A plasma display panel according to claim 37, wherein
each of the secondary electron emission layers is formed in a belt shape extending in the row direction, a recess is formed in a portion of the wall member facing the dielectric layer, and the secondary electron emission layer is fitted into the recess.

39. A plasma display panel according to claim 37, wherein
each of the secondary electron emission layers is shaped in an island form for each unit light emission area, and the wall member is placed between the partition wall unit and the dielectric layer and between the island-form secondary electron emission layers adjacent to each other in the row direction.

40. A plasma display panel according to claim 37, wherein
the wall members are formed of a same material as a dielectric material used for forming the partition wall unit.

41. A plasma display panel according to claim 37, wherein
the wall members are formed of a low dielectric material different from a dielectric material used for forming the partition wall unit.

42. A plasma display panel according to claim 37, wherein
each of the wall members has a column-direction central line approximately aligned, in the row direction, with a column-direction central line of the secondary electron emission layer, and when viewed from the first substrate, two ends of the wall member are respectively located in positions extending outward from the secondary electron emission layer in the column direction by an equal length.

43. A plasma display panel according to claim 42, wherein
the column-direction length of each of the two ends of the wall member extending outward from the secondary electron emission layer in the column direction when viewed from the first substrate is set at 30 μm or less.

44. A plasma display panel according to claim 1, wherein
a thickness of a portion of the dielectric layer facing to the discharge gap is smaller than a thickness of other portions of the dielectric layer which do not face the discharge gap.

45. A plasma display panel according to claim 44, wherein
a recess is formed in a portion, facing the discharge gap, of a face of the dielectric layer facing the discharge space, and the thickness of the portion of the dielectric layer facing the discharge gap is made smaller than that of the other portions by the recess.

46. A plasma display panel according to claim 11, wherein
a thickness of a portion, facing the discharge gap, of each of the thin-film portions of the dielectric layer is smaller than a thickness of other portions of the thin-film portion of the dielectric layer which do not face the discharge gap.

47. A plasma display panel according to claim 46, wherein
a recess is formed in a portion, facing the discharge gap, of a face of the thin-film portion of the dielectric layer facing the discharge space, and the thickness of the portion of the thin-film portion facing the discharge gap is made smaller than that of the other portions by the recess.

48. A plasma display panel according to claim 46, wherein
the thickness of the thick-film portion of the dielectric layer is set at approximately twice or more the thickness of the thin-film portion of the dielectric layer.

49. A plasma display panel according to claim 46, wherein
the thin-film portion of the dielectric layer is formed in a belt shape extending in the row direction.

50. A plasma display panel according to claim 46, wherein
each of the thin-film portions of the dielectric layer is shaped in an island form for each unit light emission area, and the thick-film portions of the dielectric layer are formed in an approximate grid shape surrounding the thin-film portions.

51. A plasma display panel according to claim 17, wherein
a thickness of a portion of the dielectric layer facing the discharge gap is smaller than a thickness of other portions of the dielectric layer which do not face the discharge gap, and the secondary electron emission layers formed of the high gamma material is placed on the portion of the dielectric layer including the portion having the smaller thickness.

52. A plasma display panel according to claim 51, wherein
a recess is formed in a portion, facing the discharge gap, of a face of the dielectric layer facing the discharge space, and the thickness of the portion of the dielectric layer facing the discharge gap is made smaller than that of the other portions by the recess, and the secondary electron emission layer is formed in the recess.

53. A plasma display panel according to claim 1, wherein
the dielectric layer is formed of a dielectric material with a relative dielectric constant of 9.3 or less.

54. A plasma display panel according to claim 53, wherein
the relative dielectric constant of the dielectric material used for forming the dielectric layer is equal to or less than 8.

55. A plasma display panel according to claim 53, wherein
the dielectric material used for forming the dielectric layer is either zinc oxide glass or a mixture of zinc oxide glass and phosphorus oxide glass.

56. A plasma display panel according to claim 53, wherein
the dielectric layer has a film-thickness of 35 μm or more in a vertical direction with respect to the substrates.

57. A plasma display panel according to claim 11, wherein
at least the thin-film portions of the dielectric layer are formed of a dielectric material with a relative dielectric constant of 9.3 or less.

58. A plasma display panel-according to claim 57, wherein
the relative dielectric constant of the dielectric material used for forming at least the thin-film portions of the dielectric layer is equal to or less than 8.

59. A plasma display panel according to claim 57, wherein
the dielectric material used for forming at least the thin-film portion of the dielectric layer is either zinc oxide glass or a mixture of zinc oxide glass and phosphorus oxide glass.

60. A plasma display panel according to claim 57, wherein
the thin-film portion of the dielectric layer has a film-thickness of 35 μm or more in a vertical direction with respect to the substrates.

61. A plasma display panel according to claim 17, wherein
the dielectric layer is formed of a dielectric material with a relative dielectric constant of 9.3 or less.

62. A plasma display panel according to claim 61, wherein
the relative dielectric constant of the dielectric material used for forming the dielectric layer is equal to or less than 8.

63. A plasma display panel according to claim 61, wherein
the dielectric material used for forming the dielectric layer is either zinc oxide glass or a mixture of zinc oxide glass and phosphorus oxide glass.

64. A plasma display panel according to claim 61, wherein
the dielectric layer has a film-thickness of 35 μm or more in a vertical direction with respect to the substrates.
